(19) United States
(12) Patent Application Publication
(10) Pub. No.: US 2020/0153885 A1
(43) Pub. Date: May 14, 2020

(54) APPARATUS FOR TRANSMITTING POINT CLOUD DATA, A METHOD FOR TRANSMITTING POINT CLOUD DATA, AN APPARATUS FOR RECEIVING POINT CLOUD DATA AND/OR A METHOD FOR RECEIVING POINT CLOUD DATA

(71) Applicant: LG ELECTRONICS INC., Seoul (KR)

(72) Inventors: Jangwon LEE, Seoul (KR); Sejin OH, Seoul (KR)

(73) Assignee: LG ELECTRONICS INC., Seoul (KR)

(21) Appl. No.: 16/588,569

(22) Filed: Sep. 30, 2019

Related U.S. Application Data
(60) Provisional application No. 62/739,838, filed on Oct. 1, 2018.

(30) Foreign Application Priority Data
Oct. 4, 2018 (KR) 10-2018-0118326

(51) Int. Cl. H04L 29/06; G06T 9/00; G06T 19/00; G06T 15/00

(52) U.S. Cl. CPC H04L 65/601; G06T 15/005; G06T 19/006; G06T 9/00

(57) ABSTRACT

In accordance with embodiments, a method for transmitting point cloud data includes generating a geometry image for a location of point cloud data; generating a texture image for attribute of the point cloud data; generating an occupancy map for a patch of the point cloud data; and/or multiplexing the geometry image, the texture image and the occupancy map. In accordance with embodiments, a method for receiving point cloud data includes demultiplexing multiplexing a geometry image for a location of point cloud data, a texture image for attribute of the point cloud data and an occupancy map for a patch of the point cloud data; decompressing the geometry image; decompressing the texture image; and/or decompressing the occupancy map.

### CROSS-REFERENCE TO RELATED APPLICATIONS

Pursuant to 35 U.S.C. § 119, this application claims the benefit of earlier filing date and right of priority to U.S. Provisional Application No. 62/739,838, filed on Oct. 1, 2018, and also claims the benefit of Korean Application No. 10-2018-0118326, filed on Oct. 4, 2018 the contents of which are all incorporated by reference herein in their entirety.

### TECHNICAL FIELD

Embodiments provide a method for providing point cloud contents to provide a user with various services such as virtual reality (VR), augmented reality (AR), mixed reality (MR), and autonomous driving services.

### BACKGROUND ART

A point cloud is a set of points in 3D space. It is difficult to generate point cloud data because the number of points in the 3D space is large.

A large amount of throughput is required to transmit and receive data of a point cloud, which raises an issue.

### DISCLOSURE

### Technical Problem

An object of the present invention is to provide a point cloud data transmission apparatus, a point cloud data transmission method, a point cloud data reception apparatus, and a point cloud data reception method for efficiently transmitting and receiving a point cloud.

Another object of the present invention is to provide a point cloud data transmission apparatus, a point cloud data transmission method, a point cloud data reception apparatus, and a point cloud data reception method for addressing latency and encoding/decoding complexity.

Objects of the present disclosure are not limited to the aforementioned objects, and other objects of the present disclosure which are not mentioned above will become apparent to those having ordinary skill in the art upon examination of the following description.

### Technical Solution

To achieve these objects and other advantages and in accordance with the purpose of the invention, as embodied and broadly described herein, a method for transmitting point cloud data according to embodiments includes generating a geometry image for a location of point cloud data, generating a texture image for an attribute of the point cloud data, generating an occupancy map for a patch of the point cloud data, generating auxiliary patch information related to the patch of the point cloud, and/or multiplexing the geometry image, the texture image, the occupancy map, and the auxiliary patch information.

A method for receiving point cloud data according to embodiments of the present invention includes demultiplexing a geometry image for a location of point cloud data, a texture image for an attribute of the point cloud data, an occupancy map for a patch of the point cloud data, and an auxiliary patch information related to the patch of the point cloud, decompressing the geometry image, decompressing the texture image, decompressing the occupancy map, and/or decompressing the auxiliary patch information.

### Advantageous Effects

A point cloud data transmission method, a point cloud data transmission apparatus, a point cloud data reception method, and a point cloud data reception apparatus according to embodiments may provide a point cloud service with a quality.

A point cloud data transmission method, a point cloud data transmission apparatus, a point cloud data reception method, and a point cloud data reception apparatus according to embodiments may achieve various video codec methods.

A point cloud data transmission method, a point cloud data transmission apparatus, a point cloud data reception method, and a point cloud data reception apparatus according to embodiments may provide universal point cloud content such as an autonomous driving service.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates an architecture for providing 360 video according to the present invention;

FIG. 2 illustrates a 360 video transmission apparatus according to one aspect of the present invention;

FIG. 3 illustrates a 360 video reception apparatus according to another aspect of the present invention;

FIG. 4 illustrates a 360-degree video transmission apparatus/360-degree video reception apparatus according to another embodiment of the present invention;

FIG. 5 illustrates the concept of aircraft principal axes for describing a 3D space of the present invention;

FIG. 6 illustrates projection schemes according to an embodiment of the present invention;

FIG. 7 illustrates tiles according to an embodiment of the present invention;

FIG. 8 illustrates 360-degree video related metadata according to an embodiment of the present invention;

FIG. 9 illustrates a viewpoint and viewing position additionally defined in a 3DoF+VR system;

FIG. 10 illustrates a method for implementing 360-degree video signal processing and related transmission apparatus/reception apparatus based on 3DoF+system;

FIG. 11 illustrates an architecture of a 3DoF+ end-to-end system;

FIG. 12 illustrates an architecture of a Frame for Live Uplink Streaming (FLUS);

FIG. 13 illustrates a configuration of 3DoF+ transmission side;

FIG. 14 illustrates a configuration of 3DoF+ reception side;

FIG. 15 illustrates an OMAF structure;

FIG. 16 illustrates a type of media according to movement of a user;

FIG. 17 illustrates the entire architecture for providing 6DoF video;

FIG. 18 illustrates a configuration of a transmission apparatus for providing 6DoF video services;

FIG. 19 illustrates a configuration of 6DoF video reception apparatus;

FIG. 20 illustrates a configuration of 6DoF video transmission/reception apparatus;

FIG. 21 illustrates 6DoF space;

FIG. 22 illustrates generals of point cloud compression processing according to embodiments;

FIG. 23 illustrates arrangement of point cloud capture equipment according to embodiments;

FIG. 24 illustrates an example of a point cloud, a geometry image, and a (non-padded) texture image according to embodiments;

FIG. 25 illustrates a V-PCC encoding process according to embodiments;

FIG. 26 illustrates a tangent plane and a normal vector of a surface according to embodiments;

FIG. 27 illustrates a bounding box of a point cloud according to embodiments;

FIG. 28 illustrates a method for determining an individual patch location in an occupancy map according to embodiments;

FIG. 29 illustrates a relationship between normal, tangent, and bitangent axes according to embodiments;

FIG. 30 illustrates configuration of d0 and d1 in a min mode and configuration of d0 and d1 in a max mode according to embodiments;

FIG. 31 illustrates an example of an EDD code according to embodiments;

FIG. 32 illustrates recoloring using color values of neighboring points according to embodiments;

FIG. 33 shows pseudo code for block and patch mapping according to embodiments;

FIG. 34 illustrates push-pull background filling according to embodiments;

FIG. 35 illustrates an example of possible traversal orders for a 4*4 sized block according to embodiments;

FIG. 36 illustrates an example of selection of the best traversal order according to embodiments;

FIG. 37 illustrates a 2D video/image encoder according to embodiments;

FIG. 38 illustrates a V-PCC decoding process according to embodiments;

FIG. 39 illustrates a 2D video/image decoder according to embodiments;

FIG. 40 is a flowchart illustrating a transmission side operation according to embodiments;

FIG. 41 is a flowchart illustrating a reception side operation according to the embodiments;

FIG. 42 illustrates an architecture for V-PCC based point cloud data storage and streaming according to embodiments;

FIG. 43 illustrates an apparatus for storing and transmitting point cloud data according to embodiments;

FIG. 44 illustrates a point cloud data reception apparatus according to embodiments;

FIG. 45 illustrates an encoding process of a point cloud data transmission apparatus according to embodiments;

FIG. 46 illustrates a decoding process according to embodiments;

FIG. 47 illustrates ISO BMFF based multiplexing/demultiplexing according to embodiments;

FIG. 48 illustrates an example of runLength and best_traversal_order_index according to embodiments;

FIG. 49 illustrates NALU stream based multiplexing/demultiplexing according to embodiments;

FIG. 50 illustrates PCC layer information according to embodiments;

FIG. 51 illustrates PCC auxiliary patch information according to embodiments;

FIG. 52 shows a PCC occupancy map according to embodiments;

FIG. 53 shows a PCC group of frames header according to embodiments;

FIG. 54 illustrates geometry/texture image packing according to embodiments;

FIG. 55 illustrates a method of arranging geometry and image components according to embodiments;

FIG. 56 illustrates VPS extension according to embodiments;

FIG. 57 illustrates pic_parameter_set according to embodiments;

FIG. 58 illustrates pps_pcc_auxiliary_patch_info_extension ( ) according to embodiments;

FIG. 59 illustrates pps_pcc_occupancymap_extension( ) according to embodiments;

FIG. 60 illustrates vps_pcc_gof header_extension( ) according to embodiments;

FIG. 61 illustrates pcc_nal_unit according to embodiments;

FIG. 62 shows an example of a PCC related syntax according to embodiments;

FIG. 63 shows PCC data interleaving information according to embodiments;

FIG. 64 illustrates a point cloud data transmission method according to embodiments; and

FIG. 65 illustrates a point cloud data reception method according to embodiments.

### BEST MODE

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide a thorough understanding of the present invention. However, it will be apparent to those skilled in the art that the present invention may be practiced without such specific details.

Although most terms used in the present invention have been selected from general ones widely used in the art, some terms have been arbitrarily selected by the applicant and their meanings are explained in detail in the following description as needed. Thus, the present invention should be understood based upon the intended meanings of the terms rather than their simple names or meanings.

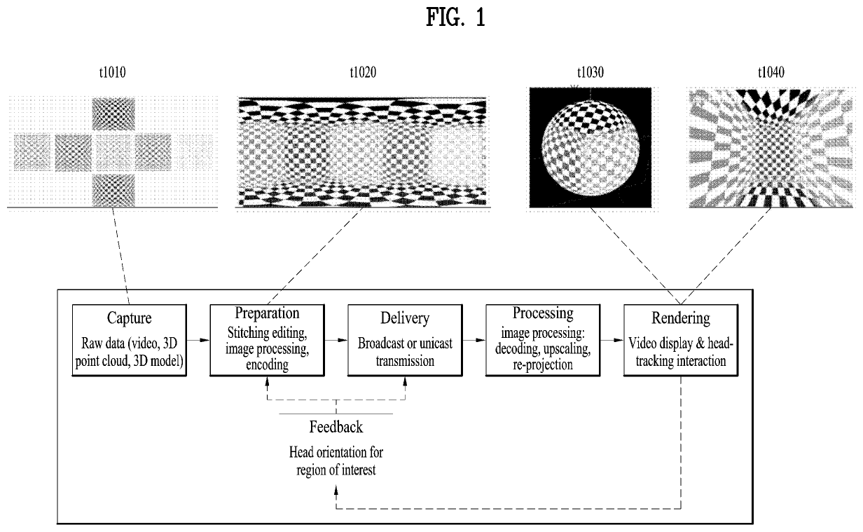

FIG. 1 illustrates an architecture for providing 360-degree video according to the present invention.

The present invention provides a method for providing 360-degree content to provide virtual reality (VR) to users. VR refers to a technique or an environment for replicating an actual or virtual environment. VR artificially provides sensuous experiences to users, and users can experience electronically projected environments. 360-degree content refers to convent for realizing and providing VR and may include 360-degree video and/or 360-degree audio. 360-degree video may refer to video or image content which is necessary to provide VR and is captured or reproduced in all directions (360 degrees). 360-degree video can refer to video or image represented on 3D spaces in various forms according to 3D models. For example, 360-degree video can be represented on a spherical plane. 360-degree audio is audio content for providing VR and can refer to spatial audio content which can be recognized as content having an audio generation source located in a specific space. 360-degree content can be generated, processed and transmitted to users, and users can consume VR experiences using the 360-degree content. 360-degree content/video/image/audio may be referred to as 360 content/video/image/audio, omitting the term “degree” representing a unit, or as VR content/video/image/audio.

The present invention proposes a method for effectively providing 360 video. To provide 360 video, first, 360 video can be captured using one or more cameras. The captured 360 video is transmitted through a series of processes, and a reception side can process received data into the original 360 video and render the 360 video. Thus, the 360 video can be provided to a user.

Specifically, a procedure for providing 360 video may include a capture process, a preparation process, a transmission process, a processing process, a rendering process and/or a feedback process.

The capture process may refer to a process of capturing images or videos for a plurality of views through one or more cameras. The shown image/video data t1010 can be generated through the capture process. Each plane of the shown image/video data t1010 can refer to an image/video for each view. The captured images/videos may be called raw data. In the capture process, metadata related to capture can be generated.

For the capture process, a special camera for VR may be used. When 360 video with respect to a virtual space generated using a computer is provided in an embodiment, capture using a camera may not be performed. In this case, the capture process may be replaced by a process of simply generating related data.

The preparation process may be a process of processing the captured images/videos and metadata generated in the capture process. The captured images/videos may be subjected to stitching, projection, region-wise packing and/or encoding in the preparation process.

First, each image/video may pass through a stitching process. The stitching process may be a process of connecting captured images/videos to create a single panorama image/video or a spherical image/video.

Then, the stitched images/videos may pass through a projection process. In the projection process, the stitched images/videos can be projected on a 2D image. This 2D image may be called a 2D image frame. Projection on a 2D image may be represented as mapping to the 2D image. The projected image/video data can have a form of a 2D image t1020 as shown in the figure.

The video data projected on the 2D image can pass through a region-wise packing process in order to increase video coding efficiency. Region-wise packing may refer to a process of dividing video data projected on a 2D image into regions and processing the regions. Here, regions may refer to regions obtained by dividing a 2D image on which 360 video data is projected. Such regions can be obtained by dividing the 2D image equally or arbitrarily according to an embodiment. Regions may be divided according to a projection scheme according to an embodiment. The region-wise packing process is an optional process and thus may be omitted from the preparation process.

According to an embodiment, this process may include a process of rotating the regions or rearranging the regions on the 2D image in order to increase video coding efficiency. For example, the regions can be rotated such that specific sides of regions are locationed in proximity to each other to increase coding efficiency.

According to an embodiment, the this process may include a process of increasing or decreasing the resolution of a specific region in order to differentiate the resolution for regions of the 360 video. For example, the resolution of regions corresponding to a relatively important part of the 360 video can be increased to higher than other regions. The video data projected on the 2D image or the region-wise packed video data can pass through an encoding process using a video codec.

According to an embodiment, the preparation process may additionally include an editing process. In this editing process, the image/video data before or after projection may be edited. In the preparation process, metadata with respect to stitching/projection/encoding/editing may be generated. In addition, metadata with respect to the initial view or region of interest (ROI) of the video data projected on the 2D image may be generated.

The transmission process may be a process of processing and transmitting the image/video data and metadata which have pass through the preparation process. For transmission, processing according to any transmission protocol may be performed. The data that has been processed for transmission can be delivered over a broadcast network and/or broadband. The data may be delivered to the reception side in an on-demand manner. The reception side can receive the data through various paths.

The processing process may refer to a process of decoding the received data and re-projecting the projected image/video data on a 3D model. In this process, the image/video data projected on the 2D image can be re-projected on a 3D space. This process may be called mapping projection. Here, the 3D space on which the data is mapped may have a form depending on a 3D model. For example, 3D models may include a sphere, a cube, a cylinder and a pyramid.

According to an embodiment, the processing process may further include an editing process, an up-scaling process, etc. In the editing process, the image/video data before or after re-projection can be edited. When the image/video data has been reduced, the size of the image/video data can be increased through up-scaling of samples in the up-scaling process. As necessary, the size may be decreased through down-scaling.

The rendering process may refer to a process of rendering and displaying the image/video data re-projected on the 3D space. Re-projection and rendering may be collectively represented as rendering on a 3D mode. The image/video re-projected (or rendered) on the 3D model may have a form t1030 as shown in the figure. The form t1030 corresponds to a case in which the image/video data is re-projected on a spherical 3D model. A user can view a region of the rendered image/video through a VR display or the like. Here, the region viewed by the user may take a form t1040 shown in the figure.

The feedback process may refer to a process of delivering various types of feedback information which can be acquired in the display process to a transmission side. Through the feedback process, interactivity in 360 video consumption can be provided. According to an embodiment, head orientation information, viewport information indicating a region currently viewed by a user, and the like may be delivered to the transmission side in the feedback process. According to an embodiment, a user can interact with content realized in a VR environment. In this case, information related to the interaction may be delivered to the transmission side or a service provider during the feedback process. According to an embodiment, the feedback process may not be performed.

The head orientation information may refer to information about the location, angle and motion of a user's head. On the basis of this information, information about a region of 360 video currently viewed by the user, that is, viewport information can be calculated.

The viewport information may be information about a region of 360 video currently viewed by a user. Gaze analysis may be performed using the viewport information to check a manner in which the user consumes 360 video, a region of the 360 video at which the user gazes, and how long the user gazes at the region. Gaze analysis may be performed by the reception side and the analysis result may be delivered to the transmission side through a feedback channel. An apparatus such as a VR display can extract a viewport region on the basis of the location/direction of a user's head, vertical or horizontal FOV supported by the apparatus.

According to an embodiment, the aforementioned feedback information may be consumed at the reception side as well as being delivered to the transmission side. That is, decoding, re-projection and rendering processes of the reception side can be performed using the aforementioned feedback information. For example, only 360 video for the region currently viewed by the user can be preferentially decoded and rendered using the head orientation information and/or the viewport information.

Here, a viewport or a viewport region can refer to a region of 360 video currently viewed by a user. A viewpoint is a point in 360 video which is viewed by the user and can refer to a center point of a viewport region. That is, a viewport is a region based on a view, and the size and form of the region can be determined by the field of view (FOV), which will be described below.

In the above-described architecture for providing 360 video, image/video data which is subjected to a series of capture/projection/encoding/transmission/decoding/re-projection/rendering processes can be called 360 video data. The term “360 video data” may be used as the concept including metadata or signaling information related to such image/video data.

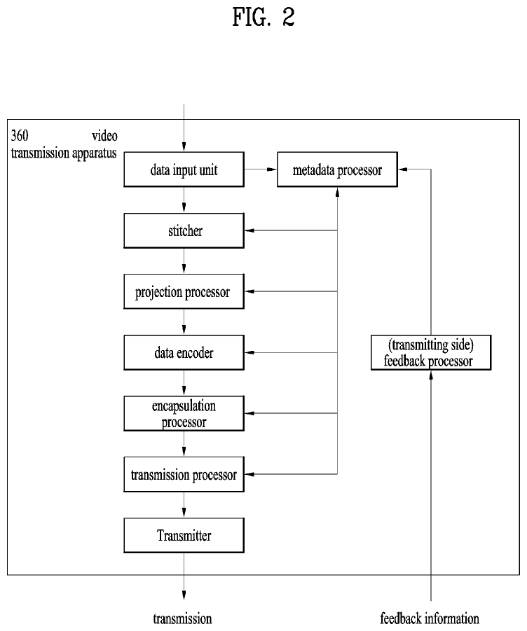

FIG. 2 illustrates a 360-degree video transmission apparatus according to one aspect of the present invention.

According to one aspect, the present invention can relate to a 360 video transmission apparatus. The 360 video transmission apparatus according to the present invention can perform operations related to the above-described preparation process to the transmission process. The 360 video transmission apparatus according to the present invention may include a data input unit, a stitcher, a projection processor, a region-wise packing processor (not shown), a metadata processor, a transmitter feedback processor, a data encoder, an encapsulation processor, a transmission processor and/or a transmitter as internal/external elements.

The data input unit may receive captured images/videos for respective views. The images/videos for the views may be images/videos captured by one or more cameras. In addition, the data input unit may receive metadata generated in a capture process. The data input unit may deliver the received images/videos for the views to the stitcher and deliver the metadata generated in the capture process to a signaling processor.

The stitcher may stitch the captured images/videos for the views. The stitcher can deliver the stitched 360 video data to the projection processor. The stitcher may receive necessary metadata from the metadata processor and use the metadata for stitching operation. The stitcher may deliver the metadata generated in the stitching process to the metadata processor. The metadata in the stitching process may include information indicating whether stitching has been performed, a stitching type, etc.

The projection processor can project the stitched 360 video data on a 2D image. The projection processor can perform projection according to various schemes which will be described below. The projection processor can perform mapping in consideration of the depth of 360 video data for each view. The projection processor may receive metadata necessary for projection from the metadata processor and use the metadata for the projection operation as necessary. The projection processor may deliver metadata generated in a projection process to the metadata processor. The metadata of the projection process may include a projection scheme type.

The region-wise packing processor (not shown) can perform the aforementioned region-wise packing process. That is, the region-wise packing processor can perform a process of dividing the projected 360 video data into regions, rotating or rearranging the regions or changing the resolution of each region. As described above, the region-wise packing process is an optional process, and when region-wise packing is not performed, the region-wise packing processor can be omitted. The region-wise packing processor may receive metadata necessary for region-wise packing from the metadata processor and use the metadata for the region-wise packing operation as necessary. The metadata of the region-wise packing processor may include a degree to which each region is rotated, the size of each region, etc.

The aforementioned stitcher, the projection processor and/or the region-wise packing processor may be realized by one hardware component according to an embodiment.

The metadata processor can process metadata which can be generated in the capture process, the stitching process, the projection process, the region-wise packing process, the encoding process, the encapsulation process and/or the processing process for transmission. The metadata processor can generate 360 video related metadata using such metadata. According to an embodiment, the metadata processor may generate the 360 video related metadata in the form of a signaling table. The 360 video related metadata may be called metadata or 360 video related signaling information according to signaling context. Furthermore, the metadata processor can deliver acquired or generated metadata to internal elements of the 360 video transmission apparatus as necessary. The metadata processor may deliver the 360 video related metadata to the data encoder, the encapsulation processor and/or the transmission processor such that the metadata can be transmitted to the reception side.

The data encoder can encode the 360 video data projected on the 2D image and/or the region-wise packed 360 video data. The 360 video data can be encoded in various formats.

The encapsulation processor can encapsulate the encoded 360 video data and/or 360 video related metadata into a file. Here, the 360 video related metadata may be delivered from the metadata processor. The encapsulation processor can encapsulate the data in a file format such as ISOBMFF, CFF or the like or process the data into a DASH segment. The encapsulation processor may include the 360 video related metadata in a file format according to an embodiment. For example, the 360 video related metadata can be included in boxes of various levels in an ISOBMFF file format or included as data in an additional track in a file. The encapsulation processor can encapsulate the 360 video related metadata into a file according to an embodiment. The transmission processor can perform processing for transmission on the 360 video data encapsulated in a file format. The transmission processor can process the 360 video data according to an arbitrary transmission protocol. The processing for transmission may include processing for delivery through a broadcast network and processing for delivery over a broadband. According to an embodiment, the transmission processor may receive 360 video related metadata from the metadata processor in addition to the 360 video data and perform processing for transmission on the 360 video related metadata.

The transmission unit can transmit the processed 360 video data and/or the 360 video related metadata over a broadcast network and/or broadband. The transmission unit can include an element for transmission over a broadcast network and an element for transmission over a broadband.

According to an embodiment of the 360 video transmission apparatus according to the present invention, the 360 video transmission apparatus may further include a data storage unit (not shown) as an internal/external element. The data storage unit may store the encoded 360 video data and/or 360 video related metadata before delivery thereof. Such data may be stored in a file format such as ISOBMFF. When 360 video is transmitted in real time, the data storage unit may not be used. However, 360 video is delivered on demand, in non-real time or over a broadband, encapsulated 360 data may be stored in the data storage unit for a predetermined period and then transmitted.

According to another embodiment of the 360 video transmission apparatus according to the present invention, the 360 video transmission apparatus may further include a transmitter feedback processor and/or a network interface (not shown) as internal/external elements. The network interface can receive feedback information from a 360 video reception apparatus according to the present invention and deliver the feedback information to the transmitter feedback processor. The transmitter feedback processor can deliver the feedback information to the stitcher, the projection processor, the region-wise packing processor, the data encoder, the encapsulation processor, the metadata processor and/or the transmission processor. The feedback information may be delivered to the metadata processor and then delivered to each internal element according to an embodiment. Upon reception of the feedback information, internal elements can reflect the feedback information in processing of 360 video data.

According to another embodiment of the 360 video transmission apparatus according to the present invention, the region-wise packing processor can rotate regions and map the regions on a 2D image. Here, the regions can be rotated in different directions at different angles and mapped on the 2D image. The regions can be rotated in consideration of neighboring parts and stitched parts of the 360 video data on the spherical plane before projection. Information about rotation of the regions, that is, rotation directions and angles can be signaled using 360 video related metadata. According to another embodiment of the 360 video transmission apparatus according to the present invention, the data encoder can perform encoding differently on respective regions. The data encoder can encode a specific region with high quality and encode other regions with low quality. The feedback processor at the transmission side can deliver the feedback information received from a 360 video reception apparatus to the data encoder such that the data encoder can use encoding methods differentiated for regions. For example, the transmitter feedback processor can deliver viewport information received from a reception side to the data encoder. The data encoder can encode regions including a region indicated by the viewport information with higher quality (UHD) than other regions.

According to another embodiment of the 360 video transmission apparatus according to the present invention, the transmission processor can perform processing for transmission differently on respective regions. The transmission processor can apply different transmission parameters (modulation orders, code rates, etc.) to regions such that data delivered to the regions have different robustnesses.

Here, the transmitter feedback processor can deliver the feedback information received from the 360 video reception apparatus to the transmission processor such that the transmission processor can perform transmission processing differentiated for respective regions. For example, the transmitter feedback processor can deliver viewport information received from the reception side to the transmission processor. The transmission processor can perform transmission processing on regions including a region indicated by the viewport information such that the regions have higher robustness than other regions.

The internal/external elements of the 360 video transmission apparatus according to the present invention may be hardware elements realized by hardware. According to an embodiment, the internal/external elements may be modified, omitted, replaced by other elements or integrated with other elements. According to an embodiment, additional elements may be added to the 360 video transmission apparatus.

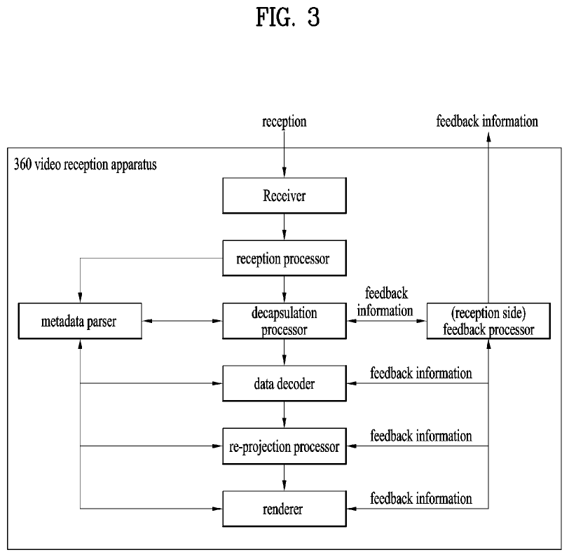

FIG. 3 illustrates a 360-degree video reception apparatus according to another aspect of the present invention.

According to another aspect, the present invention may relate to a 360 video reception apparatus. The 360 video reception apparatus according to the present invention can perform operations related to the above-described processing process and/or the rendering process. The 360 video reception apparatus according to the present invention may include a reception unit, a reception processor, a decapsulation processor, a data decoder, a metadata parser, a receiver feedback processor, a re-projection processor and/or a renderer as internal/external elements.

The reception unit can receive 360 video data transmitted from the 360 video transmission apparatus according to the present invention. The reception unit may receive the 360 video data through a broadcast network or a broadband according to a transmission channel.

The reception processor can perform processing according to a transmission protocol on the received 360 video data. The reception processor can perform a reverse of the process of the transmission processor. The reception processor can deliver the acquired 360 video data to the decapsulation processor and deliver acquired 360 video related metadata to the metadata parser. The 360 video related metadata acquired by the reception processor may have a form of a signaling table.

The decapsulation processor can decapsulate the 360 video data in a file format received from the reception processor. The decapsulation processor can decapsulate files in ISOBMFF to acquire 360 video data and 360 video related metadata. The acquired 360 video data can be delivered to the data decoder and the acquired 360 video related metadata can be delivered to the metadata parser. The 360 video related metadata acquired by the decapsulation processor may have a form of box or track in a file format. The decapsulation processor may receive metadata necessary for decapsulation from the metadata parser as necessary.

The data decoder can decode the 360 video data. The data decoder may receive metadata necessary for decoding from the metadata parser. The 360 video related metadata acquired in the data decoding process may be delivered to the metadata parser.

The metadata parser can parse/decode the 360 video related metadata. The metadata parser can deliver the acquired metadata to the data decapsulation processor, the data decoder, the re-projection processor and/or the renderer.

The re-projection processor can re-project the decoded 360 video data. The re-projection processor can re-project the 360 video data on a 3D space. The 3D space may have different forms according to used 3D modes. The re-projection processor may receive metadata necessary for re-projection from the metadata parser. For example, the re-projection processor can receive information about the type of a used 3D model and detailed information thereof from the metadata parser. According to an embodiment, the re-projection processor may re-project only 360 video data corresponding to a specific region on the 3D space on the 3D space using the metadata necessary for re-projection.

The renderer can render the re-projected 360 video data. This may be represented as rendering of the 360 video data on a 3D space as described above. When two processes are simultaneously performed in this manner, the re-projection processor and the renderer can be integrated to perform both the processes in the renderer. According to an embodiment, the renderer may render only a region viewed by a user according to view information of the user.

A user can view part of the rendered 360 video through a VR display. The VR display is an apparatus for reproducing 360 video and may be included in the 360 video reception apparatus (tethered) or connected to the 360 video reception apparatus as a separate apparatus (un-tethered).

According to an embodiment of the 360 video reception apparatus according to the present invention, the 360 video reception apparatus may further include a (receiver) feedback processor and/or a network interface (not shown) as internal/external elements. The receiver feedback processor can acquire feedback information from the renderer, the re-projection processor, the data decoder, the decapsulation processor and/or the VR display and process the feedback information. The feedback information may include viewport information, head orientation information, gaze information, etc. The network interface can receive the feedback information from the receiver feedback processor and transmit the same to the 360 video transmission apparatus.

As described above, the feedback information may be used by the reception side in addition to being delivered to the transmission side. The receiver feedback processor can deliver the acquired feedback information to internal elements of the 360 video reception apparatus such that the feedback information is reflected in a rendering process. The receiver feedback processor can deliver the feedback information to the renderer, the re-projection processor, the data decoder and/or the decapsulation processor. For example, the renderer can preferentially render a region viewed by a user using the feedback information. In addition, the decapsulation processor and the data decoder can preferentially decapsulate and decode a region viewed by the user or a region to be viewed by the user.

The internal/external elements of the 360 video reception apparatus according to the present invention may be hardware elements realized by hardware. According to an embodiment, the internal/external elements may be modified, omitted, replaced by other elements or integrated with other elements. According to an embodiment, additional elements may be added to the 360 video reception apparatus.

Another aspect of the present invention may relate to a method of transmitting 360 video and a method of receiving 360 video. The methods of transmitting/receiving 360 video according to the present invention can be performed by the above-described 360 video transmission/reception apparatuses or embodiments thereof.

The aforementioned embodiments of the 360 video transmission/reception apparatuses and embodiments of the internal/external elements thereof may be combined. For example, embodiments of the projection processor and embodiments of the data encoder can be combined to create as many embodiments of the 360 video transmission apparatus as the number of the embodiments. The combined embodiments are also included in the scope of the present invention.

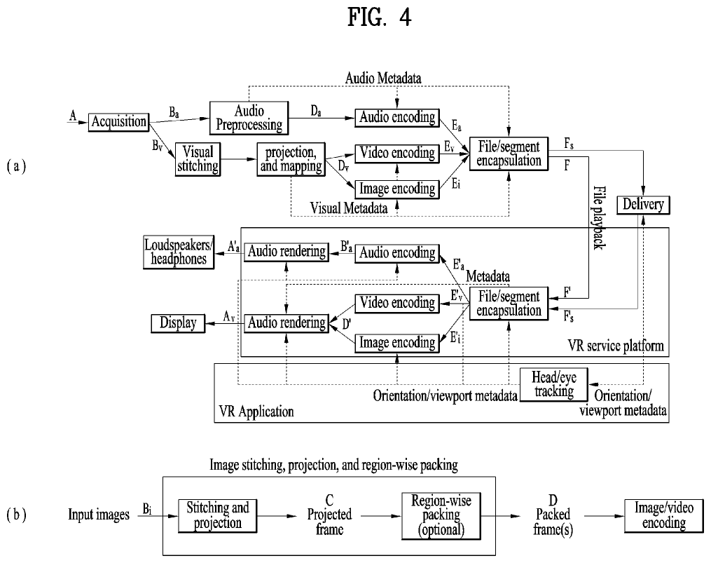

FIG. 4 illustrates a 360-degree video transmission apparatus/360-degree video reception apparatus according to another embodiment of the present invention.

As described above, 360 content can be provided according to the architecture shown in (a). The 360 content can be provided in the form of a file or in the form of a segment based download or streaming service such as DASH. Here, the 360 content can be called VR content.

As described above, 360 video data and/or 360 audio data may be acquired.

The 360 audio data can be subjected to audio preprocessing and audio encoding. In these processes, audio related metadata can be generated, and the encoded audio and audio related metadata can be subjected to processing for transmission (file/segment encapsulation).

The 360 video data can pass through the aforementioned processes. The stitcher of the 360 video transmission apparatus can stitch the 360 video data (visual stitching). This process may be omitted and performed at the reception side according to an embodiment. The projection processor of the 360 video transmission apparatus can project the 360 video data on a 2D image (projection and mapping (packing)).

The stitching and projection processes are shown in (b) in detail. In (b), when the 360 video data (input images) is delivered, stitching and projection can be performed thereon. The projection process can be regarded as projecting the stitched 360 video data on a 3D space and arranging the projected 360 video data on a 2D image. In the specification, this process may be represented as projecting the 360 video data on a 2D image. Here, the 3D space may be a sphere or a cube. The 3D space may be identical to the 3D space used for re-projection at the reception side.

The 2D image may also be called a projected frame (C). Region-wise packing may be optionally performed on the 2D image. When region-wise packing is performed, the locations, forms and sizes of regions can be indicated such that the regions on the 2D image can be mapped on a packed frame (D). When region-wise packing is not performed, the projected frame can be identical to the packed frame. Regions will be described below. The projection process and the region-wise packing process may be represented as projecting regions of the 360 video data on a 2D image. The 360 video data may be directly converted into the packed frame without an intermediate process according to design.

In (a), the projected 360 video data can be image-encoded or video-encoded. Since the same content can be present for different viewpoints, the same content can be encoded into different bit streams. The encoded 360 video data can be processed into a file format such as ISOBMFF according to the aforementioned encapsulation processor. Alternatively, the encapsulation processor can process the encoded 360 video data into segments. The segments may be included in an individual track for DASH based transmission.

Along with processing of the 360 video data, 360 video related metadata can be generated as described above. This metadata can be included in a video stream or a file format and delivered. The metadata may be used for encoding, file format encapsulation, processing for transmission, etc.

The 360 audio/video data can pass through processing for transmission according to the transmission protocol and then can be transmitted. The aforementioned 360 video reception apparatus can receive the 360 audio/video data over a broadcast network or broadband.

In (a), a VR service platform may correspond to an embodiment of the aforementioned 360 video reception apparatus. In (a), loudspeakers/headphones, display and head/eye tracking components are performed by an external apparatus or a VR application of the 360 video reception apparatus. According to an embodiment, the 360 video reception apparatus may include all of these components. According to an embodiment, the head/eye tracking component may correspond to the aforementioned receiver feedback processor.

The 360 video reception apparatus can perform processing for reception (file/segment decapsulation) on the 360 audio/video data. The 360 audio data can be subjected to audio decoding and audio rendering and provided to a user through a speaker/headphone.

The 360 video data can be subjected to image decoding or video decoding and visual rendering and provided to the user through a display. Here, the display may be a display supporting VR or a normal display.

As described above, the rendering process can be regarded as a process of re-projecting 360 video data on a 3D space and rendering the re-projected 360 video data. This may be represented as rendering of the 360 video data on the 3D space.

The head/eye tracking component can acquire and process head orientation information, gaze information and viewport information of a user. This has been described above.

A VR application which communicates with the aforementioned processes of the reception side may be present at the reception side.

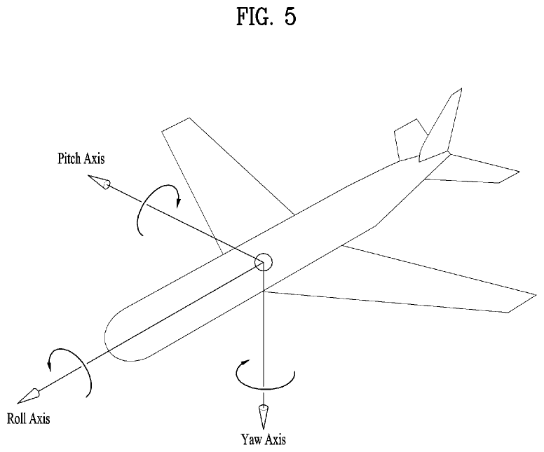

FIG. 5 illustrates the concept of aircraft principal axes for describing a 3D space of the present invention.

In the embodiments, the concept of aircraft principal axes can be used to represent a specific point, location, direction, spacing and region in a 3D space.

That is, the concept of aircraft principal axes can be used to describe a 3D space before projection or after re-projection and to signal the same. According to an embodiment, a method using X, Y and Z axes or a spherical coordinate system may be used.

An aircraft can freely rotate in the three dimension. Axes which form the three dimension are called pitch, yaw and roll axes. In the specification, these may be represented as pitch, yaw and roll or a pitch direction, a yaw direction and a roll direction.

The pitch axis may refer to a reference axis of a direction in which the front end of the aircraft rotates up and down. In the shown concept of aircraft principal axes, the pitch axis can refer to an axis connected between wings of the aircraft.

The yaw axis may refer to a reference axis of a direction in which the front end of the aircraft rotates to the left/right. In the shown concept of aircraft principal axes, the yaw axis can refer to an axis connected from the top to the bottom of the aircraft.

The roll axis may refer to an axis connected from the front end to the tail of the aircraft in the shown concept of aircraft principal axes, and rotation in the roll direction can refer to rotation based on the roll axis.

As described above, a 3D space in the present invention can be described using the concept of pitch, yaw and roll.

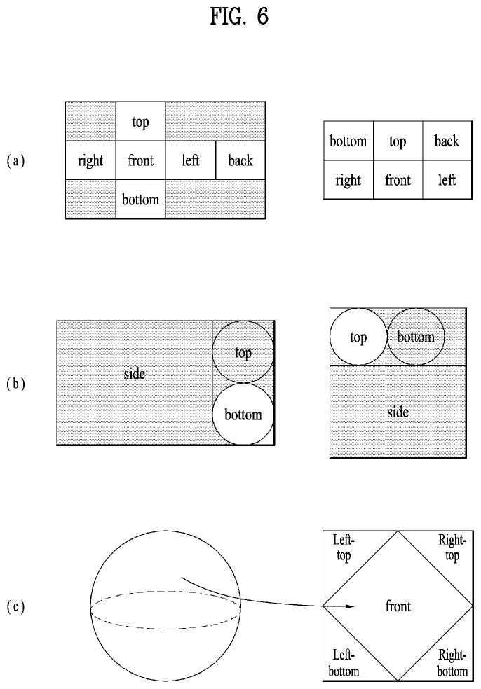

FIG. 6 illustrates projection schemes according to an embodiment of the present invention.

As described above, the projection processor of the 360 video transmission apparatus according to the present invention can project stitched 360 video data on a 2D image. In this process, various projection schemes can be used.

According to another embodiment of the 360 video transmission apparatus according to the present invention, the projection processor can perform projection using a cubic projection scheme. For example, stitched video data can be represented on a spherical plane. The projection processor can segment the 360 video data into a cube and project the same on the 2D image. The 360 video data on the spherical plane can correspond to planes of the cube and be projected on the 2D image as shown in (a).

According to another embodiment of the 360 video transmission apparatus according to the present invention, the projection processor can perform projection using a cylindrical projection scheme. Similarly, if stitched video data can be represented on a spherical plane, the projection processor can segment the 360 video data into a cylinder and project the same on the 2D image. The 360 video data on the spherical plane can correspond to the side, top and bottom of the cylinder and be projected on the 2D image as shown in (b).

According to another embodiment of the 360 video transmission apparatus according to the present invention, the projection processor can perform projection using a pyramid projection scheme. Similarly, if stitched video data can be represented on a spherical plane, the projection processor can regard the 360 video data as a pyramid form and project the same on the 2D image. The 360 video data on the spherical plane can correspond to the front, left top, left bottom, right top and right bottom of the pyramid and be projected on the 2D image as shown in (c).

According to an embodiment, the projection processor may perform projection using an equirectangular projection scheme and a panoramic projection scheme in addition to the aforementioned schemes.

As described above, regions can refer to regions obtained by dividing a 2D image on which 360 video data is projected. Such regions need not correspond to respective sides of the 2D image projected according to a projection scheme. However, regions may be divided such that the sides of the projected 2D image correspond to the regions and region-wise packing may be performed according to an embodiment. Regions may be divided such that a plurality of sides may correspond to one region or one side may correspond to a plurality of regions according to an embodiment. In this case, the regions may depend on projection schemes. For example, the top, bottom, front, left, right and back sides of the cube can be respective regions in (a). The side, top and bottom of the cylinder can be respective regions in (b). The front, left top, left bottom, right top and right bottom sides of the pyramid can be respective regions in (c).

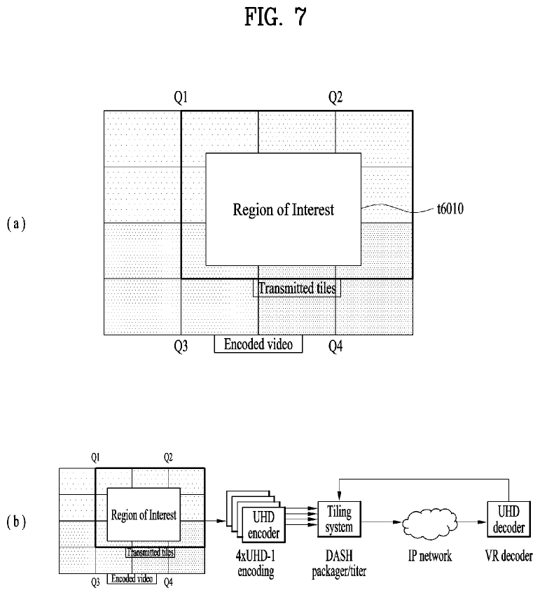

FIG. 7 illustrates tiles according to an embodiment of the present invention. 360 video data projected on a 2D image or region-wise packed 360 video data can be divided into one or more tiles. (a) shows that one 2D image is divided into 16 tiles. Here, the 2D image may be the aforementioned projected frame or packed frame. According to another embodiment of the 360 video transmission apparatus according to the present invention, the data encoder can independently encode the tiles.

The aforementioned region-wise packing can be discriminated from tiling. The aforementioned region-wise packing may refer to a process of dividing 360 video data projected on a 2D image into regions and processing the regions in order to increase coding efficiency or adjusting resolution. Tiling may refer to a process through which the data encoder divides a projected frame or a packed frame into tiles and independently encode the tiles. When 360 video is provided, a user does not simultaneously use all parts of the 360 video. Tiling enables only tiles corresponding to important part or specific part, such as a viewport currently viewed by the user, to be transmitted or consumed to or by a reception side on a limited bandwidth. Through tiling, a limited bandwidth can be used more efficiently and the reception side can reduce computational load compared to a case in which the entire 360 video data is processed simultaneously.

A region and a tile are discriminated from each other and thus they need not be identical. However, a region and a tile may refer to the same area according to an embodiment. Region-wise packing can be performed to tiles and thus regions can correspond to tiles according to an embodiment. Furthermore, when sides according to a projection scheme correspond to regions, each side, region and tile according to the projection scheme may refer to the same area according to an embodiment. A region may be called a VR region and a tile may be called a tile region according to context.

Region of Interest (ROI) may refer to a region of interest of users, which is provided by a 360 content provider. When 360 video is produced, the 360 content provider can produce the 360 video in consideration of a specific region which is expected to be a region of interest of users. According to an embodiment, ROI may correspond to a region in which important content of the 360 video is reproduced.

According to another embodiment of the 360 video transmission/reception apparatuses according to the present invention, the receiver feedback processor can extract and collect viewport information and deliver the same to the transmitter feedback processor. In this process, the viewport information can be delivered using network interfaces of both sides. In the 2D image shown in (a), a viewport t6010 is displayed. Here, the viewport may be displayed over nine tiles of the 2D images.

In this case, the 360 video transmission apparatus may further include a tiling system. According to an embodiment, the tiling system may be located following the data encoder (b), may be included in the aforementioned data encoder or transmission processor, or may be included in the 360 video transmission apparatus as a separate internal/external element.

The tiling system may receive viewport information from the transmitter feedback processor. The tiling system can select only tiles included in a viewport region and transmit the same. In the 2D image shown in (a), only nine tiles including the viewport region t6010 among 16 tiles can be transmitted. Here, the tiling system can transmit tiles in a unicast manner over a broadband because the viewport region is different for users.

In this case, the transmitter feedback processor can deliver the viewport information to the data encoder. The data encoder can encode the tiles including the viewport region with higher quality than other tiles.

Furthermore, the transmitter feedback processor can deliver the viewport information to the metadata processor. The metadata processor can deliver metadata related to the viewport region to each internal element of the 360 video transmission apparatus or include the metadata in 360 video related metadata.

By using this tiling method, transmission bandwidths can be saved and processes differentiated for tiles can be performed to achieve efficient data processing/transmission.

The above-described embodiments related to the viewport region can be applied to specific regions other than the viewport region in a similar manner. For example, the aforementioned processes performed on the viewport region can be performed on a region determined to be a region in which users are interested through the aforementioned gaze analysis, ROI, and a region (initial view, initial viewpoint) initially reproduced when a user views 360 video through a VR display.

According to another embodiment of the 360 video transmission apparatus according to the present invention, the transmission processor may perform processing for transmission differently on tiles. The transmission processor can apply different transmission parameters (modulation orders, code rates, etc.) to tiles such that data delivered for the tiles has different robustnesses.

Here, the transmitter feedback processor can deliver feedback information received from the 360 video reception apparatus to the transmission processor such that the transmission processor can perform transmission processing differentiated for tiles. For example, the transmitter feedback processor can deliver the viewport information received from the reception side to the transmission processor. The transmission processor can perform transmission processing such that tiles including the corresponding viewport region have higher robustness than other tiles.

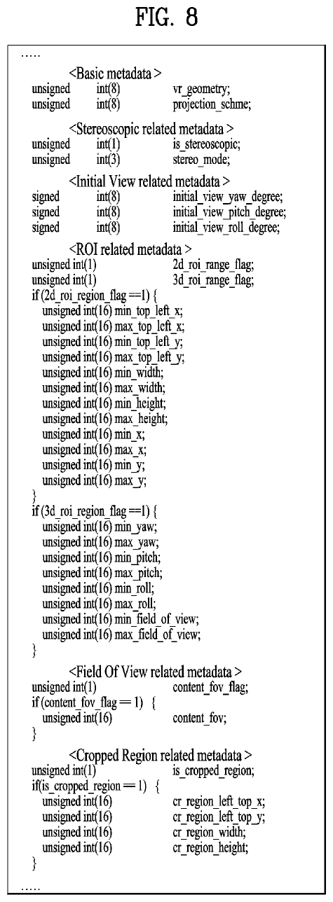

FIG. 8 illustrates 360-degree video related metadata according to an embodiment of the present invention.

The aforementioned 360 video related metadata may include various types of metadata related to 360 video. The 360 video related metadata may be called 360 video related signaling information according to context. The 360 video related metadata may be included in an additional signaling table and transmitted, included in a DASH MPD and transmitted, or included in a file format such as ISOBMFF in the form of box and delivered. When the 360 video related metadata is included in the form of box, the 360 video related metadata can be included in various levels such as a file, fragment, track, sample entry, sample, etc. and can include metadata about data of the corresponding level.

According to an embodiment, part of the metadata, which will be described below, may be configured in the form of a signaling table and delivered, and the remaining part may be included in a file format in the form of a box or a track.

According to an embodiment of the 360 video related metadata, the 360 video related metadata may include basic metadata related to a projection scheme, stereoscopic related metadata, initial view/initial viewpoint related metadata, ROI related metadata, FOV (Field of View) related metadata and/or cropped region related metadata. According to an embodiment, the 360 video related metadata may include additional metadata in addition to the aforementioned metadata.

Embodiments of the 360 video related metadata according to the present invention may include at least one of the aforementioned basic metadata, stereoscopic related metadata, initial view/initial viewpoint related metadata, ROI related metadata, FOV related metadata, cropped region related metadata and/or additional metadata. Embodiments of the 360 video related metadata according to the present invention may be configured in various manners depending on the number of cases of metadata included therein. According to an embodiment, the 360 video related metadata may further include additional metadata in addition to the aforementioned metadata.

The basic metadata may include 3D model related information, projection scheme related information and the like. The basic metadata can include a vr_geometry field, a projection_scheme field, etc. According to an embodiment, the basic metadata may further include additional information.

The vr_geometry field can indicate the type of a 3D model supported by the corresponding 360 video data. When the 360 video data is re-projected on a 3D space as described above, the 3D space can have a form according to a 3D model indicated by the vr_geometry field. According to an embodiment, a 3D model used for rendering may differ from the 3D model used for re-projection, indicated by the vr_geometry field. In this case, the basic metadata may further include a field which indicates the 3D model used for rendering. When the field has values of 0, 1, 2 and 3, the 3D space can conform to 3D models of a sphere, a cube, a cylinder and a pyramid. When the field has the remaining values, the field can be reserved for future use. According to an embodiment, the 360 video related metadata may further include detailed information about the 3D model indicated by the field. Here, the detailed information about the 3D model can refer to the radius of a sphere, the height of a cylinder, etc. for example. This field may be omitted.

The projection_scheme field can indicate a projection scheme used when the 360 video data is projected on a 2D image. When the field has values of 0, 1, 2, 3, 4, and 5, the field indicates that the equirectangular projection scheme, cubic projection scheme, cylindrical projection scheme, tile-based projection scheme, pyramid projection scheme and panoramic projection scheme are used. When the field has a value of 6, the field indicates that the 360 video data is directly projected on the 2D image without stitching. When the field has the remaining values, the field can be reserved for future use. According to an embodiment, the 360 video related metadata may further include detailed information about regions generated according to a projection scheme specified by the field. Here, the detailed information about regions may refer to information indicating whether regions have been rotated, the radius of the top region of a cylinder, etc. for example.

The stereoscopic related metadata may include information about 3D related properties of the 360 video data. The stereoscopic related metadata may include an is_stereoscopic field and/or a stereo_mode field. According to an embodiment, the stereoscopic related metadata may further include additional information.

The is_stereoscopic field can indicate whether the 360 video data supports 3D. When the field is 1, the 360 video data supports 3D. When the field is 0, the 360 video data does not support 3D. This field may be omitted.

The stereo_mode field can indicate 3D layout supported by the corresponding 360 video. Whether the 360 video supports 3D can be indicated only using this field. In this case, the is_stereoscopic field can be omitted. When the field is 0, the 360 video may be a mono mode. That is, the projected 2D image can include only one mono view. In this case, the 360 video may not support 3D.

When this field is 1 and 2, the 360 video can conform to left-right layout and top-bottom layout. The left-right layout and top-bottom layout may be called a side-by-side format and a top-bottom format. In the case of the left-right layout, 2D images on which left image/right image are projected can be locationed at the left/right on an image frame. In the case of the top-bottom layout, 2D images on which left image/right image are projected can be locationed at the top/bottom on an image frame. When the field has the remaining values, the field can be reserved for future use.

The initial view/initial viewpoint related metadata may include information about a view (initial view) which is viewed by a user when initially reproducing 360 video. The initial view/initial viewpoint related metadata may include an initial_view_yaw degree field, an initial_viewp_itch_degree field and/or an initial_view_roll_degree field. According to an embodiment, the initial view/initial viewpoint related metadata may further include additional information.

The initial_view_yaw degree field, initial_viewpitch_degree field and initial_view_roll_degree field can indicate an initial view when the 360 video is reproduced. That is, the center point of a viewport which is initially viewed when the 360 video is reproduced can be indicated by these three fields. The fields can indicate the center point using a direction (sign) and a degree (angle) of rotation on the basis of yaw, pitch and roll axes. Here, the viewport which is initially viewed when the 360 video is reproduced according to FOV The width and height of the initial viewport based on the indicated initial view can be determined through FOV. That is, the 360 video reception apparatus can provide a specific region of the 360 video as an initial viewport to a user using the three fields and FOV information.

According to an embodiment, the initial view indicated by the initial view/initial viewpoint related metadata may be changed per scene. That is, scenes of the 360 video change as 360 content proceeds with time. The initial view or initial viewport which is initially viewed by a user can change for each scene of the 360 video. In this case, the initial view/initial viewpoint related metadata can indicate the initial view per scene. To this end, the initial view/initial viewpoint related metadata may further include a scene identifier for identifying a scene to which the initial view is applied. In addition, since FOV may change per scene of the 360 video, the initial view/initial viewpoint related metadata may further include FOV information per scene which indicates FOV corresponding to the relative scene.

The ROI related metadata may include information related to the aforementioned ROI. The ROI related metadata may include a 2d_roi_range_flag field and/or a 3d_roi range_flag field. These two fields can indicate whether the ROI related metadata includes fields which represent ROI on the basis of a 2D image or fields which represent ROI on the basis of a 3D space. According to an embodiment, the ROI related metadata may further include additional information such as differentiate encoding information depending on ROI and differentiate transmission processing information depending on ROI.

When the ROI related metadata includes fields which represent ROI on the basis of a 2D image, the ROI related metadata can include a min_top_left_x field, a max_top_left_x field, a min_top_left_y field, a max top_left_y field, a min_width field, a max_width field, a min_height field, a max height field, a min_x field, a max_x field, a min_y field and/or a max_y field.

The min_top_left_x field, max top_left_x field, min top_left_y field, max_top_left_y field can represent minimum/maximum values of the coordinates of the left top end of the ROI. These fields can sequentially indicate a minimum x coordinate, a maximum x coordinate, a minimum y coordinate and a maximum y coordinate of the left top end.

The min_width field, max_width field, min_height field and max_height field can indicate minimum/maximum values of the width and height of the ROI. These fields can sequentially indicate a minimum value and a maximum value of the width and a minimum value and a maximum value of the height.

The min_x field, max_x field, min_y field and max_y field can indicate minimum and maximum values of coordinates in the ROI. These fields can sequentially indicate a minimum x coordinate, a maximum x coordinate, a minimum y coordinate and a maximum y coordinate of coordinates in the ROI. These fields can be omitted.

When ROI related metadata includes fields which indicate ROI on the basis of coordinates on a 3D rendering space, the ROI related metadata can include a min_yaw field, a max_yaw field, a min_pitch field, a max_pitch field, a min_roll field, a max_roll field, a min field of view field and/or a max field of view field.

The min_yaw field, max_yaw field, min_pitch field, max_pitch field, min_roll field and max_roll field can indicate a region occupied by ROI on a 3D space using minimum/maximum values of yaw, pitch and roll. These fields can sequentially indicate a minimum value of yaw-axis based reference rotation amount, a maximum value of yaw-axis based reference rotation amount, a minimum value of pitch-axis based reference rotation amount, a maximum value of pitch-axis based reference rotation amount, a minimum value of roll-axis based reference rotation amount, and a maximum value of roll-axis based reference rotation amount.

The min_field_of_view field and max_field_of_view field can indicate minimum/maximum values of FOV of the corresponding 360 video data. FOV can refer to the range of view displayed at once when 360 video is reproduced. The min_field_of_view field and max_field_of_view field can indicate minimum and maximum values of FOV These fields can be omitted. These fields may be included in FOV related metadata which will be described below.

The FOV related metadata can include the aforementioned FOV related information. The FOV related metadata can include a content_fov_flag field and/or a content_fov field. According to an embodiment, the FOV related metadata may further include additional information such as the aforementioned minimum/maximum value related information of FOV.

The content_fov_flag field can indicate whether corresponding 360 video includes information about FOV intended when the 360 video is produced. When this field value is 1, a content_fov field can be present.

The content_fov field can indicate information about FOV intended when the 360 video is produced. According to an embodiment, a region displayed to a user at once in the 360 video can be determined according to vertical or horizontal FOV of the 360 video reception apparatus. Alternatively, a region displayed to a user at once in the 360 video may be determined by reflecting FOV information of this field according to an embodiment.

Cropped region related metadata can include information about a region including 360 video data in an image frame. The image frame can include a 360 video data projected active video area and other areas. Here, the active video area can be called a cropped region or a default display region. The active video area is viewed as 360 video on an actual VR display and the 360 video reception apparatus or the VR display can process/display only the active video area. For example, when the aspect ratio of the image frame is 4:3, only an area of the image frame other than an upper part and a lower part of the image frame can include 360 video data. This area can be called the active video area.

The cropped region related metadata can include an is_cropped_region field, a cr_region_left_top_x field, a cr_region_left_top_y field, a cr_region_width field and/or a cr_region_height field. According to an embodiment, the cropped region related metadata may further include additional information.

The is_cropped_region field may be a flag which indicates whether the entire area of an image frame is used by the 360 video reception apparatus or the VR display. That is, this field can indicate whether the entire image frame indicates an active video area. When only part of the image frame is an active video area, the following four fields may be added.

A cr_region_left_top_x field, a cr_region_left_top_y field, a cr_region_width field and a cr_region_height field can indicate an active video area in an image frame. These fields can indicate the x coordinate of the left top, the y coordinate of the left top, the width and the height of the active video area. The width and the height can be represented in units of pixel.

As described above, the 360-degree video-related signaling information or metadata may be included in an arbitrarily defined signaling table, may be included in the form of a box in a file format such as ISOBMFF or Common File Format, or may be included and transmitted in a DASH MPD. In addition, 360-degree media data may be included and transmitted in such a file format or a DASH segment.

Hereinafter, ISOBMFF and DASH MPD will be described one by one.

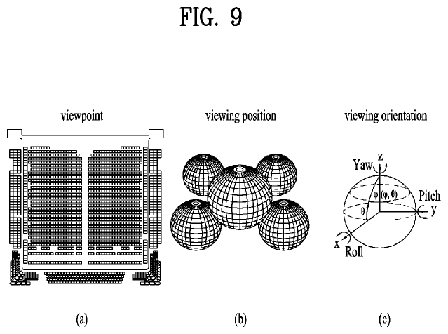

FIG. 9 illustrates a viewpoint and viewing location additionally defined in a 3DoF+VR system.

The 360 video based VR system accoriding to embodiments may provide visual/auditory experiences for different viewing orientations with resepect to a location of a user for 360 video based on the 360 video processing process described above. This method may be referred to as three degree of freedom (3DoF) plus. Specifically, the VR system that provides visual/auditory experiences for different orientations in a fixed location of a user may be referred to as a 3DoF based VR system.

The VR system that may provide extended visual/auditory experiences for different orientations in different viewpoints and different viewing locations in the same time zone may be referred to as a 3DoF+ or 3DoF plus based VR system.
1) Supposing a space such as (a) (an example of art center), different locations (an example of art center marked with a red circle) may be considered as the respective viewpoints. Here, video/audio provided by the respective viewpoints existing in the same space as in the example may have the same time flow.
2) In this case, different visual/auditory experiences may be provided according to a viewpoint change (head motion) of a user in a specific location. That is, spheres of various viewing locations may be assumed as shown in (b) for a specific viewpoint, and video/audio/text information in which a relative location of each viewpoint is reflected may be provided.
3) Visual/auditory information of various orientations such as the existing 3DoF may be delivered at a specific viewpoint of a specific location as shown in (c). In this case, additional various sources as well as main sources (video/audio/text) may be provided in combination, and this may be associated with a viewing orientation of a user or information may be delivered independently.

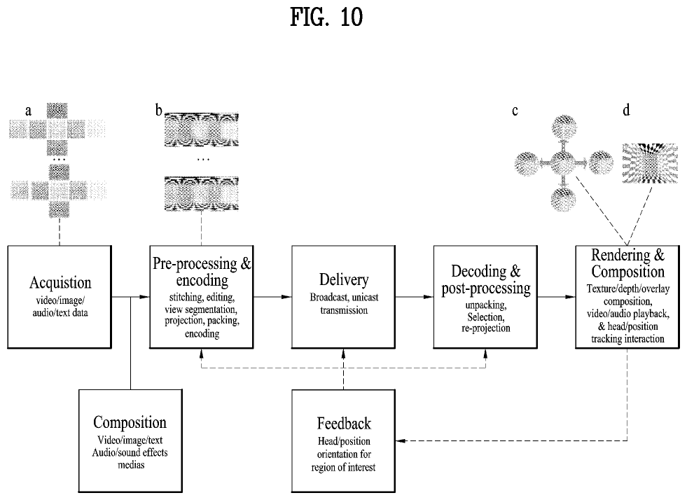

FIG. 10 is a view showing a method for implementing 360-degree video signal processing and a related transmission apparatus/reception apparatus based on 3DoF+system.

FIG. 10 is an example of 3DoF+ end-to-end system flow chart including video acquisition, pre-processing, transmission, (post)processing, rendering and feedback processes of 3DoF+.
1) Acquisition: may mean a process of acquiring 360-degree video through capture, composition or generation of 360-degree video. Various kinds of video/audio information according to head motion may be acquired for a plurality of locations through this process. In this case, video information may include depth information as well as visual information (texture). At this time, a plurality of kinds of information of different viewing locations according to different viewpoints may be acquired as in the example of video information of a.
2) Composition: may define a method for composition to include video (video/image, etc.) through external media, voice (audio/effect sound, etc.) and text (caption, etc.) as well as information acquired through the video/audio input module in user experiences.
3) Pre-processing: is a preparation (pre-processing) process for transmission/delivery of the acquired 360-degree video, and may include stitching, projection, region wise packing and/or encoding process. That is, this process may include pre-processing and encoding processes for modifying/complementing data such as video/audio/text information according to a producer's intention. For example, the pre-processing process of the video may include mapping (stitching) of the acquired visual information onto 360 sphere, editing such as removing a region boundary, reducing difference in color/brightness or providing visual effect of video, view segmentation according to viewpoint, a projection for mapping video on 360 sphere into 2D image, region-wise packing for rearranging video according to a region, and encoding for compressing video information. A plurality of projection videos of different viewing locations according to different viewpoints may be generated like example in view of video of B.
4) Delivery: may mean a process of processing and transmitting video/audio data and metadata subjected to the preparation process (pre-processing). As a method for delivering a plurality of video/audio data and related metadata of different viewing locations according to different viewpoints, a broadcast network or a communication network may be used, or unidirectional delivery method may be used.
5) Post-processing & composition: may mean a post-processing process for decoding and finally reproducing received/stored video/audio/text data. For example, the post-processing process may include unpacking for unpacking a packed video and re-projection for restoring 2D projected image to 3D sphere image as described above.
6) Rendering: may mean a process of rendering and displaying re-projected image/video data on a 3D space. In this process, the process may be reconfigured to finally output video/audio signals. A viewing orientation, viewing location/head location and viewpoint, in which a user's region of interest exists, may be subjected to tracking, and necessary video/audio/text information may selectively be used according to this information. At this time, in case of video signal, different viewing locations may be selected according to the user's region of interest as shown in c, and video in a specific orientation of a specific viewpoint at a specific location may finally be output as shown in d.
7) Feedback: may mean a process of delivering various kinds of feedback information, which can be acquired during a display process, to a transmission side. In this embodiment, a viewing orientation, a viewing location, and a viewpoint, which corresponds to a user's region of interest, may be estimated, and feedback may be delivered to reproduce video/audio based on the estimated result.

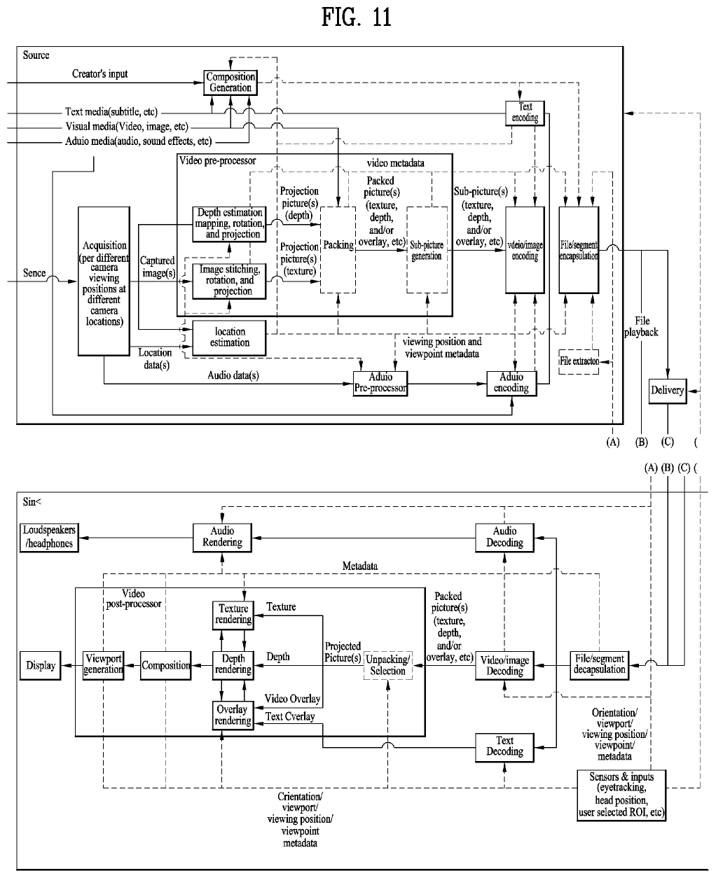

FIG. 11 illustrates an architecture of a 3DoF+ end-to-end system.

FIG. 11 illustrates an architecture of a 3DoF+ end-to-end system. As described in the architecture of FIG. 11, 3DoF+360 contents may be provided.

The 360-degree video transmission apparatus may include an acquisition unit for acquiring 360-degree video (image)/audio data, a video/audio pre-processor for processing the acquired data, a composition generation unit for composing additional information an encoding unit for encoding text, audio and projected 360-degree video, and an encapsulation unit for encapsulating the encoded data. As described above, the encapsulated data may be output in the form of bitstreams. The encoded data may be encapsulated in a file format such as ISOBMFF and CFF, or may be processed in the form of other DASH segment. The encoded data may be delivered to the 360-degree video reception apparatus through a digital storage medium. Although not shown explicitly, the encoded data may be subjected to processing for transmission through the transmission-processor and then transmitted through a broadcast network or a broadband, as described above.

The data acquisition unit may simultaneously or continuously acquire different kinds of information according to sensor orientation (viewing orientation in view of video), information acquisition timing of a sensor (sensor location, or viewing location in view of video), and information acquisition location of a sensor (viewpoint in case of video). At this time, video, image, audio and location information may be acquired.

In case of video data, texture and depth information may respectively be acquired, and video pre-processing may be performed according to characteristic of each component. For example, in case of the text information, 360-degree omnidirectional video may be configured using videos of different orientations of the same viewing location, which are acquired at the same viewpoint using image sensor location information. To this end, video stitching may be performed. Also, projection and/or region wise packing for modifying the video to a format for encoding may be performed. In case of depth image, the image may generally be acquired through a depth camera. In this case, the depth image may be made in the same format such as texture. Alternatively, depth data may be generated based on data measured separately. After image per component is generated, additional conversion (packing) to a video format for efficient compression may be performed, or a sub-picture generation for reconfiguring the images by segmentation into sub-pictures which are actually necessary may be performed. Information on image configuration used in a video pre-processing end is delivered as video metadata.

If additionally given video/audio/text information is served together with the acquired data (or data for main service), it is required to provide information for composing these kinds of information during final reproduction. The composition generation unit generates information for composing externally generated media data (video/image in case of video, audio/effect sound in case of audio, and caption in case of text) at a final reproduction end based on a producer's intention, and this information is delivered as composition data.

The video/audio/text information subjected to each processing is compressed using each encoder, and encapsulated on a file or segment basis according to application. At this time, only necessary information may be extracted (file extractor) according to a method for configuring video, file or segment.

Also, information for reconfiguring each data in the receiver is delivered at a codec or file format/system level, and in this case, the information includes information (video/audio metadata) for video/audio reconfiguration, composition information (composition metadata) for overlay, viewpoint capable of reproducing video/audio and viewing location information according to each viewpoint (viewing location and viewpoint metadata), etc. This information may be processed through a separate metadata processor.

The 360-degree video reception apparatus may include a file/segment decapsulation unit for decapsulating a received file and segment, a decoding unit for generating video/audio/text information from bitstreams, a post-processor for reconfiguring the video/audio/text in the form of reproduction, a tracking unit for tracking a user's region of interest, and a display which is a reproduction unit.

The bitstreams generated through decapsulation may be segmented into video/audio/text according to types of data and separately decoded to be reproduced.

The tracking unit generates viewpoint of a user's region of interest, viewing location at the corresponding viewpoint, and viewing orientation information at the corresponding viewing location based on a sensor and the user's input information. This information may be used for selection or extraction of a region of interest in each module of the 360-degree video reception apparatus, or may be used for a post-processing process for emphasizing information of the region of interest. Also, if this information is delivered to the 360-degree video transmission apparatus, this information may be used for file selection (file extractor) or subpicture selection for efficient bandwidth use, and may be used for various video reconfiguration methods based on a region of interest (viewport/viewing location/viewpoint dependent processing).

The decoded video signal may be processed according to various processing methods of the video configuration method. If image packing is performed in the 360-degree video transmission apparatus, a process of reconfiguring video is required based on the information delivered through metadata. In this case, video metadata generated by the 360-degree video transmission apparatus may be used. Also, if videos of a plurality of viewpoints or a plurality of viewing locations or various orientations are included in the decoded video, information matched with viewpoint, viewing location, and orientation information of the user's region of interest, which are generated through tracking, may be selected and processed. At this time, viewing location and viewpoint metadata generated at the transmission side may be used. Also, if a plurality of components are delivered for a specific location, viewpoint and orientation or video information for overlay is separately delivered, a rendering process for each of the data and information may be included. The video data (texture, depth and overlay) subjected to a separate rendering process may be subjected to a composition process. At this time, composition metadata generated by the transmission side may be used. Finally, information for reproduction in viewport may be generated according to the user's ROI.

The decoded audio signal may be generated as an audio signal capable of being reproduced, through an audio renderer and/or the post-processing process. At this time, information suitable for the user's request may be generated based on the information on the user's ROI and the metadata delivered to the 360-degree video reception apparatus.

The decoded text signal may be delivered to an overlay renderer and processed as overlay information based on text such as subtitle. A separate text post-processing process may be included, if necessary.

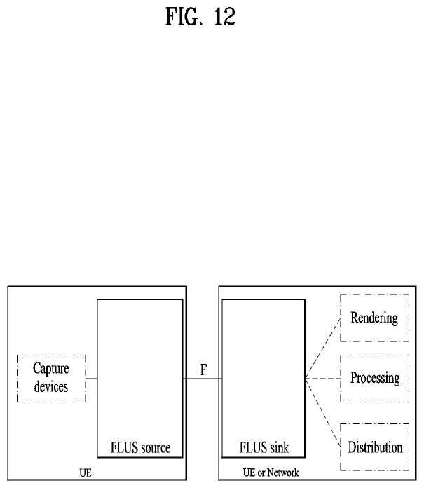

FIG. 12 illustrates an architecture of a Frame for Live Uplink Streaming (FLUS).

The detailed blocks of the transmission side and the reception side may be categorized into functions of a source and a sink in FLUS (Framework for Live Uplink Streaming). In this case, the information acquisition unit may implement the function of the source, implement the function of the sink on a network, or implement source/sink within a network node, as follows. The network node may include a user equipment (UE). The UE may include the aforementioned 360-degree video transmission apparatus or the aforementioned 360-degree reception apparatus.

A transmission and reception processing process based on the aforementioned architecture may be described as follows. The following transmission and reception processing process is described based on the video signal processing process. If the other signals such as audio or text are processed, a portion marked with italic may be omitted or may be processed by being modified to be suitable for audio or text processing process.

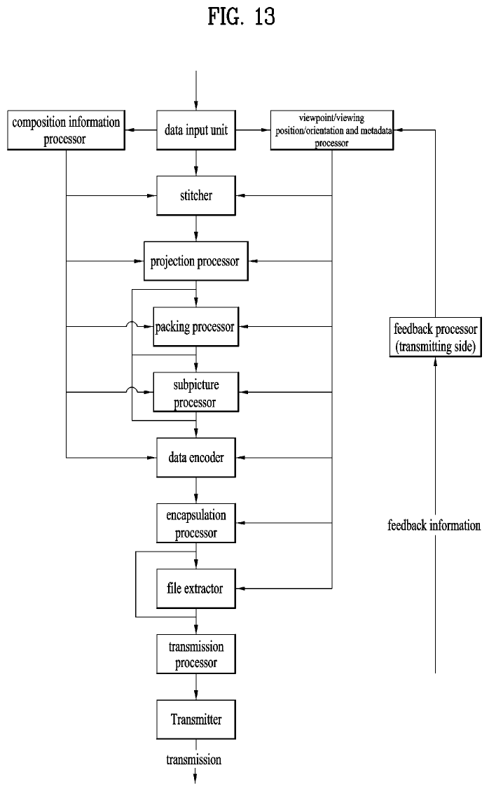

FIG. 13 is a view showing a configuration of 3DoF+ transmission side.

The transmission side (the 360 video transmission apparatus) may perform stitching for sphere image configuration per viewpoint/viewing location/component if input data are images output through a camera. If sphere images per viewpoint/viewing location/component are configured, the transmission side may perform projection for coding in 2D image. The transmission side may generate a plurality of images as subpictures of a packing or segmented region for making an integrated image according to application. As described above, the region wise packing process is an optional process, and may not be performed. In this case, the packing process may be omitted. If the input data are video/audio/text additional information, a method for displaying additional information by adding the additional information to a center image may be notified, and the additional data may be transmitted together. The encoding process for compressing the generated images and the added data to generate bitstreams may be performed and then the encapsulation process for converting the bitstreams to a file format for transmission or storage may be performed. At this time, a process of extracting a file requested by the reception side may be processed according to application or request of the system. The generated bitstreams may be transformed into the transport format through the transmission-processor and then transmitted. At this time, the feedback processor of the transmission side may process viewpoint/viewing location/orientation information and necessary metadata based on the information delivered from the reception side and deliver the information to the related transmission side so that the transmission side may process the corresponding data.

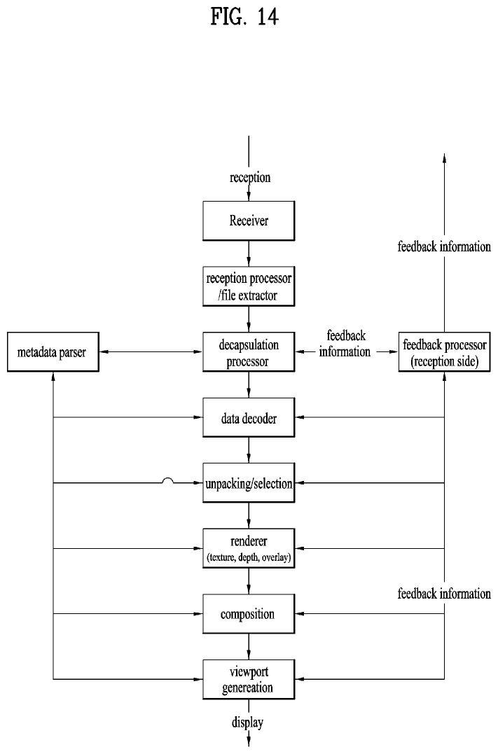

FIG. 14 illustrates a configuration of 3DoF+ reception side.

The reception side (the 360 video reception apparatus) may extract a necessary file after receiving the bitstreams delivered from the transmission side. The reception side may select bitstreams in the generated file format by using the viewpoint/viewing location/orientation information delivered from the feedback processor and reconfigure the selected bitstreams as image information through the decoder. The reception side may perform unpacking for the packed image based on packing information delivered through the metadata. If the packing process is omitted in the transmission side, unpacking of the reception side may also be omitted. Also, the reception side may perform a process of selecting images suitable for the viewpoint/viewing location/orientation information delivered from the feedback processor and necessary components if necessary. The reception side may perform a rendering process of reconfiguring texture, depth and overlay information of images as a format suitable for reproduction. The reception side may perform a composition process for composing information of different layers before generating a final image, and may generate and reproduce an image suitable for a display viewport.

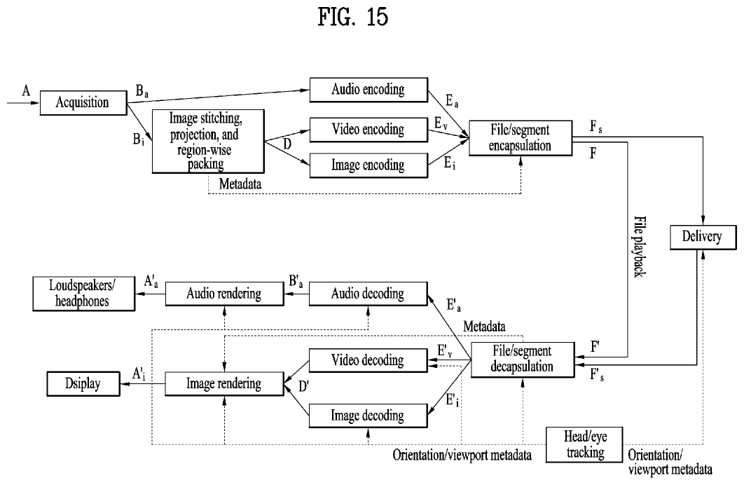

FIG. 15 is a view showing an OMAF structure.

The 360 video based VR system may provide visual/auditory experiences for different viewing orientations based on a location of a user for 360-degree video based on the 360-degree video processing process. A service for providing visual/auditory experiences for different orientations in a fixed location of a user with respect to 360-degree video may be referred to as a 3DoF based service. Meanwhile, a service for providing extended visual/auditory experiences for different orientations in a random viewpoint and viewing location at the same time zone may be referred to as a 6DoF (six degree of freedom) based service.

A file format for 3DoF service has a structure in which a location of rendering, information of a file to be transmitted, and decoding information may be varied depending on a head/eye tracking module as shown in FIG. 15. However, this structure is not suitable for transmission of a media file of 6DoF in which rendering information/transmission details and decoding information are varied depending on a viewpoint or location of a user, correction is required.

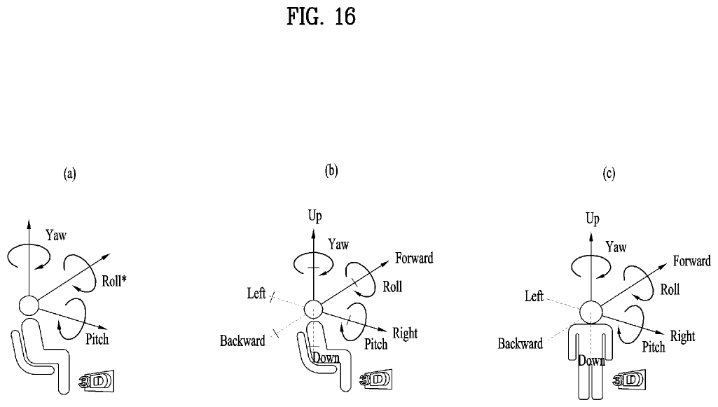

FIG. 16 is a view showing a type of media according to movement of a user.

The embodiments propose a method for providing 6DoF content to provide a user with experiences of immersive media/realistic media. The immersive media/realistic media is a concept extended from a virtual environment provided by the existing 360 contents, and the location of the user is fixed in the form of (a) of the existing 360-degree video contents.

If the immersive media/realistic media has only a concept of rotation, the immersive media/realistic media may mean an environment or contents, which can provide a user with more sensory experiences such as movement/rotation of the user in a virtual space by giving a concept of movement when the user experiences contents as described in (b) or (c).

(a) indicates media experiences if a view of a user is rotated in a state that a location of the user is fixed.

(b) indicates media experiences if a user's head may additionally move in addition to a state that a location of the user is fixed.

(c) indicates media experiences when a location of a user may move.

The realistic media contents may include 6DoF video and 6DoF audio for providing corresponding contents, wherein 6DoF video may mean video or image required to provide realistic media contents and captured or reproduced as 3DoF or 360-degree video newly formed during every movement. 6DoF content may mean videos or images displayed on a 3D space. If movement within contents is fixed, the corresponding contents may be displayed on various types of 3D spaces like the existing 360-degree video. For example, the corresponding contents may be displayed on a spherical surface. If movement within the contents is a free state, a 3D space may newly be formed on a moving path based on the user every time and the user may experience contents of the corresponding location. For example, if the user experiences an image displayed on a spherical surface at a location where the user first views, and actually moves on the 3D space, a new image on the spherical surface may be formed based on the moved location and the corresponding contents may be consumed. Likewise, 6DoF audio is an audio content for providing a content to allow a user to experience realistic media, and may mean contents for newly forming and consuming a spatial audio according to movement of a location where sound is consumed.

Embodiments propose a method for effectively providing 6DoF video. The 6DoF video may be captured at different locations by two or more cameras. The captured video may be transmitted through a series of processes, and the reception side may process and render some of the received data as 360-degree video having an initial location of the user as a starting point. If the location of the user moves, the reception side may process and render new 360-degree video based on the location where the user has moved, whereby the 6DoF video may be provided to the user.

Hereinafter, a transmission method and a reception method for providing 6DoF video services will be described.

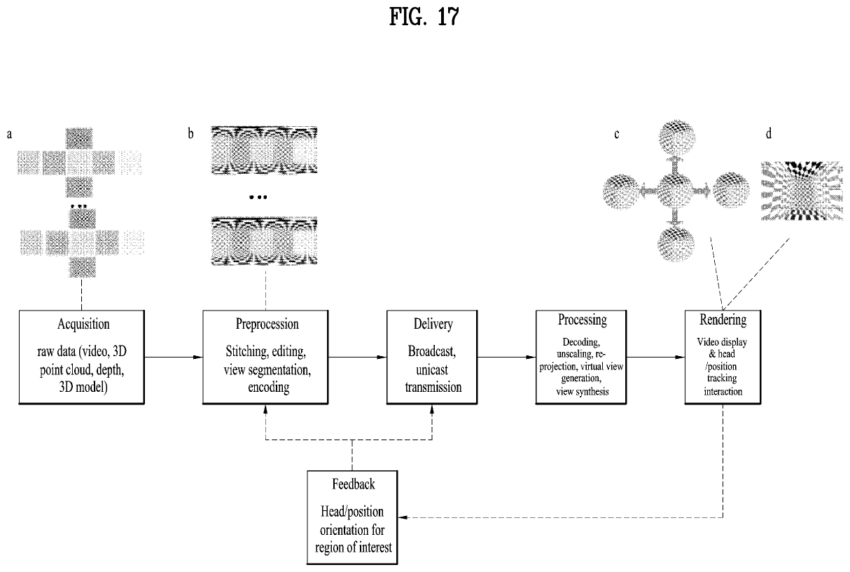

FIG. 17 is a view showing the entire architecture for providing 6DoF video.

A series of processes described above will be described in detail based on FIG. 17. First of all, as an acquisition step, HDCA (High Density Camera Array), Lenslet (microlens) camera, etc. may be used to capture 6DoF contents, and 6DoF video may be acquired by a new device designed for capture of the 6DoF video. The acquired video may be generated as several image/video data sets generated according to a location of a camera, which is captured as shown in FIG. 3a. At this time, metadata such as internal/external setup values of the camera may be generated during the capturing process. In case of image generated by a computer not the camera, the capturing process may be replaced. The pre-processing process of the acquired video may be a process of processing the captured image/video and the metadata delivered through the capturing process. This process may correspond to all of types of pre-processing steps such as a stitching process, a color correction process, a projection process, a view segmentation process for segmenting views into a primary view and a secondary view to enhance coding efficiency, and an encoding process.

The stitching process may be a process of making image/video by connecting image captured in the direction of 360-degree in a location of each camera with image in the form of panorama or sphere based on the location of each camera. Projection means a process of projecting the image resultant from the stitching process to a 2D image as shown in FIG. 3b, and may be expressed as mapping into 2D image. The image mapped in the location of each camera may be segmented into a primary view and a secondary view such that resolution different per view may be applied to enhance video coding efficiency, and arrangement or resolution of mapping image may be varied even within the primary view, whereby efficiency may be enhanced during coding. The secondary view may not exist depending on the capture environment. The secondary view means image/video to be reproduced during a movement process when a user moves from the primary view to another primary view, and may have resolution lower than that of the primary view but may have the same resolution as that of the primary view if necessary. The secondary view may be newly generated as virtual information by the receiver in some cases.

In some embodiments, the pre-processing process may further include an editing process. In this process, editing for image/video data may further be performed before and after projection, and metadata may be generated even during the pre-processing process. Also, when the image/video are provided, metadata for an initial view to be first reproduced and an initial location and a region of interest (ROI) of a user may be generated.

The media transmission step may be a process of processing and transmitting the image/video data and metadata acquired during the pre-processing process. Processing according to a random transmission protocol may be performed for transmission, and the pre-processed data may be delivered through a broadcast network and/or a broadband. The pre-processed data may be delivered to the reception side on demand.

The processing process may include all steps before image is generated, wherein all steps may include decoding the received image/video data and metadata, re-projection which may be called mapping or projection into a 3D model, and a virtual view generation and composition process. The 3D model which is mapped or a projection map may include a sphere, a cube, a cylinder or a pyramid like the existing 360-degree video, and may be a modified type of a projection map of the existing 360-degree video, or may be a projection map of a free type in some cases.

The virtual view generation and composition process may mean a process of generating and composing the image/video data to be reproduced when the user moves between the primary view and the secondary view or between the primary view and the primary view. The process of processing the metadata delivered during the capture and pre-processing processes may be required to generate the virtual view. In some cases, only some of the 360 images/videos may be generated/composed.

In some embodiments, the processing process may further include an editing process, an up scaling process, and a down scaling process. Additional editing required before reproduction may be applied to the editing process after the processing process. The process of up scaling or down scaling the received images/videos may be performed, if necessary.

The rendering process may mean a process of rendering image/video, which is re-projected by being transmitted or generated, to be displayed. As the case may be, rendering and re-projection process may be referred to as rendering. Therefore, the rendering process may include the re-projection process. A plurality of re-projection results may exist in the form of 360 degree video/image based on the user and 360 degree video/image formed based on the location where the user moves according to a moving direction as shown in FIG. 3c. The user may view some region of the 360 degree video/image according to a device to be displayed. At this time, the region viewed by the user may be a form as shown in FIG. 3d. When the user moves, the entire 360 degree videos/images may not be rendered but the image corresponding to the location where the user views may only be rendered. Also, metadata for the location and the moving direction of the user may be delivered to previously predict movement, and video/image of a location to which the user will move may additionally be rendered.

The feedback process may mean a process of delivering various kinds of feedback information, which can be acquired during the display process, to the transmission side. Interactivity between 6DoF content and the user may occur through the feedback process. In some embodiments, the user's head/location orientation and information on a viewport where the user currently views may be delivered during the feedback process. The corresponding information may be delivered to the transmission side or a service provider during the feedback process. In some embodiments, the feedback process may not be performed.

The user's location information may mean information on the user's head location, angle, movement and moving distance. Information on a viewport where the user views may be calculated based on the corresponding information.

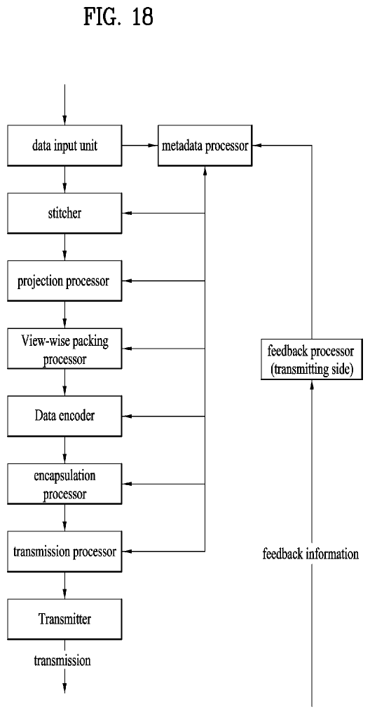

FIG. 18 is a view showing a configuration of a transmission apparatus for providing 6DoF video services.

Embodiments at the transmission side may relate to the 6DoF video transmission apparatus. The 6DoF video transmission apparatus may perform the aforementioned preparation processes and operations. The 6DoF video/image transmission apparatus according to the present invention may include a data input unit, a depth information processor (not shown), a stitcher, a projection processor, a view segmentation processor, a packing processor per view, a metadata processor, a feedback processor, a data encoder, an encapsulation processor, a transmission-processor, and/or a transmission unit as internal/external components.

The data input unit may receive image/video/depth information/audio data per view captured by one or more cameras at one or more locations. The data input unit may receive metadata generated during the capturing process together with the video/image/depth information/audio data. The data input unit may deliver the input video/image data per view to the stitcher and deliver the metadata generated during the capturing process to the metadata processor.

The stitcher may perform stitching for image/video per captured view/location. The stitcher may deliver the stitched 360 degree video data to the processor. The stitcher may perform stitching for the metadata delivered from the metadata processor if necessary. The stitcher may deliver the metadata generated during the stitching process to the metadata processor. The stitcher may vary a video/image stitching location by using a location value delivered from the depth information processor (not shown). The stitcher may deliver the metadata generated during the stitching process to the metadata processor. The delivered metadata may include information as to whether stitching has been performed, a stitching type, IDs of a primary view and a secondary view, and location information on a corresponding view.

The projection processor may perform projection for the stitched 6DoF video data to 2D image frame. The projection processor may obtain different types of results according to a scheme, and the corresponding scheme may similar to the projection scheme of the existing 360 degree video, or a scheme newly proposed for 6DoF may be applied to the corresponding scheme. Also, different schemes may be applied to the respective views. The depth information processor may deliver depth information to the projection processor to vary a mapping resultant value. The projection processor may receive metadata required for projection from the metadata processor and use the metadata for a projection task if necessary, and may deliver the metadata generated during the projection process to the metadata processor. The corresponding metadata may include a type of a scheme, information as to whether projection has been performed, ID of 2D frame after projection for a primary view and a secondary view, and location information per view.

The packing processor per view may segment view into a primary view and a secondary view as described above and perform region wise packing within each view. That is, the packing processor per view may categorize 6DoF video data projected per view/location into a primary view and a secondary view and allow the primary view and the secondary view to have their respective resolutions different from each other so as to enhance coding efficiency, or may vary rotation and rearrangement of the video data of each view and vary resolution per region categorized within each view. The process of categorizing the primary view and the second view may be optional and thus omitted. The process of varying resolution per region and arrangement may selectively be performed. When the packing processor per view is performed, packing may be performed using the information delivered from the metadata processor, and the metadata generated during the packing process may be delivered to the metadata processor. The metadata defined in the packing process per view may be ID of each view for categorizing each view into a primary view and a secondary view, a size applied per region within a view, and a rotation location value per region.

The stitcher, the projection processor and/or the packing processor per view described as above may occur in an ingest server within one or more hardware components or streaming/download services in some embodiments.

The metadata processor may process metadata, which may occur in the capturing process, the stitching process, the projection process, the packing process per view, the encoding process, the encapsulation process and/or the transmission process. The metadata processor may generate new metadata for 6DoF video service by using the metadata delivered from each process. In some embodiments, the metadata processor may generate new metadata in the form of signaling table. The metadata processor may deliver the delivered metadata and the metadata newly generated/processed therein to another components. The metadata processor may deliver the metadata generated or delivered to the data encoder, the encapsulation processor and/or the transmission-processor to finally transmit the metadata to the reception side.

The data encoder may encode the 6DoF video data projected on the 2D image frame and/or the view/region-wise packed video data. The video data may be encoded in various formats, and encoded result values per view may be delivered separately if category per view is made.

The encapsulation processor may encapsulate the encoded 6DoF video data and/or the related metadata in the form of a file. The related metadata may be received from the aforementioned metadata processor. The encapsulation processor may encapsulate the corresponding data in a file format of ISOBMFF or OMAF, or may process the corresponding data in the form of a DASH segment, or may process the corresponding data in a new type file format. The metadata may be included in various levels of boxes in the file format, or may be included as data in a separate track, or may separately be encapsulated per view. The metadata required per view and the corresponding video information may be encapsulated together.

The transmission processor may perform additional processing for transmission on the encapsulated video data according to the format. The corresponding processing may be performed using the metadata received from the metadata processor. The transmission unit may transmit the data and/or the metadata received from the transmission-processor through a broadcast network and/or a broadband. The transmission-processor may include components required during transmission through the broadcast network and/or the broadband.

The feedback processor (transmission side) may further include a network interface (not shown). The network interface may receive feedback information from the reception apparatus, which will be described later, and may deliver the feedback information to the feedback processor (transmission side). The feedback processor may deliver the information received from the reception side to the stitcher, the projection processor, the packing processor per view, the encoder, the encapsulation processor and/or the transmission-processor. The feedback processor may deliver the information to the metadata processor so that the metadata processor may deliver the information to the other components or generate/process new metadata and then deliver the generated/processed metadata to the other components. According to another embodiment, the feedback processor may deliver location/view information received from the network interface to the metadata processor, and the metadata processor may deliver the corresponding location/view information to the projection processor, the packing processor per view, the encapsulation processor and/or the data encoder to transmit only information suitable for current view/location of the user and peripheral information, thereby enhancing coding efficiency.

The components of the aforementioned 6DoF video transmission apparatus may be hardware components implemented by hardware. In some embodiments, the respective components may be modified or omitted or new components may be added thereto, or may be replaced with or incorporated into the other components.

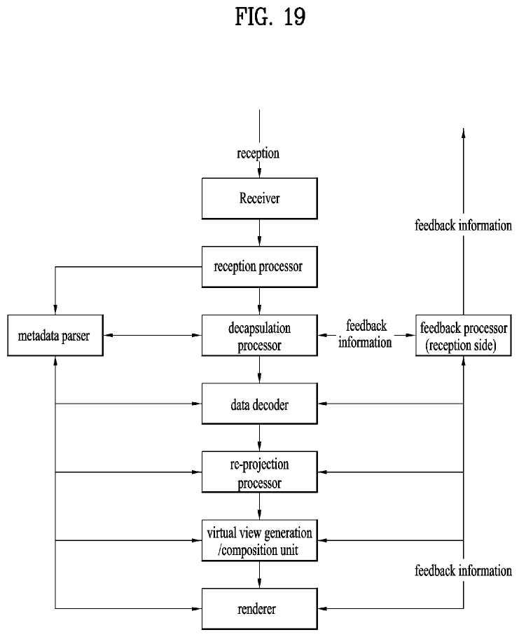

FIG. 19 illustrates a configuration of a 6DoF video reception apparatus.

The present invention may be related to the reception apparatus. According to the present invention, the 6DoF video reception apparatus may include a reception unit, a reception processor, a decapsulation-processor, a metadata parser, a feedback processor, a data decoder, a re-projection processor, a virtual view generation/composition unit and/or a renderer as components.

The reception unit may receive video data from the aforementioned 6DoF transmission apparatus. The reception unit may receive the video data through a broadcast network or a broadband according to a channel through which the video data are transmitted.

The reception processor may perform processing according to a transmission protocol for the received 6DoF video data. The reception processor may perform an inverse processing of the process performed in the transmission processor or perform processing according to a protocol processing method to acquire data obtained at a previous step of the transmission processor. The reception processor may deliver the acquired data to the decapsulation-processor, and may deliver metadata information received from the reception unit to the metadata parser.

The decapsulation-processor may decapsulate the 6DoF video data received in the form of file from the reception-processor. The decapsulation-processor may decapsulate the files to be matched with the corresponding file format to acquire 6DoF video and/or metadata. The acquired 6DoF video data may be delivered to the data decoder, and the acquired 6DoF metadata may be delivered to the metadata parser. The decapsulation-processor may receive metadata necessary for decapsulation from the metadata parser, when necessary.

The data decoder may decode the 6DoF video data. The data decoder may receive metadata necessary for decoding from the metadata parser. The metadata acquired during the data decoding process may be delivered to the metadata parser and then processed.

The metadata parser may parse/decode the 6DoF video-related metadata. The metadata parser may deliver the acquired metadata to the decapsulation-processor, the data decoder, the re-projection processor, the virtual view generation/composition unit and/or the renderer.

The re-projection processor may re-project the decoded 6DoF video data. The re-projection processor may re-project the 6DoF video data per view/location in a 3D space. The 3D space may have different forms depending on the 3D models that are used, or may be re-projected on the same type of 3D model through a conversion process. The re-projection processor may receive metadata necessary for re-projection from the metadata parser. The re-projection processor may deliver the metadata defined during the re-projection process to the metadata parser. For example, the re-projection processor may receive 3D model of the 6DoF video data per view/location from the metadata parser. If 3D model of video data is different per view/location and video data of all views are re-projected in the same 3D model, the re-projection processor may deliver the type of the 3D model that is applied, to the metadata parser. In some embodiments, the re-projection processor may re-project only a specific area in the 3D space using the metadata for re-projection, or may re-project one or more specific areas.

The virtual view generation/composition unit may generate video data, which are not included in the 6DoF video data re-projected by being transmitted and received on the 3D space but need to be reproduced, in a virtual view area by using given data, and may compose video data in a new view/location based on the virtual view. The virtual view generation/composition unit may use data of the depth information processor (not shown) when generating video data of a new view. The virtual view generation/composition unit may generate/compose the specific area received from the metadata parser and a portion of a peripheral virtual view area, which is not received. The virtual view generation/composition unit may selectively be performed, and is performed when there is no video information corresponding to a necessary view and location.

The renderer may render the 6DoF video data delivered from the re-projection unit and the virtual view generation/composition unit. As described above, all the processes occurring in the re-projection unit or the virtual view generation/composition unit on the 3D space may be incorporated within the renderer such that the renderer can perform these processes. In some embodiments, the renderer may render only a portion that is being viewed by a user and a portion on a predicted path according to the user's view/location information.

In the present invention, the feedback processor (reception side) and/or the network interface (not shown) may be included as additional components. The feedback processor of the reception side may acquire and process feedback information from the renderer, the virtual view generation/composition unit, the re-projection processor, the data decoder, the decapsulation unit and/or the VR display. The feedback information may include viewport information, head and location orientation information, gaze information, and gesture information. The network interface may receive the feedback information from the feedback processor, and may transmit the feedback information to the transmission unit. The feedback information may be consumed in each component of the reception side. For example, the decapsulation processor may receive location/viewpoint information of the user from the feedback processor, and may perform decapsulation, decoding, re-projection and rendering for corresponding location information if there is the corresponding location information in the received 6DoF video. If there is no corresponding location information, the 6DoF video located near the corresponding location may be subjected to decapsulation, decoding, re-projection, virtual view generation/composition, and rendering.

The components of the aforementioned 6DoF video reception apparatus may be hardware components implemented by hardware. In some embodiments, the respective components may be modified or omitted or new components may be added thereto, or may be replaced with or incorporated into the other components.

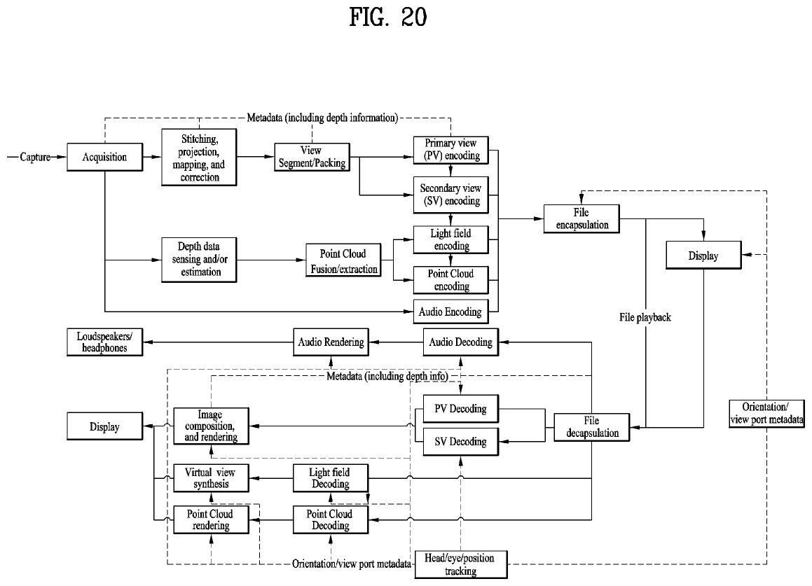

FIG. 20 illustrates a configuration of a 6DoF video transmission/reception apparatus.

6DoF contents may be provided in the form of a file or a segment-based download or streaming service such as DASH, or a new file format or streaming/download service method may be used. In this case, 6DoF contents may be called immersive media contents, light field contents, or point cloud contents.

As described above, each process for providing a corresponding file and streaming/download services may be described in detail as follows.

Acquisition: is an output obtained after being captured from a camera for acquiring multi view/stereo/depth image, and two or more videos/images and audio data are obtained, and a depth map in each scene may be acquired if there is a depth camera.

Audio encoding: 6DoF audio data may be subjected to audio pre-processing and encoding. In this process, metadata may be generated, and related metadata may be subjected to encapsulation/encoding for transmission.

Stitching, projection, mapping, and correction: 6DoF video data may be subjected to editing, stitching and projection of the image acquired at various locations as described above. Some of these processes may be performed according to the embodiment, or all of the processes may be omitted and then may be performed by the reception side.

View segmentation/packing: As described above, the view segmentation/packing processor may segment images of a primary view (PV), which are required by the reception side, based on the stitched image and pack the segmented images and then perform pre-processing for packing the other images as secondary views. Size, resolution, etc. of the primary view and the secondary views may be controlled during the packing process to enhance coding efficiency. Resolution may be varied even within the same view depending on a condition per region, or rotation and rearrangement may be performed depending on the region.

Depth sensing and/or estimation: is intended to perform a process of extracting a depth map from two or more acquired videos if there is no depth camera. If there is a depth camera, a process of storing location information as to a depth of each object included in each image in image acquisition location may be performed.

Point cloud fusion/extraction: a process of modifying a previously acquired depth map to data capable of being encoded may be performed. For example, a pre-processing of allocating a location value of each object of image on 3D by modifying the depth map to a point cloud data type may be performed, and a data type capable of expressing 3D space information not the pointer cloud data type may be applied.

PV encoding/SV encoding/light field/point cloud encoding: each view may previously be packed or depth information and/or location information may be subjected to image encoding or video encoding. The same contents of the same view may be encoded by bitstreams different per region. There may be a media format such as new codec which will be defined in MPEG-I, HEVC-3D and OMAF++.

File encapsulation: The encoded 6DoF video data may be processed in a file format such as ISOBMFF by file-encapsulation which is the encapsulation processor. Alternatively, the encoded 6DoF video data may be processed into segments.

Metadata (including depth information): Like the 6DoF vide data processing, the metadata generated during stitching, projection, view segmentation/packing, encoding, and encapsulation may be delivered to the metadata processor, or the metadata generated by the metadata processor may be delivered to each process. Also, the metadata generated by the transmission side may be generated as one track or file during the encapsulation process and then delivered to the reception side. The reception side may receive the metadata stored in a separate file or in a track within the file through a broadcast network or a broadband.

Delivery: file and/or segments may be included in a separate track for transmission based on a new model having DASH or similar function. At this time, MPEG DASH, MMT and/or new standard may be applied for transmission.

File decapsulation: The reception apparatus may perform processing for 6DoF video/audio data reception.

Audio decoding/audio rendering/loudspeakers/headphones: The 6DoF audio data may be provided to a user through a speaker or headphone after being subjected to audio decoding and rendering.

PV/SV/light field/point cloud decoding: The 6DoF video data may be image or video decoded. As a codec applied to decoding, a codec newly proposed for 6DoF in HEVC-3D, OMAF++ and MPEG may be applied. At this time, a primary view PV and a secondary view SV are segmented from each other and thus video or image may be decoded within each view packing, or may be decoded regardless of view segmentation. Also, after light field and point cloud decoding are performed, feedback of head, location and eye tracking is delivered and then image or video of a peripheral view in which a user is located may be segmented and decoded.

Head/eye/location tracking: a user's head, location, gaze, viewport information, etc. may be acquired and processed as described above.

Point cloud rendering: when captured video/image data are re-projected on a 3D space, a 3D spatial location is configured, and a process of generating a 3D space of a virtual view to which a user can move is performed although the virtual view is failed to be obtained from the received video/image data.

Virtual view synthesis: a process of generating and synthesizing video data of a new view is performed using 6DoF video data already acquired near a user's location/view if there is no 6DoF video data in a space in which the user is located, as described above. In some embodiments, the virtual view generation and/or composition process may be omitted.

Image composition and rendering: as a process of rendering image based on a user's location, video data decoded according to the user's location and eyes may be used or video and image near the user, which are made by the virtual view generation/composition, may be rendered.

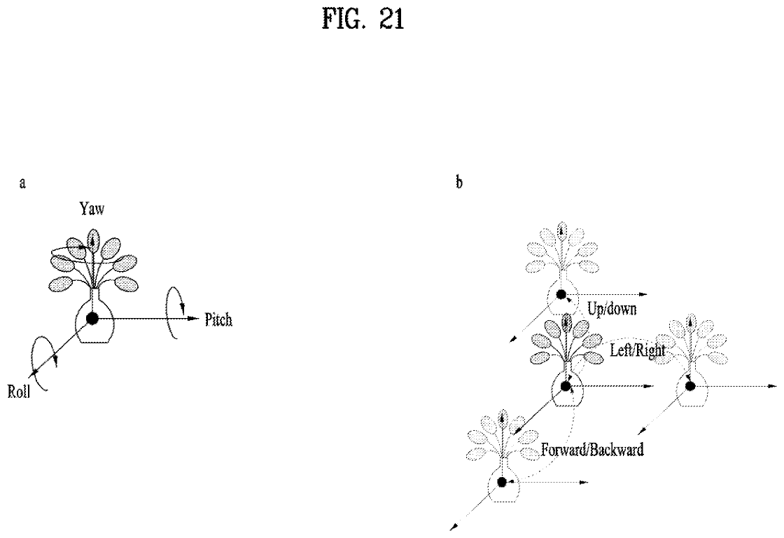

FIG. 21 is a view showing 6DoF space.

In the present invention, a 6DoF space before projection or after re-projection will be described and the concept of FIG. 21 may be used to perform corresponding signaling.

The 6DoF space may categorize an orientation of movement into two types, rational and translation, unlike the case that the 360 degree video or 3DoF space is described by yaw, pitch and roll. Rational movement may be described by yaw, pitch and roll as described in the orientation of the existing 3DoF like ‘a’, and may be called orientation movement. On the other hand, translation movement may be called location movement as described in ‘b’. Movement of a center axis may be described by definition of one axis or more to indicate a moving orientation of the axis among Left/Right orientation, Forward/Backward orientation, and Up/down orientation.

The present invention proposes an architecture for 6DoF video service and streaming, and also proposes basic metadata for file storage and signaling for future use in the invention for 6DoF related metadata and signaling extension.
Metadata generated in each process may be extended based on the proposed 6DoF transceiver architecture.
Metadata generated among the processes of the proposed architecture may be proposed.
6DoF video related parameter of contents for providing 6DoF video services by later addition/correction/extension based on the proposed metadata may be stored in a file such as ISOBMFF and signaled.

6DoF video metadata may be stored and signaled through SEI or VUI of 6DoF video stream by later addition/correction/extension based on the proposed metadata.

Region (meaning in region-wise packing): Region may mean a region where 360 video data projected on 2D image is located in a packed frame through region-wise packing. In this case, the region may refer to a region used in region-wise packing depending on the context. As described above, regions may be identified by equally dividing 2D image, or may be identified by being randomly divided according to a projection scheme.

Region (general meaning): Unlike the region in the aforementioned region-wise packing, the terminology, region may be used as a dictionary definition. In this case, the region may mean ‘area’, ‘zone’, ‘portion’, etc. For example, when the region means a region of a face which will be described later, the expression ‘one region of a corresponding face’ may be used. In this case, the region is different from the region in the aforementioned region-wise packing, and both regions may indicate their respective areas different from each other.

Picture: may mean the entire 2D image in which 360 degree video data are projected. In some embodiments, a projected frame or a packed frame may be the picture.

Sub-picture: A sub-picture may mean a portion of the aforementioned picture. For example, the picture may be segmented into several sub-pictures to perform tiling. At this time, each sub-picture may be a tile. In detail, an operation of reconfiguring tile or MCTS as a picture type compatible with the existing HEVC may be referred to as MCTS extraction. A result of MCTS extraction may be a sub-picture of a picture to which the original tile or MCTS belongs.

Tile: A tile is a sub-concept of a sub-picture, and the sub-picture may be used as a tile for tiling. That is, the sub-picture and the tile in tiling may be the same concept. Specifically, the tile may be a tool enabling parallel decoding or a tool for independent decoding in VR. In VR, a tile may mean a Motion Constrained Tile Set (MCTS) that restricts a range of temporal inter prediction to a current tile internal range. Therefore, the tile herein may be called MCTS.

Spherical region: spherical region or sphere region may mean one region on a spherical surface when 360 degree video data are rendered on a 3D space (for example, spherical surface) at the reception side. In this case, the spherical region is regardless of the region in the region-wise packing. That is, the spherical region does not need to mean the same region defined in the region-wise packing. The spherical region is a terminology used to mean a portion on a rendered spherical surface, and in this case, ‘region’ may mean ‘region’ as a dictionary definition. According to the context, the spherical region may simply be called region.

Face: Face may be a term referring to each face according to a projection scheme. For example, if cube map projection is used, a front face, a rear face, side face, an upper face, or a lower face may be called face.

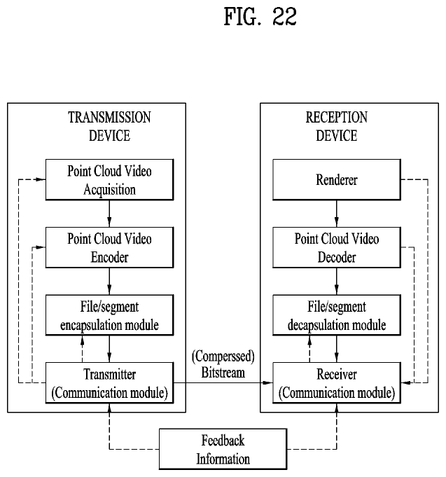

FIG. 22 illustrates generals of point cloud compression processing according to embodiments.

An apparatus for providing point cloud content according to embodiments may be configured as shown in the figure.

The embodiments provide a method for providing point cloud content to provide the user with various services such as virtual reality (VR), augmented reality (AR), mixed reality (MR), and autonomous driving services.

In order to provide a point cloud content service, a point cloud video may be acquired first. The acquired point cloud video may be transmitted through a series of processes, and the reception side may process the rendered data back into the original point cloud video and render the point cloud video. Thereby, the point cloud video may be provided to the user. Embodiments provide a method for effectively performing this series of processes.

The entire processes for providing a point cloud content service may include an acquisition process, an encoding process, a transmission process, a decoding process, a rendering process, and/or a feedback process.

The point cloud compression system may include a transmission apparatus and a reception apparatus. The transmission device may output a bitstream by encoding a point cloud video, and deliver the same to a reception device through a digital storage medium or a network in the form of a file or streaming (streaming segment). The digital storage medium may include various storage media such as USB, SD, CD, DVD, Blu-ray, HDD, and SSD.

The transmission device may include a point cloud video acquirer, a point cloud video encoder, and a transmitter. The reception device may include a receiver, a point cloud video decoder, and a renderer. The encoder may be referred to as a point cloud video/picture/picture/frame encoder, and the decoder may be referred to as a point cloud video/picture/picture/frame decoder. The transmitter may be included in the point cloud video encoder. The receiver may be included in the point cloud video decoder. The renderer may include a display, and the renderer and/or display may be configured as separate devices or external components. The transmission device and the reception device may further include a separate internal or external module/unit/component for the feedback process.

The point cloud video acquirer may perform the operation of acquiring point cloud video through a process of capturing, composing, or generating point cloud video. In the acquisition process, 3D locations (x, y, z)/property data (color, reflectance, transparency, etc.) of multiple points, for example, a Polygon File format or the Stanford Triangle format (PLY) file may be generated. For a video having multiple frames, one or more files may be acquired. During the capture process, point cloud related metadata (e.g., capture related metadata) may be generated.

For point cloud content capture, a combination of camera equipment (a combination of an infrared pattern projector and an infrared camera) capable of acquiring depth and RGB cameras capable of extracting color information corresponding to depth information may be configured in combination. Alternatively, depth information may be extracted through LiDAR, which uses a radar system that measures the location coordinates of a reflector by emitting a laser pulse and measuring the return time. A shape of geometry (information about locations) consisting of points in 3D space may be extracted from the depth information, and an attribute representing the color/reflectance of each point may be extracted from the RGB information. The point cloud content may include information about the locations (x, y, z) and color (YCbCr or RGB) or reflectance (r) of the points. For the point cloud content, an outward-facing method of capturing an external environment and an inward-facing method of capturing a central object may be used. In the VR/AR environment, when an object (e.g., a key object such as a character, a player, an physical object, or an actor) is configured into point cloud content that can be viewed freely by the user at 360 degrees, the configuration of the capture camera may use the inward-facing method. When the current surrounding environment is configured into point cloud content in the mode of a vehicle, such as autonomous driving, the configuration of the capture camera may use the outward-facing method. Because point cloud content can be captured by multiple cameras, a camera calibration process may need to be performed before the content is captured to establish a global coordinate system for the cameras.

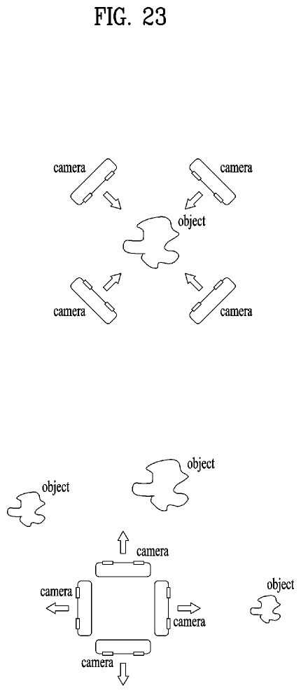

FIG. 23 illustrates arrangement of point cloud capture equipment according to embodiments.

The point cloud according to embodiments may perform the capture operation inward from the outside of the object, based on the inward-facing method.

The point cloud according to embodiments may perform the capture operation outward from the inside of the object, based on the outward-facing method.

The point cloud content may be a video or still image of an object/environment presented in various types of 3D spaces.

Additionally, in the point cloud content acquisition method, any point cloud video may be composed based on the captured point cloud video. Alternatively, when a point cloud video for a computer-generated virtual space is to be provided, capturing through an actual camera may not be performed. In this case, the corresponding capture process may be replaced simply by a process of generating related data.

The captured point cloud video may require post-processing to improve the quality of the content. In the video capture process, the value of the maximum/minimum depth may be adjusted within a range provided by the camera equipment. Even after the adjustment, point data of an unwanted area may be included. Accordingly, post-processing of removing the unwanted area (e.g., the background) or recognizing the connected space and filling the spatial holes may be performed. In addition, a point cloud extracted from the cameras sharing a spatial coordinate system may be integrated into one piece of content through a process of transforming each point to a global coordinate system based on the location coordinates of each camera acquired through a calibration process. Thereby, one wide range of point cloud content may be generated, or point cloud content with a high density of points may be acquired.

The point cloud video encoder may encode input point cloud video into one or more video streams. One video may include a plurality of frames, and one frame may correspond to a still image/picture. In this specification, the point cloud video may include a point cloud video/frame/picture, and the point cloud video may be used interchangeably with the point cloud video/frame/picture. The point cloud video encoder may perform a video-based point cloud compression (V-PCC) procedure. The point cloud video encoder may perform a series of procedures such as prediction, transform, quantization, and entropy coding for compression and coding efficiency. The encoded data (encoded video/image information) may be output in the form of a bitstream. Based on the V-PCC procedure, the point cloud video encoder may encode point cloud video by dividing the same into geometric video, attribute video, occupancy map video, and auxiliary information as described below. The geometry video may include a geometry image, the attribute video may include an attribute image, and the occupancy map video may include an occupancy map image. The auxiliary information may include auxiliary patch information. The attribute video/image may include a texture video/image.

The encapsulation processor (file/segment encapsulation module) may encapsulate the encoded point cloud video data and/or the point cloud video-related metadata in the form of a file. Here, the point cloud video-related metadata may be received from the metadata processor. The metadata processor may be included in the point cloud video encoder or may be configured as a separate component/module. The encapsulation processor may encapsulate the data in a file format such as ISOBMFF or process the same in the form of a DASH segment or the like. According to an embodiment, the encapsulation processor may include the point cloud video-related metadata in the file format. The point cloud video metadata may be included, for example, in boxes at various levels on the ISOBMFF file format or as data in a separate track within the file. According to an embodiment, the encapsulation processor may encapsulate the point cloud video-related metadata into a file. The transmission processor may perform processing for transmission on the encapsulated point cloud video data according to the file format. The transmission processor may be included in the transmitter or may be configured as a separate component/module. The transmission processor may process the point cloud video data according to a transmission protocol. The processing for transmission may include processing for delivery over a broadcast network and processing for delivery through a broadband. According to an embodiment, the transmission processor may receive point cloud video-related metadata from the metadata processor as well as the point cloud video data, and perform processing for transmission on the point cloud video data.

The transmitter may transmit the encoded video/video information or data output in the form of a bitstream to the receiver of the reception device through a digital storage medium or a network in the form of a file or streaming. The digital storage medium may include various storage media such as USB, SD, CD, DVD, Blu-ray, HDD, and SSD. The transmitter may include an element for generating a media file in a predetermined file format, and may include an element for transmission over a broadcast/communication network. The receiver may extract the bitstream and transmit the extracted bitstream to the decoder.

The receiver may receive point cloud video data transmitted by the point cloud video transmission apparatus according to embodiments. Depending on the transmission channel, the receiver may receive the point cloud video data over a broadcasting network or through a broadband. Alternatively, the point cloud video data may be received through a digital storage medium.

The reception processor may perform processing on the received point cloud video data according to the transmission protocol. The reception processor may be included in the receiver or may be configured as a separate component/module. The reception processor may reversely perform the process of the above-described transmission processor so as to correspond to the processing for transmission performed at the transmission side. The reception processor may deliver the acquired point cloud video data to the decapsulation processor, and the acquired point cloud video-related metadata to the metadata parser. The point cloud video-related metadata acquired by the reception processor may take the form of a signaling table.

The decapsulation processor (file/segment decapsulation module) may decapsulate the point cloud video data received in the form of a file from the reception processor. The decapsulation processor may decapsulate files according to ISOBMFF or the like, and may acquire a point cloud video bitstream or point cloud video-related metadata (metadata bitstream). The acquired point cloud video bitstream may be delivered to the point cloud video decoder, and the acquired point cloud video-related metadata (metadata bitstream) may be delivered to the metadata processor. The point cloud video bitstream may include the metadata (metadata bitstream). The metadata processor may be included in the point cloud video decoder or may be configured as a separate component/module. The point cloud video-related metadata acquired by the decapsulation processor may take the form of a box or track in the file format. The decapsulation processor may receive metadata necessary for decapsulation from the metadata processor, when necessary. The point cloud video-related metadata may be delivered to the point cloud video decoder and used in a point cloud video decoding procedure, or may be transferred to the renderer and used in a point cloud video rendering procedure.

The point cloud video decoder may receive the bitstream and decode the video/image by performing an operation corresponding to the operation of the point cloud video encoder. In this case, the point cloud video decoder may decode the point cloud video by dividing the same into a geometry video, an attribute video, an occupancy map video, and auxiliary information as described below. The geometry video may include a geometry image, the attribute video may include an attribute image, and the occupancy map video may include an occupancy map image. The auxiliary information may include auxiliary patch information. The attribute video/image may include a texture video/image.

The 3D geometry may be reconstructed using the decoded geometry image, the occupancy map, and auxiliary patch information, and then may be subjected to a smoothing process. The color point cloud image/picture may be reconstructed by assigning a color value to the smoothed 3D geometry using the texture image. The renderer may render the reconstructed geometry and the color point cloud image/picture. The rendered video/image may be displayed through the display. The user may see all or part of the rendered result through a VR/AR display or a normal display.

The feedback process may include transferring various feedback information that may be acquired in the rendering/displaying process to the transmission side or to the decoder of the reception side. Through the feedback process, interactivity may be provided for consumption of point cloud video. According to an embodiment, head orientation information, viewport information indicating a region currently viewed by a user, and the like may be delivered to the transmission side in the feedback process. According to an embodiment, the user may interact with those implemented in the VR/AR/MR/autonomous driving environment. In this case, information related to the interaction may be delivered to the transmission side or a service provider during the feedback process. According to an embodiment, the feedback process may not be performed.

The head orientation information may refer to information about the location, angle and motion of a user's head. On the basis of this information, information about a region of the point cloud video currently viewed by the user, that is, viewport information may be calculated.

The viewport information may be information about a region of the point cloud video currently viewed by a user. Gaze analysis may be performed using the viewport information to check a manner in which the user consumes the point cloud video, a region of the point cloud video at which the user gazes, and how long the user gazes at the region. Gaze analysis may be performed by the receiving side and the analysis result may be delivered to the transmission side through a feedback channel. A device such as a VR/AR/MR display may extract a viewport region on the basis of the location/direction of a user's head, vertical or horizontal FOV supported by the apparatus.

According to an embodiment, the aforementioned feedback information may be consumed at the receiving side as well as being delivered to the transmission side. That is, decoding and rendering processes of the reception side may be performed using the aforementioned feedback information. For example, only point cloud video for the region currently viewed by the user may be preferentially decoded and rendered using the head orientation information and/or the viewport information.

Here, a viewport or a viewport region may refer to a region of the point cloud video currently viewed by a user. A viewpoint is a point in point cloud video which is viewed by the user and can refer to a center point of a viewport region. That is, a viewport is a region based on a view, and the size and form of the region can be determined by the field of view (FOV).

This document relates to point cloud video compression as described above. For example, the methods/embodiments disclosed in this document may be applied to the Moving Picture Experts Group (MPEG) point cloud compression or point cloud coding (PCC) standard or the next generation video/image coding standard.

As used herein, a picture/frame may generally refer to a unit representing one image in a specific time zone.

A pixel or a pel may refer to the smallest unit constituting one picture (or image). In addition, “sample” may be used as a term corresponding to the pixel. A sample may generally represent a pixel or a pixel value, or may represent only a pixel/pixel value of a luma component, only a pixel/pixel value of a chroma component, or only a pixel/pixel value of a depth component.

A unit may represent a basic unit of image processing. The unit may include at least one of a specific region of the picture and information related to the region. The unit may be used interchangeably with term such as block or area in some cases. In a general case, an M×N block may include samples (or a sample array) or a set (or array) of transform coefficients configured in M columns and N rows.

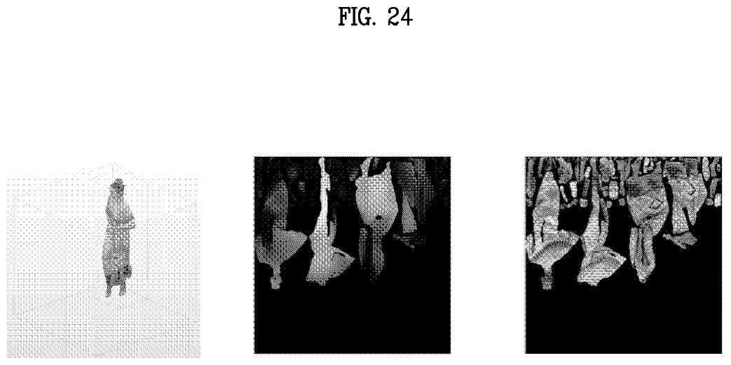

FIG. 24 illustrates an example of a point cloud, a geometry image, and a (non-padded) texture image according to embodiments.

Regarding the encoding process according to embodiments,

Video-based point cloud compression (V-PCC) according to embodiments may provide a method of compressing 3D point cloud data based on a 2D video codec such as HEVC or VVC. The following data and information may be generated in the V-PCC compression process.

Occupancy map according to embodiments: a binary map indicating whether there is data at a corresponding location in a 2D plane using a value of 0 or 1 in dividing the points constituting the point cloud into *patches and mapping the same to the 2D plane

*Patch: A set of points constituting a point cloud according to embodiments. Points belonging to the same patch may be adjacent to each other in 3D space and be mapped in the same direction among 6-face bounding box planes in the process of mapping to a 2D image.

Geometry image according to embodiments: An image in the form of a depth map representing the location information (geometry) about each point constituting a point cloud on a patch-by-patch basis. It may be composed of pixel values of one channel.

Texture image according to embodiments: An image representing the color information about each point constituting a point cloud on a patch-by-patch basis. It may be composed of pixel values of a plurality of channels (e.g., three channels of R, G, and B).

Auxiliary patch info according to embodiments: Metadata required for reconstructing a point cloud from individual patches. It may include information about the location, size, and the like of a patch in 2D/3D space.

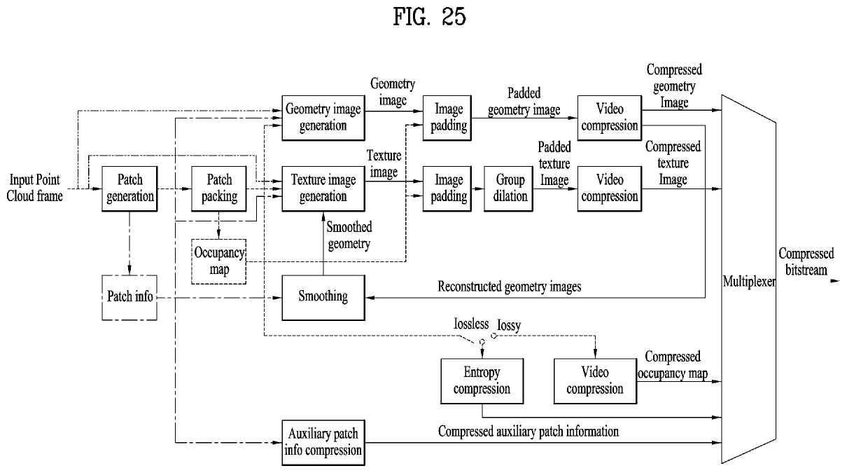

FIG. 25 illustrates a V-PCC encoding process according to embodiments.

The figure illustrates a V-PCC encoding process for generating and compressing an occupancy map, a geometry image, a texture image, and auxiliary patch information. The operation of each process is as follows.

The auxiliary patch information according to embodiments includes information about distribution of patches.

Patch Generation According to Embodiments

The patch generation process refers to a process of dividing a point cloud into patches, which are mapping units, in order to map the point cloud to the 2D image. The patch generation process may be divided into three steps: normal value calculation, segmentation, and patch segmentation.

Patches according to embodiments represent data that maps 3D data to 2D data (e.g., an image).

Normal Value Calculation According to Embodiments

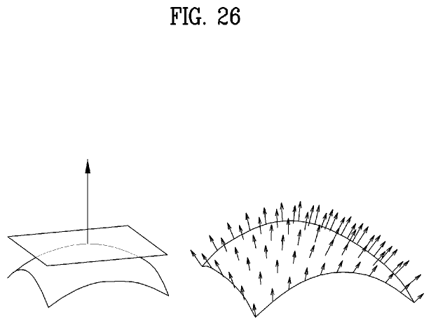

Each point of a point cloud has its own direction, which is represented by a 3D vector called a normal vector. Using the neighbors of each point obtained using a K-D tree or the like, a tangent plane and a normal vector of each point forming the surface of the point cloud as shown in FIG. 26 may be obtained. The search range in the process of finding the neighbors may be defined by the user.

FIG. 26 illustrates a tangent plane and a normal vector of a surface according to embodiments.

Tangent plane according to embodiments: A plane that passes through a point on the surface and completely includes a tangent line to the curve on the surface.

The normal vector according to the embodiments is a normal vector with respect to the tangent plane.

Next, the V-PCC encoding process according to embodiments will be described.

Segmentation:

Segmentation is divided into two processes: initial segmentation and refine segmentation.

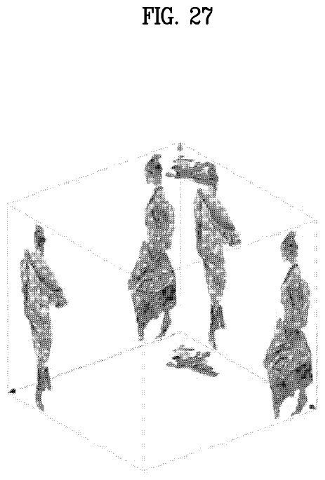

Each point constituting a point cloud is projected onto one of the six faces of the bounding box surrounding the point cloud as shown in FIG. 27, which will be described later. Initial segmentation is a process of determining one of the planes of the bounding box onto which each point is projected.

FIG. 27 illustrates a bounding box of a point cloud according to embodiments.

The bounding box of a point cloud according to the embodiments may take the form of, for example, a cube. \vec{n}ₚ_{_{idx}}, which is a normal value corresponding to each of the six planes according to the embodiments, is defined as follows.

(1.0, 0.0, 0.0),

(0.0, 1.0, 0.0),

(0.0, 0.0, 1.0),

(−1.0, 0.0, 0.0),

(0.0, −1.0, 0.0),

(0.0, 0.0, −1.0).

As shown in the following equation, a face where dot product of the normal value \vec{n}ₚ_{ᵢ} of each point obtained in the process of calculating the normal value and \vec{n}ₚ_{_{idx}} yields the maximum value is determined as a projection plane of the face. That is, a plane whose normal vector is most similar in direction to the normal vector of the point is determined as the projection plane of the point.

$${max}_{{p}_{idx}} \{ {\vec{n}}_{{p}_{i}} \cdot {\vec{n}}_{{p}_{idx}} \}$$

The determined plane may be identified by a cluster, which is one of indexes 0 to 5.

Refine segmentation is a process of improving the projection plane of each point forming the point cloud determined in the initial segmentation process in consideration of the projection planes of neighboring points. In this process, a score normal that represents the degree of similarity between the normal vector of each point and the normal value of each plane of the bounding box, which are considered in determining the projection plane in the initial segmentation process, and score smooth, which indicates the degree of similarity between the projection plane of the current point and the projection planes of neighboring points may be considered together.

Score smooth may be considered by weighting the score normal. In this case, the weight value may be defined by the user. The refine segmentation may be performed repeatedly, and the number of repetitions may also be defined by the user.

Segmenting Patches:

Patch segmentation is a process of dividing the entire point cloud into patches, which are sets of neighboring points, based on the projection plane information about each point forming the point cloud obtained in the initial/refine segmentation process. The patch segmentation may include the following steps:

1) Calculate Neighboring points of each point forming a point cloud are using a K-D tree or the like. The maximum number of neighbors may be defined by the user;

2) When the neighboring points are projected on the same plane as the current point (when they have the same cluster index value), extract the current point and the neighboring points as one patch;

3) Calculate geometry values of the extracted patch. The details are described in Section 1.3; and

4) Repeat steps 2) to 4) until there is no unextracted point.

The size of each patch, and the occupancy map, geometry image and texture image for each patch are determined through the patch segmentation process.

Patch Packing & Occupancy Map Generation:

This is a process of determining the locations of the individual patches in a 2D image to map the segmented patches to a single 2D image. The occupancy map is one of the 2D images, and is a binary map that indicates whether there is data at a corresponding location using a value of 0 or 1. The occupancy map is composed of blocks and the resolution thereof may be determined by the size of the block. For example, when the block size is 1*1 block, a resolution corresponding to the pixel scale is given. The occupancy packing block size may be determined by the user.

The process of determining the locations of individual patches within the occupancy map may be configured as follows.

1) Set all values of the occupancy map to 0.

2) Place the patch at a point (u, v) having a horizontal coordinate within the range of (0, *occupancySizeU−*patch.sizeU0) and a vertical coordinate within the range of (0, *occupancySizeV−*patch.sizeV0) in the occupancy map plane.

3) Set a point (x, y) having a horizontal coordinate within the range of (0, patch.sizeU0) and a vertical coordinate within the range of (0, patch.sizeV0) in the patch plane as the current point.

4) Change the location of point (x, y) in raster order and repeat operations 3) and 4) if the (x, y) coordinate value of the patch occupancy map is 1 (there is data at the point in the patch), and the (u+x, v+y) coordinate of the occupancy map is 1 (the occupancy map is filled by the previous patch). If not, proceed to operation 6.

5) Change the location of (u, v) in raster order and repeat the operations 3) to 5).

6) Determine (u, v) as the location of the patch and copy the occupancy map data of the patch onto the corresponding portion of the entire occupancy map.

7) Repeat operations 2) to 7) for the next patch.

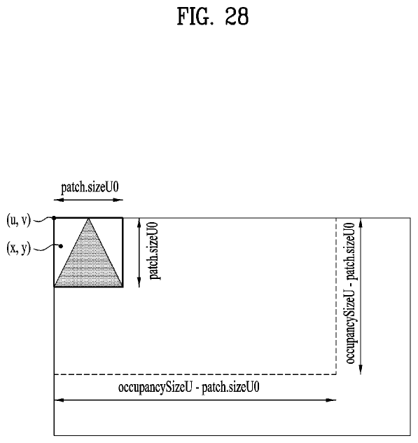

FIG. 28 illustrates a method for determining an individual patch location in an occupancy map according to embodiments.

occupancySizeU according to the embodiments: indicates the width of the occupancy map. The unit is occupancy packing block size.

occupancySizeV according to the embodiments: indicates the height of the occupancy map. The unit is occupancy packing block size.

patch.sizeU0 according to the embodiments: indicates the width of the occupancy map. The unit is occupancy packing block size.

patch.sizeV0 according to the embodiments: indicates the height of the occupancy map. The unit is occupancy packing block size.

Geometry Image Generation According to the Embodiments:

In this process, the depth values constituting the geometry image of each patch are determined, and the entire geometry image is generated based on the locations of the patches determined in the above-described processes. The process of determining the depth values constituting the geometry image of an individual patch may be configured as follows.

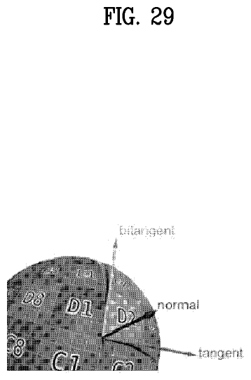

1) Calculate parameters related to the location and size of an individual patch according to the embodiments. The parameters may include the following information.
Index indicating the normal axis according to embodiments: the normal axis is obtained in the previous patch generation process. The tangent axis is an axis coincident with the horizontal axis (u) of the patch image among the axes perpendicular to the normal axis, and the bitangent axis is an axis coincident with the vertical axis (v) of the patch image among the axes perpendicular to the normal axis. The three axes may be expressed as shown in FIG. 29.

FIG. 29 illustrates a relationship between normal, tangent, and bitangent axes according to embodiments.

A surface according to embodiments may include a plurality of regions (e.g., C1, C2, D1, D2, E1, etc.).

The tangent axis of the surface according to the embodiments is an axis coincident with the horizontal axis (u) of the patch image among the axes perpendicular to the normal axis.

The bitangent axis of the surface according to embodiments is an axis coincident with the vertical axis (v) of the patch image among the axes perpendicular to the normal axis.

The normal axis of the surface according to the embodiments represents a normal axis generated in the patch generation.
3D spatial coordinates of a patch according to the embodiments may be calculated by the bounding box of the minimum size surrounding the patch. The 3D spatial coordinates may include the minimum tangent value (a patch 3d shift tangent axis) of the patch, the minimum bitangent value (a patch 3d shift bitangent axis) of the patch, and the minimum normal value (a patch 3d shift normal axis) of the patch.
2D size of the patch according to embodiments indicates the horizontal and vertical sizes of the patch when the patch is packed into a 2D image. The horizontal size (patch 2d size u) may be obtained as the difference between the maximum and minimum tangent values of the bounding box, and the vertical size (patch 2d size v) may be obtained as the difference between the maximum and minimum bitangent values of the bounding box.

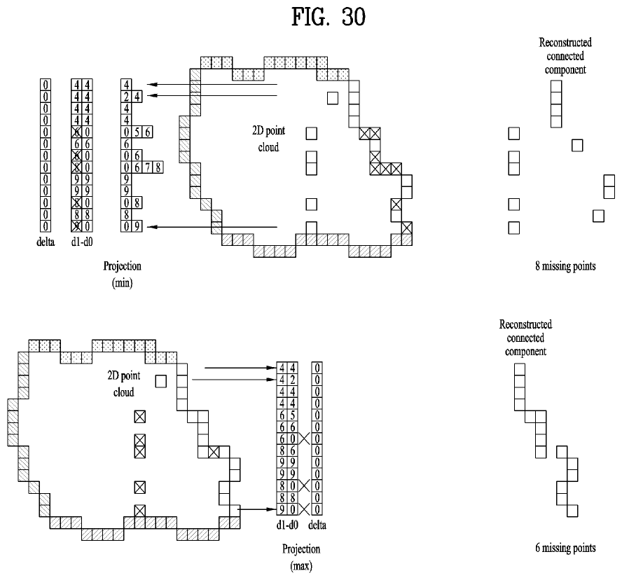

FIG. 30 illustrates configuration of d0 and d1 in a min mode and configuration of d0 and d1 in a max mode according to embodiments.

The projection mode of the patch of a 2D point cloud according to the embodiments includes a minimum mode and a maximum mode.

According to the embodiments, d0 is an image of a first layer, and d1 is an image of a second layer.

Projection of the patch of the 2D point cloud is performed based on the minimum value, and the missing points are determined based on the layers d0 and d1.

Geometry image generation according to the embodiments reconstructs the connected component for the patch, wherein there are missing points.

According to the embodiments, delta may be a difference between d0 and d1. The geometry image generation according to the embodiments may determine the missing points based on the value of delta.

2) Determine the projection mode of the patch. The projection mode may be either the min mode or the max mode. The geometry information about the patch is expressed with a depth value. When each point constituting the patch in the normal direction of the patch is projected, an image configured with the maximum value of depth and an image configured with the minimum value of depth, which form two layers, may be generated.

In generating the two layers of images d0 and d1 according to embodiments, in the min mode, the minimum depth may be configured in d0, and the maximum depth within the surface thickness from the minimum depth may be configured in d1, as shown in FIG. 30. In the max mode, as shown in FIG. 30, the maximum depth may be configured in d0, and the minimum depth within the surface thickness from the maximum depth may be configured in d1.

The projection mode according to the embodiments may be applied to all point clouds in the same manner or differently applied to each frame or patch by user definition. When different projection modes are applied to the respective frames or patches, a projection mode that may increase compression efficiency or minimize missed points may be adaptively selected.

The configuration of the connected component depends on the projection mode according to the embodiments.

3) Calculate the depth values of the individual points. In the Min mode, image d0 is constructed with depth0, which is a value obtained by subtracting the minimum normal value (patch 3d shift normal axis) of the patch calculated in operation 1) from the minimum normal value (patch 3d shift normal axis) of the patch for the minimum normal value of each point. If there is another depth value within the range between depth0 and the surface thickness at the same location, this value is set to depth1. Otherwise, the value of depth0 is assigned to depth1. Image d1 is constructed with the value of depth1.

In the Max mode, image d0 is constructed with depth0, which is a value obtained by subtracting the minimum normal value (patch 3d shift normal axis) of the patch calculated in operation 1) from the minimum normal value (patch 3d shift normal axis) of the patch for the maximum normal value of each point. If there is another depth value within the range between depth0 and the surface thickness at the same location, this value is set to depth1. Otherwise, the value of depth0 is assigned to depth1. Image d1 is constructed with the value of depth1.

The entire geometry image may be generated by placing the geometry images of the individual patches generated through the above-described process into the entire geometry image using the patch location information determined in the 1.2 patch packing process.

The d1 layer of the generated entire geometry image may be encoded using various methods. A first method is to encode the depth values of the previously generated image d1 (Absolute d1 method). A second method is to encode a difference between the depth value of previously generated image d1 and the depth value of image d0 (Differential method).

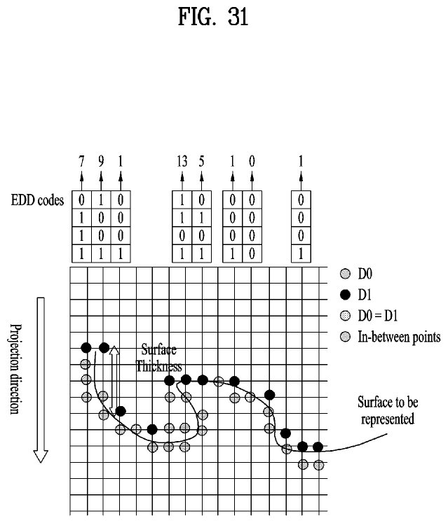

FIG. 31 illustrates an example of an EDD code according to embodiments.

In the encoding method using the depth values of the two layers, d0 and d1 according to the embodiments described above, if there is another point between the two depths, the geometry information about the point is lost in the encoding process, and therefore Enhanced-Delta-Depth (EDD) code may be used for lossless coding. As shown in FIG. 31, the EDD code represents binary encoding of the locations of all the points within the range of surface thickness including d1. For example, the points included in the second column from the left in FIG. 31 may be represented as the EDD of 0b1001 (=9) because the points are present at the first and fourth locations above D0 and the second and third locations are empty. When the EDD code is encoded together with D0 and transmitted, the reception terminal may restore the geometry information about all the points without loss.

Smoothing According to Embodiments:

Smoothing is a process for eliminating discontinuity that may occur on the patch boundary due to deterioration of the image quality that occurs during the compression process. Smoothing may be performed in the following procedure.

1) Reconstruct the point cloud from the geometry image. This operation is the reverse of the geometry image generation described above.

2) Calculate the neighboring points of each point constituting the reconstructed point cloud using a K-D tree or the like.

3) Determine whether each of the points is located on the patch boundary. For example, when there is a neighboring point having a different projection plane (cluster index) from the current point, it may be determined that the point is located on the patch boundary.

4) If there is a point present on the patch boundary, move the point to the center of gravity of the neighboring points (located at the average x, y, z coordinates of the neighboring points). That is, change the geometry value. If not, maintain the previous geometry value.

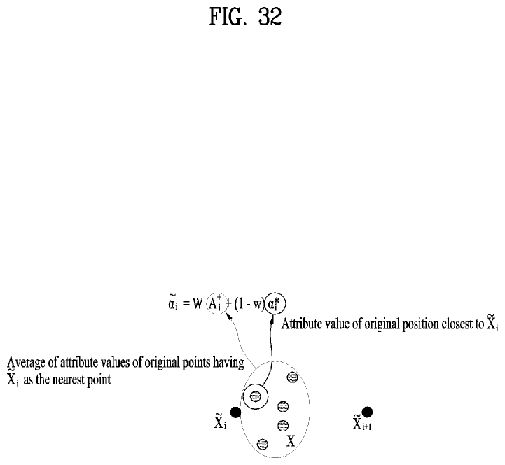

FIG. 32 illustrates recoloring using color values of neighboring points according to embodiments.

Texture Image Generation According to Embodiments:

The texture image generation process according to the embodiments, which is similar to the geometry image generation process described above, includes generating texture images of individual patches and generating the entire texture image by arranging the texture images at determined locations. However, in the operation of generating the texture image of each patch, an image with color values (e.g., R, G, B) of points constituting a point cloud corresponding to a location is generated instead of the depth value for geometry generation.

In the operation of obtaining a color value of each point constituting the point cloud according to the embodiments, the geometry previously obtained through the smoothing process may be used. In the smoothed point cloud, the locations of some points from the original point cloud may have been shifted, and accordingly a recoloring process of finding colors suitable for the changed locations may be required. Recoloring may be performed using the color values of neighboring points. According to embodiments, as shown in FIG. 32, the new color value may be calculated in consideration of the color value of the nearest neighboring point and the color values of the neighboring point.

Texture images according to embodiments may also be generated in two layers of t0 and t1, like the geometry images generated in two layers of d0 and d1.

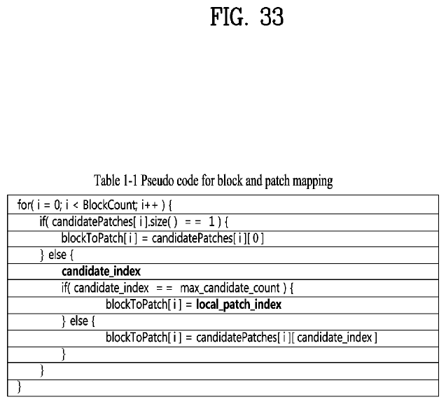

FIG. 33 shows pseudo code for block and patch mapping according to embodiments.

Auxiliary Patch Info Compression According to Embodiments:

In the process according to the embodiments, the auxiliary patch information generated in the aforementioned patch generation, patch packing, and geometry generation processes is compressed. The auxiliary patch information may include the following parameters:
Index (cluster index) for identifying the projection plane (normal plane);
3D spatial location of a patch: the minimum tangent value of the patch (patch 3d shift tangent axis), the minimum bitangent value of the patch (patch 3d shift bitangent axis), and the minimum normal value of the patch (patch 3d shift normal axis);
2D spatial location and size of the patch: horizontal size (patch 2d size u), vertical size (patch 2d size v), minimum horizontal value (patch 2d shift u), minimum vertical value (patch 2d shift u)
Mapping information about each block and patch: a candidate index (when patches are disposed in order based on the 2D spatial location and size information about the patches, multiple patches may be mapped to one block in an overlapping manner. In this case, the mapped patches constitute a candidate list, and the candidate index indicates the sequential location of a patch whose data is present in the block), and a local patch index (which is an index indicating one of the entire patches present in the frame). The figure shows a pseudo code for matching between blocks and patches using a candidate list and a local patch index.

The maximum number of candidate lists according to embodiments may be defined by a user.

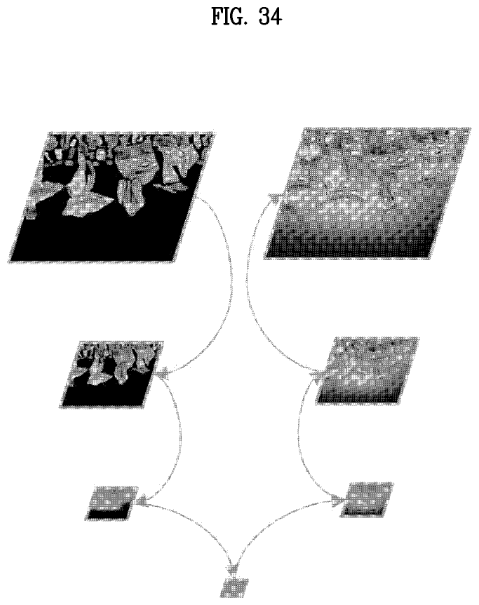

FIG. 34 illustrates push-pull background filling according to embodiments.

Image Padding and Group Dilation According to Embodiments

Image padding is a process of filling the space other than the patch region with meaningless data to improve compression efficiency. For image padding, pixel values in columns or rows corresponding to the boundary side inside the patch may be copied to fill an empty space. Alternatively, as shown in the figure, a push-pull background filling method may be used, by which an empty space is filled with pixel values from a low resolution image in the process of gradually reducing the resolution of a non-padded image and increasing the resolution again.

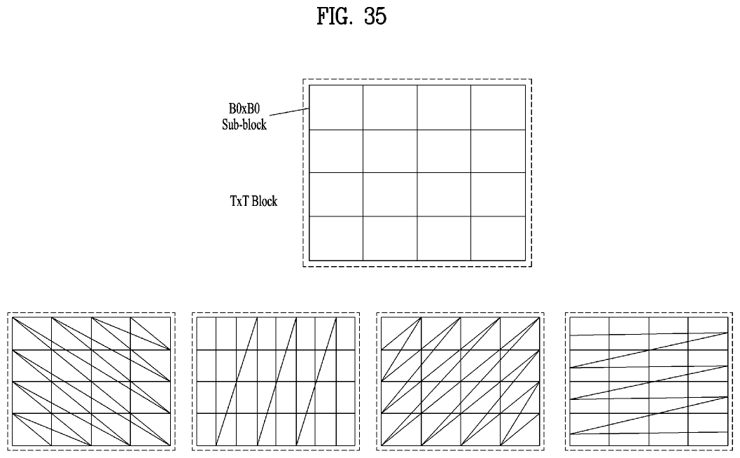

FIG. 35 illustrates an example of possible traversal orders for a 4*4 block according to embodiments.

Group dilation according to the embodiments is a method of filling the empty space of a geometry image and a texture image composed of two layers, d0/d1 and t0/t1. This is a process of filling the empty spaces of the two layers calculated through image padding with the average of the values for the same location.

Occupancy Map Compression According to Embodiments:

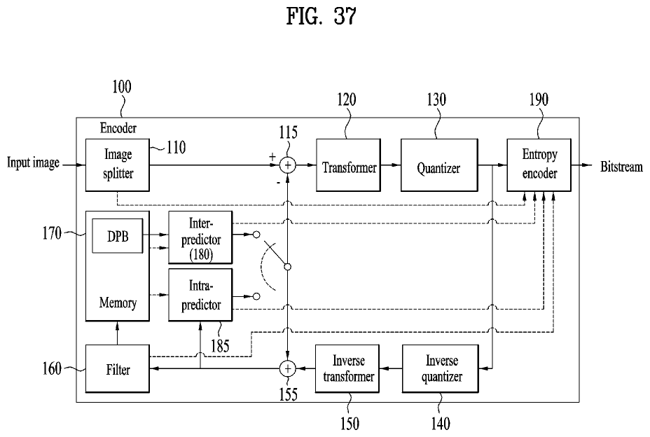

Occupancy map compression is an operation of compressing the occupancy map generated in the above-described embodiments, and there may be two methods, video compression for lossy compression and entropy compression for lossless compression. Video compression will be described with reference to FIG. 37.

The entropy compression according to the embodiments may be performed in the following procedure.

1) For each block constituting an occupancy map, if all the blocks are filled, encode 1 and repeat the same operation for the next block. Otherwise, encode 0 and perform operations 2) to 5).

2) Determine the best traversal order to perform run-length coding on the filled pixels of the block. FIG. 35 shows four possible traversal orders for a 4*4 block.

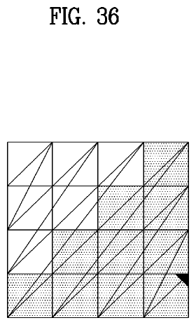

FIG. 36 illustrates an example of selection of the best traversal order according to embodiments.

The best traversal order with the minimum number of runs is selected from among the possible traversal orders and the index thereof is encoded. The figure according to the embodiments illustrates a case where the third traversal order is selected in the previous figure. In this case, the number of runs may be minimized to 2, and therefore the third traversal order may be selected as the best traversal order.

3) Encode the number of runs. In the example of the figure, since there are two runs, 2 is encoded.

4) Encode the occupancy of the first run. In the example of the figure, 0 is encoded because the first run corresponds to unfilled pixels.

5) Encode lengths of the individual runs (as many as the number of runs). In the example of the figure, the lengths of the first run and the second run, 6 and 10, are sequentially encoded.

FIG. 37 illustrates a 2D video/image encoder according to embodiments.

Video Compression According to Embodiments:

This is an operation of encoding a sequence of a geometry image, a texture image, an occupancy map image, and the like generated in the above-described operations using a 2D video codec such as HEVC or VVC according to embodiments.

The figure, which represents an embodiment to which video compression is applied, is a schematic block diagram of a 2D video/image encoder 100 by which encoding of a video/image signal is performed. The 2D video/image encoder 100 may be included in the point cloud video encoder described above or may be configured as an internal/external component. Here, the input image may include the geometry image, texture image (attribute(s) image), and occupancy map image described above. The output bitstream (i.e., the point cloud video/image bitstream) of the point cloud video encoder may include output bitstreams for the respective input images (the geometry image, texture image (attribute(s) image), occupancy map image, etc.).

Referring to the figures according to the embodiments, the encoder 100 may include an image splitter 110, a subtractor 115, a transformer 120, a quantizer 130, an inverse quantizer 140, an inverse transformer 150, an adder 155, a filter 160, a memory 170, an inter-predictor 180, an intra-predictor 185, and an entropy encoder 190. The inter-predictor 180 and the intra-predictor 185 may be collectively called a predictor. That is, the predictor may include the inter-predictor 180 and the intra-predictor 185. The transformer 120, the quantizer 130, the inverse quantizer 140, and the inverse transformer 150 may be included in the residual processor. The residual processor may further include the subtractor 115. The image splitter 110, the subtractor 115, the transformer 120, the quantizer 130, the inverse quantizer 140, the inverse transformer 150, the adder 155, and the filter 160, the inter-predictor 180, the intra-predictor 185, and the entropy encoder 190 described above may be configured by one hardware component (e.g., an encoder or a processor) according to an embodiment. In addition, the memory 170 may include a decoded picture buffer (DPB) or may be configured by a digital storage medium.

The image splitter 110 according to the embodiments may spit an input image (or a picture or a frame) input to the encoder 100 into one or more processing units. For example, the processing unit may be called a coding unit (CU). In this case, the CU may be recursively split from a coding tree unit (CTU) or a largest coding unit (LCU) according to a quad-tree binary-tree (QTBT) structure. For example, one CU may be split into a plurality of CUs of a deeper depth based on a quad-tree structure and/or a binary-tree structure. In this case, for example, the quad-tree structure may be applied first and the binary-tree structure may be applied later. Alternatively, the binary-tree structure may be applied first. The coding procedure according to the embodiments may be performed based on a final CU that is not split anymore. In this case, the LCU may be used as the final CU based on coding efficiency according to characteristics of the image. If necessary, the CU may be recursively split into CUs of a deeper depth, and a CU of the optimum size may be used as the final CU. Here, the coding procedure may include prediction, transformation, and reconstruction, which will be described later. As another example, the processing unit may further include a prediction unit (PU) or a transform unit (TU). In this case, the PU and the TU may be split or partitioned from the aforementioned final CU. The PU may be a unit of sample prediction, and the TU may be a unit for deriving a transform coefficient and/or a unit for deriving a residual signal from the transform coefficient.

The units according to the embodiments may be used interchangeably with terms such as block or area. In a general case, an M×N block may represent a set of samples or transform coefficients configured in M columns and N rows. A sample may generally represent a pixel or a value of a pixel, and may indicate only a pixel/pixel value of a luma component, or only a pixel/pixel value of a chroma component. “Sample” may be used as a term corresponding to a pixel or a pel in one picture (or image).

The encoder 100 according to the embodiments may generate a residual signal (residual block or residual sample array) by subtracting a prediction signal (predicted block or prediction sample array) output from the inter-predictor 180 or the intra-predictor 185 from an input image signal (original block or original sample array), and the generated residual signal is transmitted to the transformer 120. In this case, as shown in the figure, the unit that subtracts the prediction signal (prediction block, prediction sample array) from the input image signal (original block, original sample array) in the encoder 100 may be called a subtractor 115. The predictor may perform prediction on a processing target block (hereinafter, referred to as a current block) and generate a predicted block including prediction samples for the current block. The predictor may determine whether intra-prediction or inter-prediction is applied on a current block or CU basis. As described later in the description of each prediction mode, the predictor may generate various kinds of information about prediction, such as prediction mode information, and deliver the generated information to the entropy encoder 190. The information about the prediction may be encoded by the entropy encoder 190 and output in the form of a bitstream.

The intra-predictor 185 according to the embodiments may predict the current block with reference to the samples in the current picture. The referenced samples may be positioned in the neighborhood of or away from the current block depending on the prediction mode. In intra-prediction, the prediction modes may include a plurality of non-directional modes and a plurality of directional modes. The non-directional modes may include, for example, a DC mode and a planar mode. The directional modes may include, for example, 33 directional prediction modes or 65 directional prediction modes according to fineness of the prediction directions. However, this is merely an example, more or fewer directional prediction modes may be used depending on the configuration. The intra-predictor 185 may determine a prediction mode to be applied to the current block, using the prediction mode applied to the neighboring block.

The inter-predictor 180 according to the embodiments may derive the predicted block for the current block based on a reference block (reference sample array) specified by a motion vector on the reference picture. In this case, in order to reduce the amount of motion information transmitted in the inter-prediction mode, the motion information may be predicted per block, subblock, or sample based on the correlation in motion information between the neighboring blocks and the current block. The motion information may include a motion vector and a reference picture index. The motion information may further include information about an inter-prediction direction (L0 prediction, L1 prediction, Bi prediction, etc.). In the case of inter-prediction, the neighboring blocks may include a spatial neighboring block, which is present in the current picture, and a temporal neighboring block, which is present in the reference picture. The reference picture including the reference block may be the same as or different from the reference picture including the temporal neighboring block. The temporal neighboring block may be referred to as a collocated reference block or a collocated CU (colCU), and the reference picture including the temporal neighboring block may be referred to as a collocated picture (colPic). For example, the inter-predictor 180 may configure a motion information candidate list based on neighboring blocks and generate information indicating a candidate that is used to derive a motion vector and/or a reference picture index of the current block. Inter-prediction may be performed based on various prediction modes. For example, in a skip mode and a merge mode, the inter-predictor 180 may use motion information about a neighboring block as motion information about a current block. In the skip mode, unlike the merge mode, the residual signal may not be transmitted. In the motion vector prediction (MVP) mode, the motion vector of the neighboring block may be used as a motion vector predictor and the motion vector difference may be signaled to indicate the motion vector of the current block.

The prediction signal generated by the inter-predictor 180 or the intra-predictor 185 according to the embodiments may be used to generate a reconstruction signal or to generate a residual signal.

The transformer 120 according to the embodiments may generate transform coefficients by applying a transformation technique to the residual signal. For example, the transformation technique may include at least one of discrete cosine transform (DCT), discrete sine transform (DST), Karhunen-Loeve transform (KLT), graph-based transform (GBT), or conditionally non-linear transform (CNT). Here, the GBT refers to transformation obtained from a graph when the information about the relationship between pixels is represented by the graph. The CNT refers to transformation acquired based on a prediction signal generated using all previously reconstructed pixels. In addition, the transformation operation may be applied to pixel blocks having the same size of a square, or may be applied to blocks of a variable size rather than a square.

The quantizer 130 according to the embodiments may quantize the transform coefficients and transmit the same to the entropy encoder 190. The entropy encoder 190 may encode a quantized signal (information about the quantized transform coefficients) and output the same as a bitstream. The information about the quantized transform coefficients may be referred to as residual information. The quantizer 130 may rearrange the quantized transform coefficients, which are in a block form, into the form of a one-dimensional vector based on a coefficient scan order, and generate information about the quantized transform coefficients based on the quantized transform coefficients in the form of a one-dimensional vector. The entropy encoder 190 may employ various encoding methods such as, for example, exponential Golomb, context-adaptive variable length coding (CAVLC), and context-adaptive binary arithmetic coding (CABAC). The entropy encoder 190 may encode information necessary for video/image reconstruction (e.g., values of syntax elements) together with or separately from other the quantized transform coefficients. The encoded information (e.g., encoded video/image information) may be transmitted or stored in the form of a bitstream on a network abstraction layer (NAL) unit basis. The bitstream may be transmitted over a network or may be stored in a digital storage medium. Here, the network may include a broadcast network and/or a communication network, and the digital storage medium may include various storage media such as USB, SD, CD, DVD, Blu-ray, HDD, and SSD. A transmitter (not shown) to transmit the signal output from the entropy encoder 190 and/or a storage (not shown) to store the signal may be configured as internal/external elements of the encoder 100, or the transmitter may be included in the entropy encoder 190.

The quantized transform coefficients output from the quantizer 130 according to the embodiments may be used to generate a prediction signal. For example, the inverse quantization and inverse transform may be applied to the quantized transform coefficients through the inverse quantizer 140 and the inverse transformer 150 to reconstruct the residual signal (residual block or residual samples). The adder 155 may add the reconstructed residual signal to the prediction signal output from the inter-predictor 180 or the intra-predictor 185. Thereby, a reconstructed signal (reconstructed picture, reconstructed block, reconstructed sample array) may be generated. When there is no residual signal for a processing target block as in the case where the skip mode is applied, the predicted block may be used as the reconstructed block. The adder 155 may be called a reconstructor or a reconstructed block generator. The generated reconstructed signal may be used for intra-prediction of a next processing target block in the current picture, or may be used for inter-prediction of a next picture through filtering as described below.

The filter 160 according to the embodiments may improve subjective/objective image quality by applying filtering to the reconstructed signal. For example, the filter 160 may generate a modified reconstructed picture by applying various filtering methods to the reconstructed picture, and the modified reconstructed picture may be stored in the memory 170, specifically, the DPB of the memory 170. The various filtering methods may include, for example, deblocking filtering, a sample adaptive offset, an adaptive loop filter, and a bilateral filter. As described below in the description of each filtering method, the filter 160 may generate various kinds of information about the filtering and deliver the generated information to the entropy encoder 190. The information about the filtering may be encoded by the entropy encoder 190 and output in the form of a bitstream.

The modified reconstructed picture transmitted to the memory 170 according to embodiments may be used as a reference picture in the inter-predictor 180. Thereby, when inter-prediction is applied, the encoder may avoid prediction mismatch between the encoder 100 and the decoder and improve encoding efficiency.

The DPB of the memory 170 according to embodiments may store the modified reconstructed picture for use as a reference picture in the inter-predictor 180. The memory 170 may store the motion information about a block from which the motion information in the current picture is derived (or encoded) and/or the motion information about the blocks in the picture that have already been reconstructed. The stored motion information may be delivered to the inter-predictor 180 so as to be used as the motion information about a spatial neighboring block or the motion information about a temporal neighboring block. The memory 170 may store the reconstructed samples of the reconstructed blocks in the current picture, and deliver the reconstructed samples to the intra-predictor 185.

At least one of the prediction, transform, and quantization procedures described above may be omitted. For example, for a block to which the pulse coding mode (PCM) is applied, the prediction, transform, and quantization procedures may be omitted, and the value of the original sample may be encoded and output in the form of a bitstream.

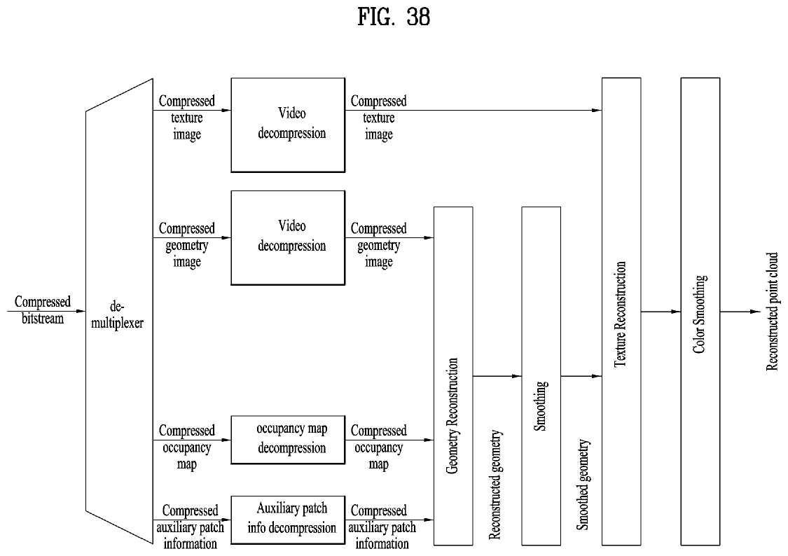

FIG. 38 illustrates a V-PCC decoding process according to embodiments.

The figure according to the embodiments illustrates a decoding process of the V-PCC for reconstructing a point cloud by decoding the compressed occupancy map, geometry image, texture image, and auxiliary path information. Each process is operated as follows.

Video decompression according to embodiments:

Video decompression is a reverse process of video compression described above. In the video decompression, a 2D video codec such as HEVC or VVC is used to decode a compressed bitstream including the geometry image, texture image, and occupancy map image generated in the above-described process.

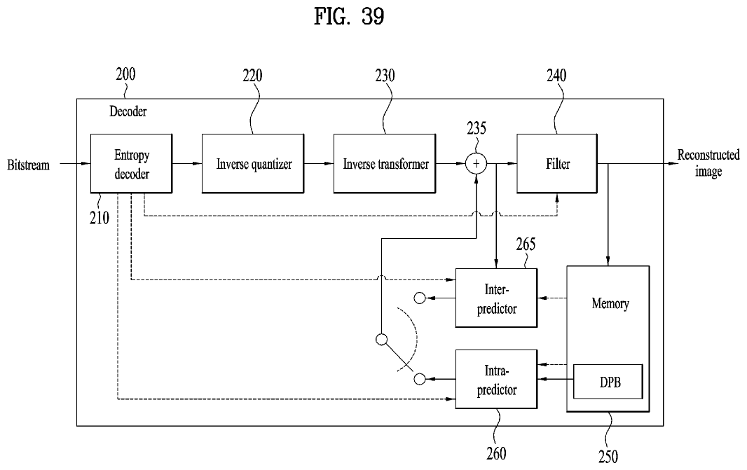

FIG. 39 illustrates a 2D video/image decoder according to embodiments.

The figure, which represents an embodiment to which video decompression is applied, is a schematic block diagram of a 2D video/image decoder 200 by which decoding of a video/image signal is performed. The 2D video/image decoder 200 may be included in the point cloud video decoder described above, or may be configured as an internal/external component. Here, the input bitstream may include bitstreams for the geometry image, texture image (attribute(s) image), and occupancy map image described above. The reconstructed image (or the output image or decoded image) may represent reconstructed images for the geometry image, texture image (attribute(s) image), and occupancy map image described above.

Referring to the figures, the decoder 200 may include an entropy decoder 210, an inverse quantizer 220, an inverse transformer 230, an adder 235, a filter 240, a memory 250, an inter-predictor 260, and an intra-predictor 265. The inter-predictor 260 and the intra-predictor 265 may be collectively called a predictor. That is, the predictor may include the inter-predictor 260 and the intra-predictor 265. The inverse quantizer 220 and the inverse transformer 230 may be collectively called a residual processor. That is, the residual processor may include the inverse quantizer 220 and the inverse transformer 230. The entropy decoder 210, the inverse quantizer 220, the inverse transformer 230, the adder 235, the filter 240, the inter-predictor 260, and the intra-predictor 265 described above may be configured by one hardware component (e.g., a decoder or a processor) according to an embodiment. In addition, the memory 250 may include a decoded picture buffer (DPB) or may be configured by a digital storage medium.

When a bitstream including video/image information according to the embodiments is input, the decoder 200 may reconstruct an image in a process corresponding to the process in which the video/image information has been processed by the encoder of FIG. 38. For example, the decoder 200 may perform decoding using a processing unit applied in the encoder. Thus, the processing unit of decoding may be, for example, a CU. The CU may be split from a CTU or an LCU along a quad-tree structure and/or a binary-tree structure. Then, the reconstructed video signal decoded and output through the decoder 200 may be reproduced through a player.

The decoder 200 according to the embodiments may receive a signal output from the encoder of the figure in the form of a bitstream, and the received signal may be decoded through the entropy decoder 210. For example, the entropy decoder 210 may parse the bitstream to derive information (e.g., video/image information) necessary for image reconstruction (or picture reconstruction). For example, the entropy decoder 210 may decode the information in the bitstream based on a coding method such as exponential Golomb coding, CAVLC, or CABAC, and output values of syntax elements required for image reconstruction, and quantized values of transform coefficients for residuals. More specifically, in the CABAC entropy decoding method, a bin corresponding to each syntax element may be received from the bitstream, and a context model may be determined using decoding target syntax element information and decoding information about neighboring and decoding target blocks or information about a symbol/bin decoded in a previous step. Then, the probability of occurrence of a bin may be predicted according to the determined context model, and arithmetic decoding of the bin may be performed to generate a symbol corresponding to the value of each syntax element. In this case, the CABAC entropy decoding method may update the context model using the information about a symbol/bin decoded for the context model of the next symbol/bin after determining the context model. The information related to the prediction of the information decoded by the entropy decoder 210 is provided to the predictor (the inter-predictor 260 and the intra-predictor 265), and the residual values on which entropy decoding has been performed by the entropy decoder 210, that is, the quantized transform coefficients and related parameter information, may be input to the inverse quantizer 220. In addition, information about filtering of the information decoded by the entropy decoder 210 may be provided to the filter 240. A receiver (not shown) to receive a signal output from the encoder may be further configured as an internal/external element of the decoder 200. Alternatively, the receiver may be a component of the entropy decoder 210.

The inverse quantizer 220 according to the embodiments may output transform coefficients by inversely quantizing the quantized transform coefficients. The inverse quantizer 220 may rearrange the quantized transform coefficients in the form of a two-dimensional block. In this case, the rearrangement may be performed based on the coefficient scan order implemented by the encoder. The inverse quantizer 220 may perform inverse quantization on the quantized transform coefficients using a quantization parameter (e.g., quantization step size information), and acquire transform coefficients.

The inverse transformer 230 according to the embodiments acquires a residual signal (residual block, residual sample array) by inversely transforming the transform coefficients.

The predictor according to embodiments may perform prediction on the current block and generate a predicted block including prediction samples for the current block. The predictor may determine whether intra-prediction or inter-prediction is applied to the current block based on the information about the prediction output from the entropy decoder 210, and may determine a specific intra-/inter-prediction mode.

The intra-predictor 265 according to the embodiments may predict the current block with reference to the samples in the current picture. The referenced samples may be positioned in the neighborhood of or away from the current block depending on the prediction mode. In intra-prediction, the prediction modes may include a plurality of non-directional modes and a plurality of directional modes. The intra-predictor 265 may determine a prediction mode to be applied to the current block, using the prediction mode applied to the neighboring block.

The inter-predictor 260 according to the embodiments may derive the predicted block for the current block based on a reference block (reference sample array) specified by a motion vector on the reference picture. In this case, in order to reduce the amount of motion information transmitted in the inter-prediction mode, the motion information may be predicted per block, subblock, or sample based on the correlation in motion information between the neighboring blocks and the current block. The motion information may include a motion vector and a reference picture index. The motion information may further include information about an inter-prediction direction (L0 prediction, L1 prediction, Bi prediction, etc.). In the case of inter-prediction, the neighboring blocks may include a spatial neighboring block, which is present in the current picture, and a temporal neighboring block, which is present in the reference picture. For example, the inter-predictor 260 may configure a motion information candidate list based on neighboring blocks and derive a motion vector and/or a reference picture index of the current block based on the received candidate selection information. Inter-prediction may be performed based on various prediction modes, and the information about the prediction may include information indicating an inter-prediction mode for the current block.

The adder 235 according to the embodiments may add the acquired residual signal to the prediction signal (predicted block or prediction sample array) output from the inter-predictor 260 or the intra-predictor 265, thereby generating a reconstructed signal (a reconstructed picture, a reconstructed block, or a reconstructed sample array). When there is no residual signal for a processing target block as in the case where the skip mode is applied, the predicted block may be used as the reconstructed block.

The adder 235 according to the embodiments may be called a reconstructor or a reconstructed block generator. The generated reconstructed signal may be used for intra-prediction of a next processing target block in the current picture, or may be used for inter-prediction of a next picture through filtering as described below.

The filter 240 according to the embodiments may improve subjective/objective image quality by applying filtering to the reconstructed signal. For example, the filter 240 may generate a modified reconstructed picture by applying various filtering methods to the reconstructed picture, and the modified reconstructed picture may be transmitted to the memory 250, specifically, the DPB of the memory 250. The various filtering methods may include, for example, deblocking filtering, a sample adaptive offset, an adaptive loop filter, and a bilateral filter.

The reconstructed picture stored in the DPB of the memory 250 according to embodiments may be used as a reference picture in the inter-predictor 260. The memory 250 may store the motion information about a block from which the motion information in the current picture is derived (or decoded) and/or the motion information about the blocks in the picture that have already been reconstructed. The stored motion information may be delivered to the inter-predictor 260 so as to be used as the motion information about a spatial neighboring block or the motion information about a temporal neighboring block. The memory 250 may store the reconstructed samples of the reconstructed blocks in the current picture, and deliver the reconstructed samples to the intra-predictor 265.

According to embodiments, the embodiments described regarding the filter 160, the inter-predictor 180, and the intra-predictor 185 of the encoder 100 may be applied to the filter 240, the inter-predictor 260 and the intra-predictor 265 of the decoder 200, respectively, in the same or corresponding manner.

At least one of the prediction, transform, and quantization procedures described above may be omitted. For example, for a block to which the pulse coding mode (PCM) is applied, the prediction, transform, and quantization procedures may be omitted, and the value of a decoded sample may be used as a sample of a reconstructed image.

Occupancy map decompression according to embodiments:

This is a reverse process of the occupancy map compression described above. Occupancy map decompression is a process for reconstructing the occupancy map by decompressing the occupancy map bitstream.

Auxiliary patch info decompression according to embodiments:

This is a reverse process of the auxiliary patch info compression described above. Auxiliary patch info decompression is a process for reconstructing the auxiliary patch info by decoding the compressed auxiliary patch info bitstream.

Geometry Reconstruction According to Embodiments:

This is a reverse process of the geometry image generation described above. First, a patch is extracted from the geometry image using the 2D location/size information about the patch included in the reconstructed occupancy map and auxiliary patch info, and the mapping information about a block and the patch. Then, a point cloud is reconstructed in the 3D space using the geometry image of the extracted patch and 3D location information about the patch included in the auxiliary patch info. When the geometry value corresponding to any point (u, v) within a patch is g(u, v), and the coordinates of the location of the patch on the normal, tangent and bitangent axes of the 3D space are (0, s0, r0), □(u, v), s(u, v), and r(u, v), which are coordinates of a location on the normal, tangent, and bitangent axes of the 3D space mapped to point (u, v) may be expressed as follows:

δ(u,v)=δ0+g(u,v)

s(u,v)=s0+u

r(u,v)=r0+v

Smoothing According to Embodiments

Smoothing, which is the same as smoothing in the encoding process described above, is a process for eliminating discontinuity that may occur on the patch boundary due to deterioration of the image quality that occurs during the compression process.

Texture Reconstruction According to Embodiments

Texture reconstruction is a process of reconstructing a color point cloud by assigning color values to each point constituting a smoothed point cloud. It may be performed by assigning color values corresponding to the texture image pixels at the same location as in the geometry image in 2D space to points of a point cloud corresponding to the same location in 3D space, using the mapping information about the geometry image and the point cloud in the geometry reconstruction process described above.

Color Smoothing According to Embodiments

Color smoothing is similar to the process of geometry smoothing described above. It is a process for eliminating discontinuity that may occur on the patch boundary due to deterioration of the image quality that occurs during the compression process. Color smoothing may be performed in the following procedure.

1) Calculate the neighboring points of each point constituting the reconstructed point cloud using a K-D tree or the like. The neighboring point information calculated in the geometry smoothing process described above may be used.

2) Determine whether each of the points is located on the patch boundary. The boundary information calculated in the geometry smoothing process described above may be used.

3) Check the distribution of color values for the neighboring points of the points which are on the boundary and determine whether smoothing is to be performed. For example, when the entropy of luminance values is less than or equal to a threshold local entry (when there are many similar luminance values), smoothing may be performed, determining that the corresponding portion is a non-edge portion. As a method of smoothing, the color value of a corresponding point may be replaced with an average value of the neighboring points.

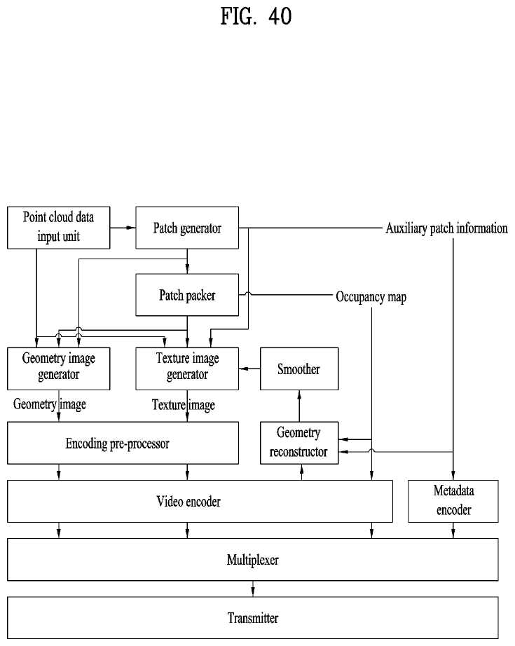

FIG. 40 is a flowchart illustrating a transmission side operation according to embodiments.

An operation process on the transmission side for compression and transmission of point cloud data using V-PCC according to the embodiments may be performed as illustrated in the figure.

First, a patch for 2D image mapping of a point cloud is generated. Auxiliary patch information is generated as a result of the patch generation. The generated information may be used in the processes of geometry image generation, texture image generation, and geometry reconstruction for smoothing. A patch packing process of mapping the generated patches into the 2D image is performed. As a result of patch packing, an occupancy map may be generated. The occupancy map may be used in the processes of geometry image generation, texture image generation, and geometry reconstruction for smoothing. Thereafter, a geometry image is generated using the auxiliary patch information and the occupancy map. The generated geometry image is encoded into one bitstream through video encoding. The encoding preprocessing may include an image padding procedure. The geometry image regenerated by decoding the generated geometry image or the encoded geometry bitstream may be used for 3D geometry reconstruction and may then undergo a smoothing process. The texture image generator may generate a texture image using the (smoothed) 3D geometry, the point cloud, the auxiliary patch information, and the occupancy map. The generated texture image may be encoded into one video bitstream. The auxiliary patch information may be encoded into one metadata bitstream by the metadata encoder, and the occupancy map may be encoded into one video bitstream by the video encoder. The video bitstreams of the generated geometry image, texture image, and the occupancy map and the metadata bitstream of the auxiliary patch information may be multiplexed into one bitstream and transmitted to the reception side through the transmitter. Alternatively, the video bitstreams of the generated geometry image, texture image, and the occupancy map and the metadata bitstream of the auxiliary patch information may be processed into a file of one or more track data or encapsulated into segments and then transmitted to the reception side through the transmitter.

The occupancy map according to the embodiments includes distribution information on a portion that may be a region other than the patch, for example, a black region (padded region), in the patch mapping and transmission process. The decoder or receiver according to the embodiments may identify the patch and padding region based on the occupancy map and the auxiliary patch information.

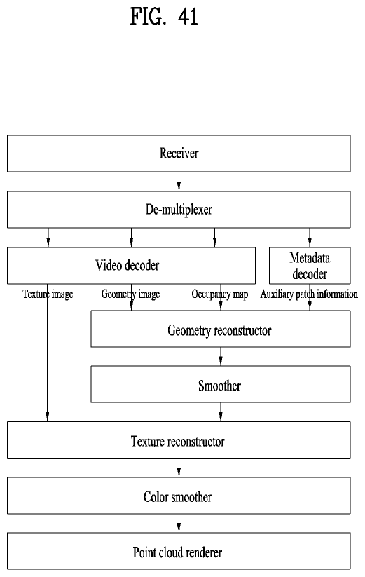

FIG. 41 is a flowchart illustrating a reception side operation according to the embodiments.

An operation process on the reception side for receiving and reconstructing point cloud data using V-PCC according to the embodiments may be performed as illustrated in the figure.

The bitstream of the received point cloud is demultiplexed into the video bitstreams of the compressed geometry image, texture image, occupancy map and the metadata bitstream of the auxiliary patch information after file/segment decapsulation. The video decoder and the metadata decoder decode the demultiplexed video bitstreams and metadata bitstream. The 3D geometry is reconstructed using the decoded geometry image, occupancy map, and auxiliary patch information, and then undergoes a smoothing process. A color point cloud image/picture may be reconstructed by assigning color values to smoothed 3D geometry using the texture image. Thereafter, a color smoothing process may be additionally performed to improve the objective/subjective visual quality, and a modified point cloud image/picture derived is shown to the user through the rendering process (by, for example, the point cloud renderer). In some cases, the color smoothing process may be omitted.

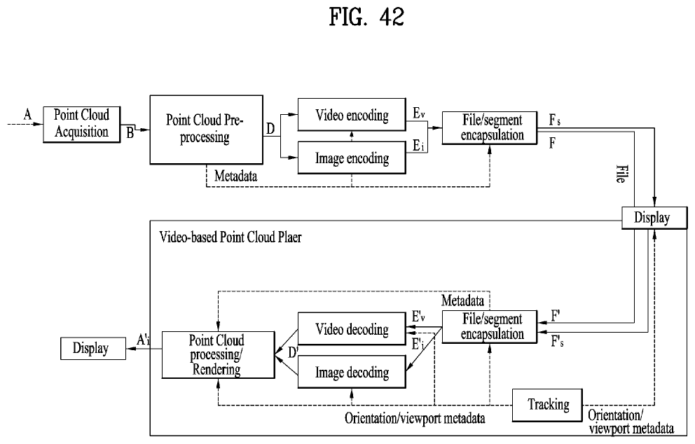

FIG. 42 illustrates an architecture for V-PCC based point cloud data storage and streaming according to embodiments.

In the embodiments, a method of storing and streaming point cloud data that supports various services such as virtual reality (VR), augmented reality (AR), mixed reality (MR), and autonomous driving services.

The figure shows the overall architecture for storing or streaming point cloud data compressed based on video-based point cloud compression (hereinafter referred to as V-PCC). The process of storing and streaming the point cloud data may include an acquisition process, an encoding process, a transmission process, a decoding process, a rendering process, and/or a feedback process.

The embodiments propose a method for effectively providing point cloud media/content/data. In order to effectively provide point cloud media/content/data, a point cloud video may be acquired first. For example, one or more cameras may acquire point cloud data through capture, composition or generation of a point cloud. Through this acquisition process, a point cloud video including a 3D location (which may be represented by x, y, z location values, etc.) (hereinafter referred to as geometry) of each point and attributes (color, reflectance, transparency, etc.) of each point may be acquired. For example, a Polygon File format or Stanford Triangle format (PLY) file or the like including the same may be generated. For point cloud data having multiple frames, one or more files may be acquired. In this process, point cloud related metadata (e.g., metadata related to capture, etc.) may be generated.

Post-processing for improving the quality of the content may be needed for the captured point cloud video. In the video capture process, the maximum/minimum depth may be adjusted within the range provided by the camera equipment. Even after the adjustment, point data of an unwanted area may be included. Accordingly, post-processing of removing the unwanted area (e.g., the background) or recognizing the connected space and filling the spatial holes may be performed. In addition, a point cloud extracted from the cameras sharing a spatial coordinate system may be integrated into one piece of content through a process of transforming each point to a global coordinate system based on the location coordinates of each camera acquired through a calibration process. Thereby, point cloud video with a high density of points may be acquired.

The point cloud pre-processor may generate one or more pictures/frames of the point cloud video. Here, a picture/frame may generally mean a unit representing one image of a specific time zone. When points constituting the point cloud video is divided into one or more patches (sets of points that make up the point cloud video, wherein the points belonging to the same patch neighbor each other in 3D space and mapped to a 2D image in the same direction among the planes of a 6-face bounding box) and mapped to a 2D plane, an occupancy map picture/frame in a binary map indicating whether there is data at the corresponding location in the 2D plane with 0 or 1 may be generated. In addition, a geometry picture/frame, which is a picture/frame in the form of a depth map that represent the information about the location (geometry) of each point constituting the point cloud video on a patch-by-patch basis, may be generated. A texture picture/frame, which is a picture/frame representing the color information about each point constituting the point cloud video on a patch-by-patch basis, may be generated. In this process, metadata needed to reconstruct the point cloud from the individual patches may be generated. The metadata may include information about the patches, such as the location and size of each patch in 2D/3D space. These pictures/frames may be generated continuously in temporal order to construct a video stream or metadata stream.

The point cloud video encoder may encode one or more video streams associated with point cloud video. One video may include multiple frames, and one frame may correspond to a still image/picture. In this specification, the point cloud video may include a point cloud video/frame/picture, and the point cloud video may be used interchangeably with the point cloud video/frame/picture. The point cloud video encoder may perform a video-based point cloud compression (V-PCC) procedure. The point cloud video encoder may perform a series of procedures such as prediction, transform, quantization, and entropy coding for compression and coding efficiency. The encoded data (encoded video/image information) may be output in the form of a bitstream. Based on the V-PCC procedure, the point cloud video encoder may encode point cloud video by dividing the same into geometric video, attribute video, occupancy map video, and metadata, for example, information about a patch, as described below. The geometry video may include a geometry image, the attribute video may include an attribute image, and the occupancy map video may include an occupancy map image. The patch data, which is the auxiliary information, may include patch related information. The attribute video/image may include a texture video/image.

The point cloud image encoder may encode one or more images associated with point cloud video. The point cloud image encoder may perform a video-based point cloud compression (V-PCC) procedure. The point cloud image encoder may perform a series of procedures such as prediction, transform, quantization, and entropy coding for compression and coding efficiency. The encoded image may be output in the form of a bitstream. Based on the V-PCC procedure, the point cloud image encoder may encode the point cloud image by dividing the same into a geometric image, an attribute image, an occupancy map image, and metadata, e.g., information about patches, as described below.

In encapsulation (file/segment encapsulation), the encoded point cloud data and/or point cloud-related metadata may be encapsulated in the form of a file or a segment for streaming. Here, the point cloud-related metadata may be received from the metadata processor or the like. The metadata processor may be included in the point cloud video/image encoder or may be configured as a separate component/module. The encapsulation processor may encapsulate the corresponding video/image/metadata in a file format such as ISOBMFF or in the form of a DASH segment or the like. According to an embodiment, the encapsulation processor may include the point cloud metadata on the file format. The point cloud-related metadata may be included, for example, in various levels of boxes on the ISOBMFF file format or as data in a separate track within the file. According to an embodiment, the encapsulation processor may encapsulate the point cloud-related metadata into a file.

The transmission processor may perform processing for transmission on the encapsulated point cloud data according to the file format. The transmission processor may be included in the transmitter or may be configured as a separate component/module. The transmission processor may process the point cloud data according to a transmission protocol. The processing for transmission may include processing for delivery over a broadcast network and processing for delivery through a broadband. According to an embodiment, the transmission processor may receive point cloud-related metadata from the metadata processor as well as the point cloud data, and perform processing for transmission on the point cloud data.

The transmitter may transmit a point cloud bitstream or a file/segment including the bitstream to the receiver of the reception apparatus over a digital storage medium or a network. For transmission, processing according to any transmission protocol may be performed. The data that has been processed for transmission can be delivered over a broadcast network and/or broadband. The data may be delivered to the reception side in an on-demand manner. The digital storage medium may include various storage media such as USB, SD, CD, DVD, Blu-ray, HDD, and SSD. The transmitter may include an element for generating a media file in a predetermined file format, and may include an element for transmission over a broadcast/communication network. The receiver may extract the bitstream and transmit the extracted bitstream to the decoder.

The receiver may receive point cloud data transmitted by the point cloud data transmission apparatus according to embodiments. Depending on the transmission channel, the receiver may receive the point cloud data over a broadcasting network or through a broadband. Alternatively, the point cloud data may be received through a digital storage medium. The receiver may include a process of decoding the received data and rendering the data according to the user's viewport.

The reception processor may perform processing on the received point cloud video data according to the transmission protocol. The reception processor may be included in the receiver or may be configured as a separate component/module. The reception processor may reversely perform the process of the above-described transmission processor so as to correspond to the processing for transmission performed at the transmission side. The reception processor may deliver the acquired point cloud video to the decapsulation processor, and the acquired point cloud-related metadata to the metadata parser.

The decapsulation (file/segment decapsulation) processor may decapsulate the point cloud data received in the form of a file from the reception processor. The decapsulation processor may decapsulate files according to ISOBMFF or the like, and may acquire a point cloud bitstream or point cloud-related metadata (or a separate metadata bitstream). The acquired point cloud bitstream may be delivered to the point cloud decoder, and the acquired point cloud video-related metadata (metadata bitstream) may be delivered to the metadata processor. The point cloud bitstream may include the metadata (metadata bitstream). The metadata processor may be included in the point cloud decoder or may be configured as a separate component/module. The point cloud video-related metadata acquired by the decapsulation processor may take the form of a box or track in the file format. The decapsulation processor may receive metadata necessary for decapsulation from the metadata processor, when necessary. The point cloud-related metadata may be delivered to the point cloud decoder and used in a point cloud decoding procedure, or may be transferred to the renderer and used in a point cloud rendering procedure.

The point cloud video decoder may receive the bitstream and decode the video/image by performing an operation corresponding to the operation of the point cloud video encoder. In this case, the point cloud video decoder may decode the point cloud video by dividing the same into a geometry video, an attribute video, an occupancy map video, and auxiliary patch information as described below. The geometry video may include a geometry image, the attribute video may include an attribute image, and the occupancy map video may include an occupancy map image. The auxiliary information may include auxiliary patch information. The attribute video/image may include a texture video/image.

The 3D geometry may be reconstructed using the decoded geometry image, the occupancy map, and auxiliary patch information, and then may be subjected to a smoothing process. The color point cloud image/picture may be reconstructed by assigning a color value to the smoothed 3D geometry using the texture image. The renderer may render the reconstructed geometry and the color point cloud image/picture. The rendered video/image may be displayed through the display. The user may see all or part of the rendered result through a VR/AR display or a normal display.

The sensor/tracker (sensing/tracking) acquires orientation information and/or user viewport information from the user or the reception side and delivers the orientation information and/or the user viewport information to the receiver and/or the transmitter. The orientation information may represent information about the location, angle, movement, etc. of the user's head, or represent information about the location, angle, movement, etc. of the apparatus that the user is viewing. Based on this information, information about the area currently viewed by the user in 3D space, that is, viewport information may be calculated.

The viewport information may be information about an area in 3D space currently viewed by the user through a device or an HMD. A device such as a display may extract a viewport area based on the orientation information, a vertical or horizontal FOV supported by the apparatus, and the like. The orientation or viewport information may be extracted or calculated at the reception side. The orientation or viewport information analyzed at the reception side may be transmitted to the transmission side on a feedback channel.

Using the orientation information acquired by the sensing/tracking unit and/or the viewport information indicating the area currently being viewed by the user, the receiver may efficiently extract or decode only media data of a specific area, i.e., the area indicated by the orientation information and/or the viewport information from the file. In addition, using the orientation information and/or viewport information acquired by the sensing/tracking unit, the transmitter may efficiently encode only the media data of the specific area, that is, the area indicated by the orientation information and/or the viewport information, or generate and transmit a file therefor.

The renderer may render the decoded point cloud data in 3D space. The rendered video/image may be displayed through the display. The user may see all or part of the rendered result through a VR/AR display or a normal display.

The feedback process may include transferring various feedback information that may be acquired in the rendering/displaying process to the transmission side or to the decoder of the reception side. Through the feedback process, interactivity may be provided for consumption of point cloud data. According to an embodiment, head orientation information, viewport information indicating a region currently viewed by a user, and the like may be delivered to the transmission side in the feedback process. According to an embodiment, the user may interact with those implemented in the VR/AR/MR/autonomous driving environment. In this case, information related to the interaction may be delivered to the transmission side or a service provider during the feedback process. According to an embodiment, the feedback process may not be performed.

According to an embodiment, the above-described feedback information may not only be transmitted to the transmission side, but also be consumed at the reception side. That is, the decapsulation processing, decoding, and rendering processes of the reception side may be performed using the above-described feedback information. For example, the point cloud data about the area currently viewed by the user may be preferentially decapsulated, decoded, and rendered using the orientation information and/or the viewport information.

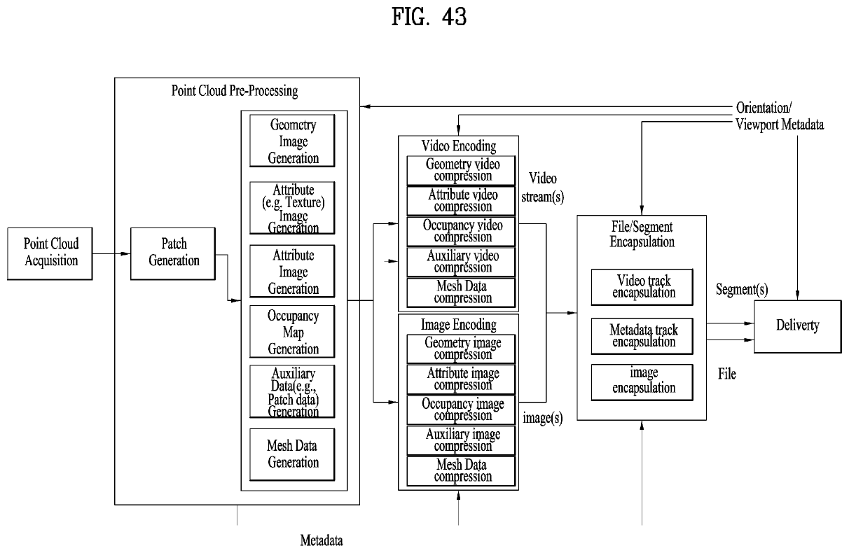

FIG. 43 illustrates an apparatus for storing and transmitting point cloud data according to embodiments.

The apparatus for storing and transmitting point cloud data according to the embodiments may include a point cloud acquirer (point cloud acquisition), a patch generator (patch generation), a geometry image generator (geometry image generation), an attribute image generator (attribute image generation), an occupancy map generator (occupancy map generation), an auxiliary data generator (auxiliary data generation), a mesh data generator (mesh data generation), a video encoder (video encoding), an image encoder (image encoding), a file/segment encapsulator (file/segment encapsulation), and a deliverer (delivery). According to an embodiment, the patch generation, geometry image generation, attribute image generation, occupancy map generation, auxiliary data generation, mesh data generation may be referred to as point cloud pre-processing, a pre-processor or a controller. The video encoder includes geometry video compression, attribute video compression, occupancy map compression, auxiliary data compression, and mesh data compression. The image encoder includes geometry video compression, attribute video compression, occupancy map compression, auxiliary data compression, and mesh data compression. The file/segment encapsulator includes video track encapsulation, metadata track encapsulation, and image encapsulation. Each element of the transmission apparatus may be a module/unit/component/hardware/software/processor.

The geometry, attribute, auxiliary data, and mesh data of the point cloud may each be configured as a separate stream or stored in different tracks in a file. Furthermore, they may be included in a separate segment.

The point cloud acquirer (point cloud acquisition) acquires a point cloud. For example, one or more cameras may acquire point cloud data through capture, composition or generation of a point cloud. Through this acquisition process, point cloud data including a 3D location (which may be represented by x, y, z location values, etc.) (hereinafter referred to as geometry) of each point and attributes (color, reflectance, transparency, etc.) of each point may be acquired. For example, a Polygon File format or Stanford Triangle format (PLY) file or the like including the same may be generated. For point cloud data having multiple frames, one or more files may be acquired. In this process, point cloud related metadata (e.g., metadata related to capture, etc.) may be generated.

The patch generation or patch generator generates patches from the point cloud data. The patch generator generates point cloud data or point cloud video into one or more pictures/frames. A picture/frame may generally refer to a unit representing one image of a specific time zone. When points constituting the point cloud video is divided into one or more patches (sets of points that make up the point cloud video, wherein the points belonging to the same patch neighbor each other in 3D space and mapped to a 2D image in the same direction among the planes of a 6-face bounding box) and mapped to a 2D plane, an occupancy map picture/frame in a binary map indicating whether there is data at the corresponding location in the 2D plane with 0 or 1 may be generated. In addition, a geometry picture/frame, which is a picture/frame in the form of a depth map that represent the information about the location (geometry) of each point constituting the point cloud video on a patch-by-patch basis, may be generated. A texture picture/frame, which is a picture/frame representing the color information about each point constituting the point cloud video on a patch-by-patch basis, may be generated. In this process, metadata needed to reconstruct the point cloud from the individual patches may be generated. The metadata may include information about the patches, such as the location and size of each patch in 2D/3D space. These pictures/frames may be generated continuously in temporal order to construct a video stream or metadata stream.

In addition, the patches may be used for 2D image mapping. For example, the point cloud data may be projected onto each face of the cube. After patch generation, a geometry image, one or more attribute images, an occupancy map, auxiliary data, and/or mesh data may be generated based on the generated patches.

Geometry image generation, attribute image generation, occupancy map generation, auxiliary data generation, and/or mesh data generation are performed by the pre-processor or controller.

In the geometry image generation, a geometry image is generated based on the result of the patch generation. Geometry represents points in 3D space. A geometry image is generated based on the patches using the occupancy map, which includes information related to 2D image packing of the patches, auxiliary data (patch data), and/or mesh data. The geometry image is associated with information such as a depth (e.g., near, far) for a patch generated after the patch generation.

In the attribute image generation, an attribute image is generated. For example, an attribute may represent a texture. The texture may be a color value that matches each point. According to embodiments, images of a plurality of attributes (such as color and reflectance) (N attributes) including a texture may be generated. The plurality of attributes may include material information and reflectance. In addition, according to embodiments, the attributes may additionally include information indicating a color that may vary depending on viewing angle and light even for the same texture.

In the occupancy map generation, an occupancy map is generated from the patches. The occupancy map includes information representing the presence or absence of data in the pixel, such as the corresponding geometry or attribute image.

In the auxiliary data generation, auxiliary data including information about the patches is generated. That is, the auxiliary data represents metadata about a patch of a point cloud object. For example, it may represent information such as normal vectors for the patches. Specifically, according to embodiments, the auxiliary data may include information needed to reconstruct the point cloud from the patches (e.g., information about the locations, sizes, and the like of the patches in 2D/3D space, and projection (normal) plane identification information, patch mapping information, etc.)

In the mesh data generation, mesh data is generated from the patches. Mesh represents connection information between neighboring points. For example, it may represent data of a triangular shape. For example, mesh data according to the embodiments refers to connectivity between the points.

The point cloud pre-processor or controller generates metadata related to patch generation, geometry image generation, attribute image generation, occupancy map generation, auxiliary data generation, and mesh data generation.

The point cloud transmission apparatus performs video encoding and/or image encoding in response to the result generated by the pre-processor. The point cloud transmission apparatus may generate point cloud image data as well as point cloud video data. According to embodiments, the point cloud data may have only video data, only image data, and/or both video data and image data.

The video encoder performs geometry video compression, attribute video compression, occupancy map compression, auxiliary data compression, and/or mesh data compression. The video encoder generates video stream(s) containing encoded video data.

Specifically, in the geometry video compression, point cloud geometry video data is encoded. In the attribute video compression, attribute video data of the point cloud is encoded. In the auxiliary data compression, auxiliary data associated with the point cloud video data is encoded. In the mesh data compression, mesh data of the point cloud video data is encoded. The respective operations of the point cloud video encoder may be performed in parallel.

The image encoder performs geometry image compression, attribute image compression, occupancy map compression, auxiliary data compression, and/or mesh data compression. The image encoder generates image(s) containing encoded image data.

Specifically, in the geometry image compression, point cloud geometry image data is encoded. In the attribute image compression, attribute image data of the point cloud is encoded. In the auxiliary data compression, the auxiliary data associated with the point cloud image data is encoded. In the mesh data compression, mesh data associated with the point cloud image data is encoded. The respective operations of the point cloud image encoder may be performed in parallel.

The video encoder and/or the image encoder may receive metadata from the pre-processor. The video encoder and/or the image encoder may perform each encoding process based on the metadata.

The file/segment encapsulator (file/segment encapsulation) encapsulates the video stream(s) and/or image(s) in the form of a file and/or segment. The file/segment encapsulator performs video track encapsulation, metadata track encapsulation, and/or image encapsulation.

In the video track encapsulation, one or more video streams may be encapsulated into one or more tracks.

In the metadata track encapsulation, metadata related to a video stream and/or image may be encapsulated in one or more tracks. The metadata includes data related to the content of the point cloud data. For example, it may include initial viewing orientation metadata. According to embodiments, the metadata may be encapsulated in a metadata track, or may be encapsulated together in a video track or an image track.

In the image encapsulation, one or more images may be encapsulated into one or more tracks or items.

For example, according to embodiments, when four video streams and two images are input to the encapsulator, the four video streams and two images may be encapsulated in one file.

The file/segment encapsulator may receive metadata from the pre-processor. The file/segment encapsulator may perform encapsulation based on the metadata.

Files and/or segments generated by the file/segment encapsulation are transmitted by the point cloud transmission apparatus or transmitter. For example, the segment(s) may be delivered based on a DASH-based protocol.

The transmitter may transmit a point cloud bitstream or a file/segment including the bitstream to the receiver of the reception apparatus over a digital storage medium or a network. For transmission, processing according to any transmission protocol may be performed. The data that has been processed for transmission can be delivered over a broadcast network and/or broadband. The data may be delivered to the reception side in an on-demand manner. The digital storage medium may include various storage media such as USB, SD, CD, DVD, Blu-ray, HDD, and SSD. The deliverer may include an element for generating a media file in a predetermined file format, and may include an element for transmission over a broadcast/communication network. The deliverer receives orientation information and/or viewport information from the receiver. The deliverer may deliver the acquired orientation information and/or viewport information (or information selected by the user) to the pre-processor, the video encoder, the image encoder, the file/segment encapsulator, and/or the point cloud encoder. Based on the orientation information and/or viewport information, the point cloud encoder may encode all point cloud data or the point cloud data indicated by the orientation information and/or viewport information. Based on the orientation information and/or viewport information, the file/segment encapsulator may encapsulate all point cloud data or the point cloud data indicated by the orientation information and/or viewport information. Based on the orientation information and/or viewport information, the deliverer may deliver all point cloud data or the point cloud data indicated by the orientation information and/or viewport information.

For example, the pre-processor may perform the above-described operation on all the point cloud data, or may perform the above-described operation on the point cloud data indicated by the orientation information and/or viewport information. The video encoder and/or the image encoder may perform the above-described operation on all the point cloud data or on the point cloud data indicated by the orientation information and/or the viewport information. The file/segment encapsulator may perform the above-described operation on all the point cloud data or on the point cloud data indicated by the orientation information and/or the viewport information. The transmitter may perform the above-described operation on all the point cloud data or on the point cloud data indicated by the orientation information and/or the viewport information.

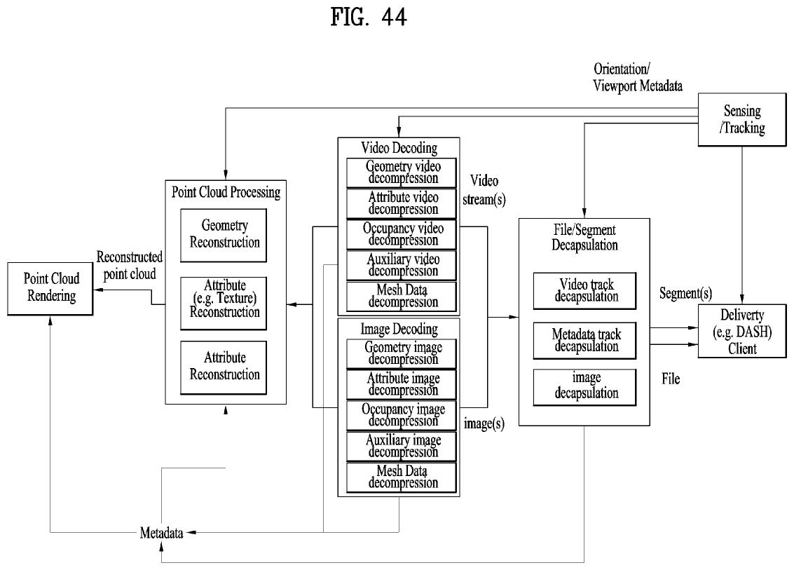

FIG. 44 illustrates a point cloud data reception apparatus according to embodiments.

A point cloud data reception apparatus according to the embodiments may include a delivery client, a sensor/tracker (sensing/tracking), a file/segment decapsulator (file/segment decapsulation), a video decoder (video decoding), an image decoder (image decoding), a point cloud processor (point cloud processing) and/or a point cloud renderer (point cloud rendering), and a display. The video decoder includes geometry video decompression, attribute video decompression, occupancy map decompression, auxiliary data decompression, and/or mesh data decompression. The image decoder includes geometry image decompression, attribute image decompression, occupancy map decompression, auxiliary data decompression, and/or mesh data decompression. Point cloud processing includes geometry reconstruction and attributes reconstruction.

Each component of the reception apparatus may be a module/unit/component/hardware/software/processor.

The delivery client may receive point cloud data, a point cloud bitstream, or a file/segment including the corresponding bitstream transmitted by the point cloud data transmission apparatus according to the embodiments. The receiver may receive the point cloud data over a broadcast network or through a broadband depending on the channel used for the transmission. Alternatively, the point cloud video data may be received through a digital storage medium. The receiver may include a process of decoding the received data and rendering the received data according to the user's viewport. The reception processor may perform processing on the received point cloud data according to a transmission protocol. A reception processor may be included in the receiver or configured as a separate component/module. The reception processor may perform a reverse process of the above-described transmission processor so as to correspond to the processing for transmission performed at the transmission side. The reception processor may deliver the acquired point cloud data to the decapsulation processor, and the acquired point cloud-related metadata to the metadata parser.

The sensor/tracker (sensing/tracking) acquires orientation information and/or viewport information. The sensor/tracker may deliver the obtained orientation information and/or viewport information to the delivery client, the file/segment decapsulator, and the point cloud decoder.

The delivery client may receive all point cloud data or the point cloud data indicated by the orientation information and/or viewport information based on the orientation information and/or viewport information. The file/segment decapsulator may decapsulate all point cloud data or the point cloud data indicated by the orientation information and/or viewport information based on the orientation information and/or viewport information. The point cloud decoder (the video decoder and/or the image decoder) may decode all point cloud data or the point cloud data indicated by the orientation information and/or viewport information based on the orientation information and/or viewport information. The point cloud processor may process all point cloud data or the point cloud data indicated by the orientation information and/or viewport information based on the orientation information and/or viewport information.

The file/segment decapsulator (file/segment decapsulation) performs video track decapsulation, metadata track decapsulation, and/or image decapsulation. The decapsulation processor (file/segment decapsulation) may decapsulate the point cloud data in the form of a file received from the reception processor. The decapsulation processor (file/segment decapsulation) may decapsulate files or segments according to ISOBMFF, etc., to acquire a point cloud bitstream or point cloud-related metadata (or a separate metadata bitstream). The acquired point cloud bitstream may be delivered to the point cloud decoder, and the acquired point cloud-related metadata (or metadata bitstream) may be delivered to the metadata processor. The point cloud bitstream may include the metadata (metadata bitstream). The metadata processor may be included in the point cloud video decoder or configured as a separate component/module. The point cloud-related metadata acquired by the decapsulation processor may take the form of a box or track in a file format. The decapsulation processor may receive metadata necessary for decapsulation from the metadata processor, if necessary. The point cloud-related metadata may be delivered to the point cloud decoder and used in a point cloud decoding procedure, or may be delivered to the renderer and used in a point cloud rendering procedure. The file/segment decapsulator may generate metadata related to the point cloud data.

In the video track decapsulation, a video track contained in the files and/or segment is decapsulated. Video stream(s) including geometry video, attribute video, an occupancy map, auxiliary data, and/or mesh data are decapsulated.

In the metadata track decapsulation, a bitstream including metadata related to the point cloud data and/or auxiliary data is decapsulated.

In the image decapsulation, image(s) including a geometry image, an attribute image, an occupancy map, auxiliary data and/or mesh data are decapsulated.

The video decoder (video decoding) performs geometry video decompression, attribute video decompression, occupancy map decompression, auxiliary data decompression, and/or mesh data decompression. The video decoder decodes the geometry video, the attribute video, the auxiliary data, and/or the mesh data in a process corresponding to the process performed by the video encoder of the point cloud transmission apparatus according to the embodiments.

The image decoder (image decoding) performs geometry image decompression, attribute image decompression, occupancy map decompression, auxiliary data decompression, and/or mesh data decompression. The image decoder decodes the geometry image, the attribute image, the auxiliary data, and/or the mesh data in a process corresponding to the process performed by the image encoder of the point cloud transmission apparatus according to the embodiments.

The video decoder and/or the image decoder may generate metadata related to the video data and/or the image data.

The point cloud processor (point cloud processing) performs geometry reconstruction and/or attributes reconstruction.

In the geometry reconstruction, the geometry video and/or geometry image are reconstructed from the decoded video data and/or decoded image data based on the occupancy map, auxiliary data and/or mesh data.

In the attribute reconstruction, the attribute video and/or attribute image are reconstructed from the decoded attribute video and/or decoded attribute image based on the occupancy map, auxiliary data, and/or mesh data. According to embodiments, for example, the attribute may be a texture. According to embodiments, an attribute may refer to a plurality of pieces of attribute information. When there is a plurality of attributes, the point cloud processor according to the embodiments performs a plurality of attribute reconstructions.

The point cloud processor may receive metadata from the video decoder, the image decoder, and/or the file/segment decapsulator, and process the point cloud based on the metadata.

The point cloud renderer (point cloud rendering) renders the reconstructed point cloud. The point cloud renderer may receive metadata from the video decoder, the image decoder, and/or the file/segment decapsulator, and render the point cloud based on the metadata.

The display actually displays the result of rendering on the display.

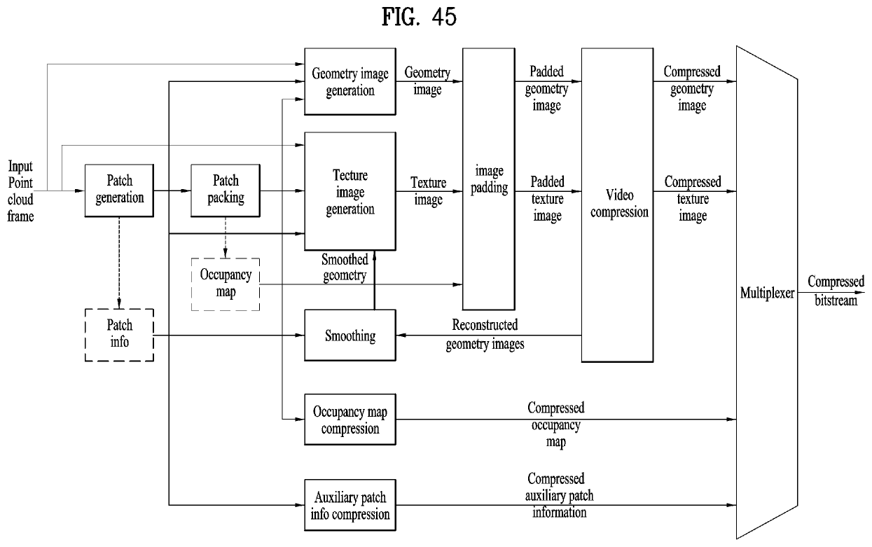

FIG. 45 illustrates an encoding process of a point cloud data transmission apparatus according to embodiments.

Patch generation according to embodiments: In the patch generation, a frame containing point cloud data is received and a patch is generated. The patch may be a set of points subjected to mapping when a PCC frame is mapped to a 2D plane. The process of generating a patch from the PCC frame may include the following steps: calculating a normal vector of each point constituting the PCC, generating a cluster corresponding to an image projected onto the six bounding box planes in FIG. 27 and reconstructing the cluster using the normal vector and a neighboring cluster, and extracting neighboring points from the cluster and generating a patch.

In the patch generation according to the embodiments, a 3D object may be bounded by 6 3D planes, and the object may be projected onto each plane. According to embodiments, one point may be projected onto one projection plane. In the embodiments, a plane onto which a point is to be projected may be determined. Based on vectors such as a vector with respect to a surface and an orientation vector of a plane, a corresponding projection plane of the point may be determined.

Regarding patch packing according to embodiments, the result of the projection is a patch, which may be projected onto 2D space. An occupancy map is generated in the patch packing process. Then, a process of assigning data corresponding to a location is performed according to the embodiments.

In the patch generation according to the embodiments, patch information including patch generation-related metadata or signaling information may be generated. In the patch generation according to embodiments, the patch information may be delivered to geometry image generation, patch packing, texture image generation, smoothing, and/or auxiliary patch information compression.

The occupancy map according to the embodiments may be encoded based on a video coding scheme.

In smoothing according to embodiments, inter-patch spacing may be smoothed in order to address an issue of deterioration in image quality (e.g., inter-patch spacing) caused by inter-patch artifacts produced due to the encoding process (in order to improve coding efficiency). The point cloud data may be reconstructed by assigning a texture and a color to the smoothing result.

Referring to FIG. 27, the generated patch data may include an occupancy map, a geometry image, and a texture image, which corresponding to an individual patch. The occupancy map may be a binary map indicating whether there is data at a point constituting the patch. The geometry image may be used to identify the locations of the points constituting the PCC in the 3D space, and may be represented by 1-channel value, such as a depth map. The geometry image may be configured in a plurality of layers. For example, a near point (D0) may be acquired by setting a specific point in the PCC to the lowest depth value, and a far layer (D1) may be acquired by setting the same point to the highest depth value. The texture image may indicate a color value corresponding to each point and may be expressed as a multi-channel value such as RGB or YUV.

Patch packing according to embodiments will be described with reference to FIG. 28. Patch packing may be a process of determining the location of each patch in a whole 2D image. The determined location of the patch is also applied to the occupancy map, the geometry image, and the texture image, and therefore one of the map and the images may be used in the packing process. Using the occupancy map, the locations of patches may be determined as follows.

1) Generate an occupancy map (occupancySizeU*occupancySizeV) and set all pixel values to false (=0).

2) Place the top left of the patch of the 2D image at any point (u, v) in the occupancy map (where 0<=u<occupancySizeU−patch.sizeU0, and 0<=v<occupancySizeV−patch.sizeV0).

3) For any point (x, y) in the patch, check a corresponding point value of the patch occupancy map obtained in the patch generation process. In addition, check a corresponding point value of the entire occupancy map (where 0<=x<patch.sizeU0, and 0<=y<patch.sizeV0).

4) For a specific point (x, y), when both values are 1 (=true), change the top left location of the patch and repeat operation 3). Otherwise, determine (u, v) as the location of the patch.

In the patch packing according to the embodiments, an occupancy map including metadata or signaling information related to patch packing may be generated. In the patch packing according to the embodiments, an occupancy map may be delivered to geometry image generation, texture image generation, image padding, and/or occupancy map compression.

In the geometry image generation according to the embodiments, a geometry image is generated based on a frame containing point cloud data, patch information, and/or an occupancy map. The geometry image generation may be a process of filling the entire geometry with data (i.e., depth values) based on the determined patch locations and the geometry of individual patches. Geometry images of multiple layers (e.g., near [d0] layer/far [d1] layer) may be generated.

In the texture image generation according to embodiments, a texture image is generate based on a frame containing point cloud data, patch information, an occupancy map, and/or smoothed geometry. The texture image generation may be a process of filling the entire geometry with data (i.e., color values) based on the determined patch locations and the geometry of individual patches.

The smoothing procedure can aim at alleviating potential discontinuities that may arise at the patch boundaries due to compression artifacts. Smoothing according to the embodiments reduces discontinuities. The implemented approach may move boundary points to the centroid of their nearest neighbors).

The occupancy map compression (or generation) according to the embodiments generates an occupancy map according to the patch packing result, and compresses the occupancy map. The occupancy map processing may be a process of filling the entire occupancy map with data (i.e., 0 or 1) based on the determined patch locations and the occupancy maps of the individual patches. It may be considered as part of the patch packing process described above. The occupancy map compression according to the embodiments may be a process of compressing the generated occupancy map using arithmetic coding or the like.

In the auxiliary patch information compression according to the embodiments, auxiliary patch information is compressed based on the patch information according to patch generation. The auxiliary patch information compression is a process of encoding the auxiliary information about individual patches, and may include information corresponding to an index of a projection plane, a 2D bounding box, and a 3D location of a patch.

In the image padding according to the embodiments, a geometry image and/or a texture image are padded. Image padding fills in a blank area that is not filled between patches with data so as to be suitable for video compression. For the padding data according to the embodiments, neighboring area pixel values, an average of neighboring area pixel values, or the like may be used.

In the video compression according to the embodiments, a geometry image and a texture image generated using a codec (e.g., HEVC, AVC) are encoded. The encoded geometry image (or reconstructed geometry image) according to the embodiments may be smoothed through the smoothing operation.

The encoder or the point cloud data transmission apparatus according to the embodiments may provide signaling based on the occupancy map and/or the auxiliary patch information, such that the decoder or the point cloud data reception apparatus according to the embodiments can recognize the 3D point location and the 2D point location.

A multiplexer according to embodiments generates one bitstream by multiplexing the data constituting one PCC image, including the compressed geometry image, the compressed texture image, the compressed occupancy map, and the compressed patch information. According to embodiments, a set of data of the compressed geometry image, the compressed texture image, the compressed occupancy map, and the compressed patch information corresponding to one group of pictures (GOP) may be called a group of frames (GOF). The generated bitstream may take the form of a NAL unit stream, an ISO BMFF file, a DASH segment, an MMT MPU, or the like. The generated bitstream may include GOF header data indicating coding characteristics of the PCC GOF. Each operation of the encoding process according to the embodiments may be regarded as an operation of a combination of hardware, software, and/or a processor.

In this specification, the point cloud data transmission apparatus according to the embodiments can be called by variously names, such as an encoder, a transmitter, and a transmission apparatus.

The point cloud data transmission apparatus according to embodiments provides an effect of efficiently coding point cloud data based on the embodiments described in this specification, and an effect of enabling the point cloud data reception apparatus according to the embodiments to efficiently decode/reconstruct the point cloud data.

A point cloud data transmission method according to the embodiments may include generating a geometry image for a location of point cloud data; generating a texture image for attributes of the point cloud data; generating an occupancy map for a patch of the point cloud data; and/or multiplexing the geometry image, the texture image and the occupancy map. According to embodiments, the geometry image may be called geometry information or geometry data, the texture image may be called texture information, texture data, attribute information, or attribute data, and the occupancy map may be called occupancy information, within the scope of meaning of each term.

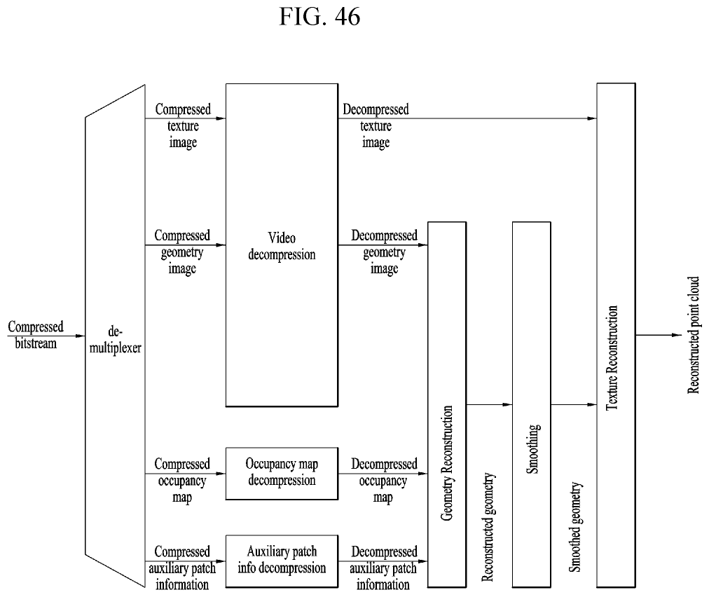

FIG. 46 illustrates a decoding process according to embodiments.

A de-multiplexer according to embodiments extracts individual data constituting a PCC image, including the compressed geometry image, the compressed texture image, the compressed occupancy map, and the compressed patch information from one PCC bitstream (e.g., NAL unit stream, ISO BMFF file, DASH segment, MMT MPU) through demultiplexing. The de-multiplexer may also include a process of interpreting the GOF header data indicating the coding characteristics of the PCC GOF.

In the video decompression according to embodiments, the extracted compressed geometry image and compressed texture image are decoded using a codec (e.g., HEVC, AVC).

In the occupancy map decompression according to embodiments, the extracted compressed occupancy map is decoded using arithmetic coding or the like.

Auxiliary patch information decompression according to embodiments is a process of interpreting auxiliary information about an individual patch by decoding the extracted compressed auxiliary patch information. Such information may include an index of a projection plane, a 2D bounding box, and a 3D location of the patch.

Geometry reconstruction according to embodiments may be a process of calculating the locations of the points constituting the PCC in the 3D space using the decompressed geometry image, the decompressed occupancy map, and the decompressed auxiliary patch information. The calculated locations of the points may be expressed in the form of 3D locations of the points (e.g., x, y, z) and the presence or absence of data (0 or 1).

The smoothing procedure can aim at alleviating potential discontinuities that may arise at the patch boundaries due to compression artifacts. Smoothing according to the embodiments reduces discontinuities. The implemented approach may move boundary points to the centroid of their nearest neighbors). Smoothing reduces discontinuities that may occur during decoding.

Texture reconstruction according to embodiments may be a process of assigning a color value to a corresponding point using the locations of the points calculated in the geometry reconstruction process and the decompressed texture image.

The decoding process according to the embodiments may be an inverse process of the encoding process according to the embodiments.

In this specification, the point cloud data reception apparatus according to the embodiments may be called by various names such as a decoder, a receiver, and a reception apparatus.

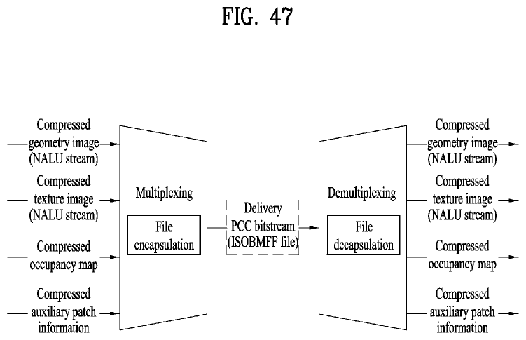

FIG. 47 illustrates ISO BMFF based multiplexing/demultiplexing according to embodiments.

In multiplexing according to the embodiments, a geometry image, a texture image, an occupancy map, and/or auxiliary patch information are multiplexed. The geometry image according to the embodiments may be a NALU stream. The texture image according to the embodiments may be a NALU stream. According to embodiments, the geometry image, texture image, occupancy map and/or auxiliary patch information are encapsulated in the form of a file.

Embodiments of the present disclosure relate to how to code, transmit and receive point cloud data, for example, four kinds of data (geometry, texture, occupancy map, and auxiliary map information), particularly based on the V-PCC scheme.

In delivery according to embodiments, a PCC bitstream into which the geometry image, texture image, occupancy map and/or auxiliary patch information are multiplexed is transmitted. According to embodiments, the delivery type may include an ISOBMFF file.

In demultiplexing according to embodiments, the geometry image, texture image, occupancy map and/or auxiliary patch information are demultiplexed. The geometry image according to the embodiments may be a NALU stream. The texture image according to the embodiments may be a NALU stream. According to embodiments, the geometry image, texture image, occupancy map and/or auxiliary patch information are de-encapsulated in the form of a file.

The form of multiplexing/demultiplexing according to embodiments is as follows.

An ISO BMFF file according to embodiments may have multiple PCC tracks. Each of the PCC tracks according to embodiments may individually include the following information.

The multiple tracks according to the embodiments may be composed of, for example, four tracks as follows.

A geometry/texture image related track according to the embodiments includes definition of a restricted scheme type and/or an additional box of a video sample entry.

The restricted scheme type according to the embodiments may additionally define a scheme type box to indicate information that data to be transmitted/received is geometry and/or texture images (videos) for the point cloud.

The additional box of the video sample entry according to the embodiments may include metadata for interpreting the point cloud. The video sample entry according to the embodiments may include a PCC sub-box including PCC-related metadata. For example, the geometry, texture, occupancy map, auxiliary patch metadata, and the like may be identified.

The geometry/texture images according to embodiments may be composed of two layers (for example, D0, D1, T0, T1). According to embodiments, the geometry/texture images may be constructed based on at least two layers for efficiency when points on a surface overlap each other.

An occupancy map/auxiliary patch information-related track according to embodiments includes definition of a timed metadata track, for example, definition of a sample entry and a sample format. In addition, information about occupancy and the location of a patch may be included in the track.

The geometry/texture/occupancy map/auxiliary patch information tracks may be grouped into a PCC track grouping-related track according to embodiments, and PCC GOF header information is included in the track.

Information about a track reference between geometries D0 and D1 (when the differential method is used) is included in a PCC track referencing-related track according to embodiments.

An ISO BMFF file according to embodiments may have a single PCC track.

The single track according to the embodiments may include the following information.

Regarding the PCC GOF header information according to the embodiments, the track includes definition of a restricted scheme type and/or an additional box of a video sample entry.

Regarding the geometry/texture images according to the embodiments, the track may include a sub-sample and sample grouping. The sub-sample refers to configuring an individual image with a sub-sample, and signaling (of, for example, D0, D1 or texture) is allowed. Sample grouping refers to configuring an individual image with a sample, and the image may be distinguished using sample grouping after interleaving.

According to embodiments, since a plurality of pieces of information may be included in the single track sample, sub-samples (classifying sub-samples) may be necessary, and sample grouping may sequentially distinguish samples.

Regarding the occupancy map/auxiliary patch information according to the embodiments, the track includes sample auxiliary information, sample grouping, and/or a sub-sample. For the sample auxiliary information (‘saiz’, ‘szio’ box), individual metadata may be configured with sample auxiliary information and be signaling. Sample grouping may be the same as or similar to that described above. The sub-sample may constitute individual metadata and be signaled.

According to embodiments, a file may be multiplexed onto one track and transmitted, or may be multiplexed onto multiple tracks and transmitted. In addition, through signaling information, video data, for example, the geometry/texture image may be distinguished, and metadata, for example, the occupancy map/auxiliary patch information, may be distinguished.

SchemeType for a PCC track according to embodiments is configured as follows.

When a PCC frame is decoded, the decoded PCC frame may include data such as a geometry image, a texture image, an occupancy map, auxiliary patch information of one or two layers. The PCC video track may contain one or more of these data, and a point cloud may be reconstructed by performing post-processing based on the data. As such, the track including the PCC data may be identified through, for example, the ‘pccv’ value of scheme type present in SchemeTypeBox.

The box of SchemeType according to the embodiments may be expressed as follows.

```
  aligned(8) class SchemeTypeBox extends FullBox(′schm′, 0, flags) {
  unsigned int(32)scheme_type;
  unsigned int(32)scheme_version;
  if (flags & 0×000001) {
    unsigned int(8) scheme_uri[];
  }
}
```

SchemeType according to embodiments may indicate that the track is a track for delivering point cloud data.

Through the SchemeType according to the embodiments, the receiver may recognize the type of data for which whether reception/decoding is allowed can be checked and may provide compatibility.

The PCC file according to the embodiments may include a PCC Video Box. A PCC track containing PCC data may have PccVideoBox. PccVideoBox may be positioned under SchemeInformationBox when SchemeType is ‘pccv’. Alternatively, it may be positioned under VisualSampleEntry regardless of SchemeType. PccVideoBox may indicate whether data needed to reconstruct a PCC frame, such as the PCC GOF header, the geometry image (D0/D1), the texture image, the occupancy map, and the auxiliary patch information, is present in the current track, and may directly contain PCC GOF header data.

Box Type: ‘pccv′

| | |
|---|---|
| Container: | SchemeInformationBox or VisualSampleEntry |
| Mandatory: | Yes (when the SchemeType is ‘pccv′) |
| Quantity: | One |

```
  aligned(8) class PccVideoBox extends FullBox(‘pccv′, version = 0, 0) {
  unsigned int(1) pcc_gof_header_flag;
  unsigned int(1) geometry_image_d0_flag;
  unsigned int(1) geometry_image_d1_lag;
  unsigned int(1) texture_image_flag;
  unsigned int(1) occupancy_map_flag;
  unsigned int(1) auxiliary_patch_info_flag;
  unsigned int(2) reserved = 0;
  if (pcc_header_flag == 1) {
    PccHeaderBox pcc_header_box;
  }
  Box[] any_box; // optional
}
```

pcc_gof_header_flag according to the embodiments: may indicate whether the current track includes a PCC GOF header. When the value of the flag is 1, the corresponding data may be included in the PccVideoBox in the form of a PccGofHeader box. When the value of the flag is 0, the current track does not include the PCC GOF header.

geometry_image_d0_flag according to the embodiments: may indicate whether the current track includes a geometry image of a near layer. When the value of the flag is 1, the track may include a geometry image of a near layer in the form of media data of the current track. When the value of the flag is 0, the geometry image data of the near layer is not included in the current track.

geometry_image_d1_flag according to the embodiments: may indicate whether the current track includes a geometry image of a far layer. When the value of the flag is 1, a geometry image of the far layer may be included in the form of media data of the current track. When the value of the flag is 0, the geometry image data of the far layer is not included in the current track.

texture_image_flag according to the embodiments: may indicate whether the current track includes a texture image. When the value of the flag is 1, the texture image may be included in the form of media data of the current track. When the value of the flag is 0, the texture image data is not included in the current track.

occupancy_map_flag according to the embodiments: may indicate whether the current track includes an occupancy map. When the value of the flag is 1, occupancy map data is included in the current track. When the value of the flag is 0, the occupancy map data is not included in the current track.

auxiliary_patch_info_flag according to the embodiments: may indicate whether the current track includes auxiliary patch information. When the value of the flag is 1, the auxiliary track information data is included in the current track. When the value of the flag is 0, the auxiliary track information data is not included in the current track.

As described above, when the PCC GOF header is included, the box according to the embodiments is configured as follows.

Regarding the PCC GOF Header Box according to the embodiments, the PccGofHeaderBox may include parameters indicating coding characteristics of PCC Group of Frames (GoF).

Box Type: ‘pghd′

| | |
|---|---|
| Container: | PccVideoBox |
| Mandatory: | No |
| Quantity: | Zero or one |

```
  aligned(8) class PccGofHeaderBox extends FullBox(‘pghd′, version = 0,
0) {
  unsigned int(8) group_of_frames_size;
  unsigned int(16)frame_width;
  unsigned int(16)frame_height;
  unsigned int(8) occupancy_resolution;
  unsigned int(8) radius_to_smoothing;
  unsigned int(8) neighbor_count_smoothing;
  unsigned int(8) radius2_boundary_detection;
  unsigned int(8) threshold_smoothing;
  unsigned int(8) lossless_geometry;
  unsigned int(8) lossless_texture;
  unsigned int(8) no_attributes;
  unsigned int(8) lossless_geometry_444;
  unsigned int(8) absolute_d1_coding;
  unsigned int(8) binary_arithmetic_coding;
  }
```

group_of_frames_size according to the embodiments indicates the number of frames in the current group of frames.

frame_width according to the embodiments indicates the frame width, in pixels, of the geometry and texture videos. It shall be multiple of occupancyResolution.

frame_height according to the embodiments indicates the frame height, in pixels, of the geometry and texture videos. It shall be multiple of occupancyResolution.

occupancy_resolution according to the embodiments: indicates the horizontal and vertical resolution, in pixels, at which patches are packed in the geometry and texture videos. It shall be an even value multiple of occupancyPrecision.

radius_to_smoothing according to the embodiments indicates the radius to detect neighbours for smoothing. The value of radius_to_smoothing shall be in the range of 0 to 255, inclusive.

neighbor_count_smoothing according to the embodiments indicates the maximum number of neighours used for smoothing. The value of neighbor_count_smoothing shall be in the range of 0 to 255, inclusive.

radius2_boundary_detection according to the embodiments indicates the radius for boundary point detection. The value of radius2_boundary_detection shall be in the range of 0 to 255, inclusive.

threshold_smoothing according to the embodiments indicates the smoothing threshold. The value of threshold_smoothing shall be in the range of 0 to 255, inclusive.

lossless_geometry according to the embodiments indicates lossless geometry coding. The value of lossless_geometry equal to 1 indicates that point cloud geometry information is coded losslessly. The value of lossless_geometry equal to 0 indicates that point cloud geometry information is coded in a lossy manner.

lossless_texture according to the embodiments indicates lossless texture encoding. The value of lossless_texture equal to 1 indicates that point cloud texture information is coded losslessly. The value of lossless_texture equal to 0 indicates that point cloud texture information is coded in a lossy manner.

no_attributes according to the embodiments indicates whether attributes are coded along with geometry data. The value of no_attributes equal to 1 indicates that the coded point cloud bitstream does not contain any attributes information. The value of no_attributes equal to 0 indicates that the coded point cloud bitstream contains attributes information.

lossless_geometry_444 according to the embodiments indicates whether to use 4:2:0 or 4:4:4 video format for geometry frames. The value of lossless_geometry_444 equal to 1 indicates that the geometry video is coded in 4:4:4 format. The value of lossless_geometry_444 equal to 0 indicates that the geometry video is coded in 4:2:0 format.

absolute_d1_coding according to the embodiments indicates how the geometry layers other than the layer nearest to the projection plane are coded. absolute_d1_coding equal to 1 indicates that the actual geometry values are coded for the geometry layers other than the layer nearest to the projection plane. absolute d1 coding equal to 0 indicates that the geometry layers other than the layer nearest to the projection plane are coded differentially.

bin_arithmetic_coding according to the embodiments indicates whether binary arithmetic coding is used. The value of bin_arithmetic_coding equal to 1 indicates that binary arithmetic coding is used for all the syntax elements. The value of bin_arithmetic_coding equal to 0 indicates that non-binary arithmetic coding is used for some syntax elements.

The PCC file according to the embodiments may include a PCC auxiliary patch information timed metadata track. The PCC auxiliary patch information timed metadata track may include PccAuxiliaryPatchInfoSampleEntry( ). PccAuxiliaryPatchInfoSampleEntry may be identified by a ‘papi’ type value, and may include static PCC auxiliary patch information in the entry. An individual sample of media data (‘mdat’) of the PCC auxiliary patch information timed metadata track may be configured as PccAuxiliaryPatchInfoSample( ), and may include PCC auxiliary patch information, which dynamically changes, in the sample.

```
  class PccAuxiliaryPatchInfoSampleEntry() extends
MetaDataSampleEntry (‘papi′) {
}
  class PccAuxiliaryPatchInfoSample() {
  unsigned int(32)  patch_count;
  unsigned int(8) occupancy_precision;
  unsigned int(8) max_candidate_count;
  unsigned int(2) byte_count_u0;
  unsigned int(2) byte_count_v0;
  unsigned int(2) byte_count_u1;
  unsigned int(2) byte_count_v1;
  unsigned int(2) byte_count_d1;
  unsigned int(2) byte_count_delta_size_u0;
  unsigned int(2) byte_count_delta_size_v0;
  unsigned int(2) reserved = 0;
  for(i=0; i<patch_count; i++) {
    unsigned int(byte_count_u0 * 8) patch_u0;
    unsigned int(byte_count_v0 * 8) patch_v0;
    unsigned int(byte_count_u1 * 8) patch_u1 ;
    unsigned int(byte_count_v1 * 8) patch_v1;
    unsigned int(byte_count_d1 * 8) patch_d1;
    unsigned int(byte_count_delta_size_u0 * 8)   delta_size_u0;
    unsigned int(byte_count_delta_size_v0 * 8)   delta_size_v0;
    unsigned int(2)   normal_axis.
    unsigned int(6)   reserved = 0;
}
unsinged int(1) candidate_index_flag;
unsigned int(1) patch_index_flag;
unsigned int(3) byte_count_candidate_index;
unsigned int(3) byte_count_patch_index;
if(candidate_index_flag == 1) {
    unsigned int(byte_count_candidate_index * 8)   candidate_index;
}
if(patch_index_flag == 1) {
    unsigned int(byte_count_candidate_index * 8)   patch_index;
}
}
```

patch_count according to the embodiments is the number of patches in the geometry and texture videos. It shall be larger than 0.

occupancy_precision according to the embodiments is the horizontal and vertical resolution, in pixels, of the occupancy map precision. This corresponds to the sub-block size for which occupancy is signaled. To achieve lossless coding of occupancy map, this should be set to size 1.

max_candidate_count according to the embodiments specifies the maximum number of candidates in the patch candidate list.

byte_count_u0 according to the embodiments specifies the number of bytes for fixed-length coding of patch_u0.

byte_count_v0 according to the embodiments specifies the number of bytes for fixed-length coding of patch_v0.

byte_count_u1 according to the embodiments specifies the number of bytes for fixed-length coding of patch_u1.

byte_count_v1 according to the embodiments specifies the number of bytes for fixed-length coding of patch_v1.

byte_count_d1 according to the embodiments specifies the number of bytes for fixed-length coding of patch_d1.

byte_count_delta_size_u0 according to embodiments specifies the number of bytes for fixed-length coding of delta_size_u0.

byte_count_delta_size_v0 according to the embodiments specifies the number of bytes for fixed-length coding of delta_size_v0.

patch-u0 according to the embodiments specifies the x-coordinate of the top-left corner subblock of size occupancy_resolution×occupancy_resolution of the patch bounding box. The value of patch_u0 shall be in the range of 0 to frame_width/occupancy_resolution−1, inclusive.

patch-v0 according to the embodiments specifies the y-coordinate of the top-left corner subblock of size occupancy_resolution×occupancy_resolution of the patch bounding box. The value of patch_v0 shall be in the range of 0 to frame_height/occupancy_resolution−1, inclusive.

patch_u1 according to the embodiments specifies the minimum x-coordinate of the 3D bounding box of patch points. The value of patch_u1 shall be in the range of 0 to frame width−1, inclusive.

patch_v1 according to the embodiments is the minimum y-coordinate of the 3D bounding box of patch points. The value of patch_v1 shall be in the range of 0 to frameHeight−1, inclusive.

patch_d1 according to the embodiments specifies the minimum depth of the patch.

delta_size_u0 according to the embodiments is the difference of patch width between the current patch and the previous one.

delta_size_v0 according to the embodiments is the difference of patch height between the current patch and the previous one.

normal_axis according to the embodiments specifies the plane projection index. The value of normal_axis shall be in the range of 0 to 2, inclusive. normalAxis values of 0, 1, and 2 correspond to the X, Y, and Z projection axes, respectively.

candidate_index_flag according to the embodiments specifies whether candidate_index is present or not.

patch_index_flag according to the embodiments specifies whether patch_index is present or not.

byte_count_candidate_index according to the embodiments specifies the number of bytes for fixed-length coding of candidate_index.

byte_count_patch_index according to the embodiments specifies the number of bytes for fixed-length coding of patch_index.

candidate_index according to the embodiments is the index into the patch candidate list. The value of candidate_index shall be in the range of 0 to max_candidate_count, inclusive.

patch_index according to the embodiments is an index to a sorted patch list, in descending size order, associated with a frame.

The PCC file according to the embodiments includes a PCC occupancy map timed metadata track. The PCC occupancy map timed metadata track may include PccOccupancyMapSampleEntry( ). PccOccupancyMapSampleEntry may be identified by a ‘papi’ type value, and may include static PCC occupancy map data in the entry. An individual sample of media data (‘mdat’) of the PCC occupancy map timed metadata track may be configured as PccOccupancyMapSample ( ), and may include PCC occupancy map data, which dynamically changes, in the sample.

```
  class PccOccupancyMapSampleEntry() extends MetaDataSampleEntry
(‘popm′) {
}
  class PccOccupancyMapSample() {
  unsigned int(32)   block_count;
  for( i = 0; i < block count; i++ ) {
    unsigned int(1) empty_block_frag;
    unsigned int(7) reserved = 0;
    if(empty_block_frag == 1) {
      unsigned int(1) is_full;
      unsigned int(7) reserved = 0;
        if(is_full == 0) {
          unsinged int(2) best_traversal_order_index;
          unsigned int(6) reserved = 0;
          unsinged int(16) run_count_prefix;
          if (run_count_prefix > 0) {
            unsigned int(16)run count suffix;
          }
          unsigned int(1) occupancy;
          unsigned int(7) reserved = 0;
          for( j = 0; j <= runCountMinusTwo+1; j++ ) {
            unsigned int(16)run_length_idx;
          }
        }
      }
    }
}
}
```

block_count according to the embodiments specifies the number of occupancy blocks.

empty_block_flag according to the embodiments specifies whether the current occupancy block of size occupancy_resolution×occupancy_resolution block is empty or not. empty block_flag equal to 0 specifies that the current occupancy block is empty.

is_full according to the embodiments specifies whether the current occupancy block of size occupancy_resolution×occupancy_resolution block is full. is_full equal to 1 specifies that the current block is full. is_full equal to 0 specifies that the current occupancy block is not full.

best_traversal_order_index according to the embodiments specifies the scan order for sub-blocks of size occupancy_precision×occupancy_precision in the current occupancy_resolution×occupancy_resolution block. The value of best_traversal_order_index shall be in the range of 0 to 4, inclusive.

run_count_prefix according to the embodiments may be used in the derivation of variable runCountMinusTwo.

run_count_suffix according to the embodiments may be used in the derivation of variable runCountMinusTwo. When not present, the value of run_count_suffix is inferred to be equal to 0.

When the value of blockToPatch for a particular block is not equal to zero and the block is not full, runCountMinusTwo plus 2 represents the number of signaled runs for a block. The value of runCountMinusTwo shall be in the range of 0 to (occupancy_resolution*occupancy_resolution)−1, inclusive.

runCountMinusTwo according to the embodiments may be expressed as follows:

runCountMinusTwo=(1<<run_count_prefix)−1+run_count_suffix

Occupancy specifies the occupancy value for the first sub-block (of occupancyPrecision×occupancyPrecision pixels). Occupancy equal to 0 specifies that the first sub-block is empty. occupancy equal to 1 specifies that the first sub-block is occupied.

run_length_idx according to the embodiments is indication of the run length. The value of runLengthIdx shall be in the range of 0 to 14, inclusive.

Multiplexing according to embodiments multiplexes four data into a file. In relation to the file according to the embodiments, each bitstream of a plurality of bitstreams may be included in multiple tracks, and a plurality of bitstreams may be included in a single track. The multiple tracks/single track according to the embodiments will be described later.

In multiplexing of a point cloud data transmission method according to embodiments, the geometry image, the texture image, the occupancy map, and the auxiliary patch information may be multiplexed into a file type or a NALU type.

In multiplexing of a point cloud data transmission method according to embodiments, the geometry image, the texture image, the occupancy map, and the auxiliary patch information into a file type, wherein the type may include multiple tracks.

The multiple tracks of the point cloud data transmission method according to the embodiments may include a first track including the geometry image, a second track including the texture image, and a third track including the occupancy map and the auxiliary patch information. According to embodiments, the terms first and second are interpreted as expressions used to distinguish and/or refer to the corresponding tracks.

The first track, the second track, and the third track of the point cloud data transmission method according to the embodiments may include a video group box. The video group box may include a header box, wherein the header box may indicate whether point cloud-related data is included.

In multiplexing of the point cloud data transmission method according to embodiments, the geometry image, the texture image, and the occupancy map may be multiplexed into a file.

The file of the point cloud data transmission method according to the embodiments may include multiple PCC tracks.

The multiple tracks of the point cloud data transmission method according to the embodiments may include a first track including the geometry image, a second track including the texture image, and a third track including the occupancy map.

The file of the point cloud data transmission method according to the embodiments may include a group box. The group box may include information indicating at least one of the first track, the second track, and the third track.

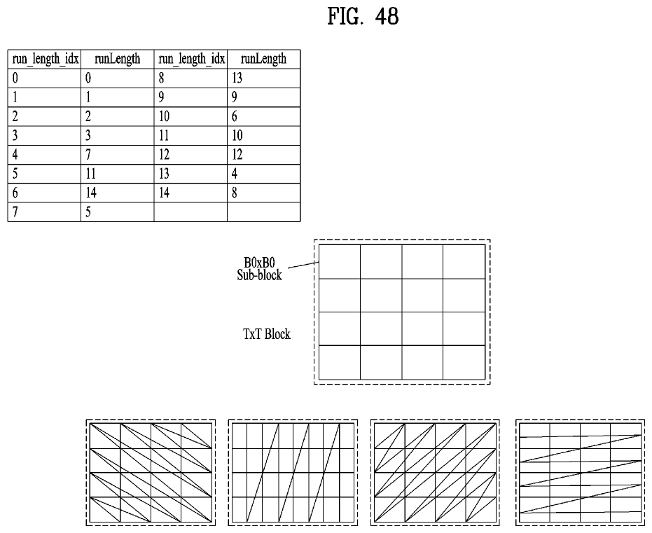

FIG. 48 illustrates an example of runLength and best_traversal_order_index according to embodiments.

For example, embodiments may use a coding scheme that determines presence or absence of pixels on a 4 by 4 block. Specifically, embodiments may use a zigzag scan method to scan the pixels to determine the number of is and the number of Os. Furthermore, embodiments may use a scan method that reduces the number of runs based on a particular direction. This method may increase the efficiency of run coding. The table in the figure shows a run length according to the run length index.

A PCC track grouping-related track/file according to the embodiments includes the following information. Geometry image D0/D1 tracks, a texture image track, and occupancy map/auxiliary patch information tracks, which contain data constituting the PCC, may include the following PccVideoGroupBox, which may indicate necessary tracks for one PCC content. PccTrackGroupBox may include PccHeaderBox described above. Tracks belonging to one PCC track group include PccTrackGroupBox having the same track_group_type (=‘pctg’) and the same track_group_id value. In the same PCC track group, there may be a constraint that only one geometry image D0/D1 track, one texture image track, and one occupancy map/auxiliary patch information track should be present. PCC track grouping according to embodiments may be delivered through multiple PCC tracks.

class PccTrackGroupBox() extends TrackGroupTypeBox (‘pctg′) {
PccHeaderBox pcc_header_box; // optional
}

If there is data other than the PCC data in one file, for example, 2D data, etc., the decoder may efficiently identify the PCC data using the above-described embodiments. When the demultiplexer according to embodiments acquires pcc_header_box based on PCC track grouping on multiple PCC tracks, the decoder may efficiently decode the PCC data required by the decoder without latency and decoder complexity.

Due to the PCC track grouping according to the embodiments, the file parser (demultiplexer) of the receiver may quickly filter data necessary for PCC content reproduction using this information. For example, when 4 tracks of geometry, image, occupancy map, and auxiliary patch information for PCC and contents other than PCC, such as a 2D video track, coexist in one file, only the 4 tracks required for PCC content reproduction may be quickly filtered using this information. In addition, using this information, the receiver may calculate resources necessary for processing of the filtered tracks. Thus, the PCC content may be reproduced using only the minimum resources (memory, decoder instance, etc.) for PCC content reproduction.

The decoder may identify the grouped tracks based on PCC track grouping box information according to embodiments, for example, track_group_type and/or track_group_id, and quickly filter point cloud data included in the tracks.

The PCC geometry track referencing-related track/file according to the embodiments includes the following information. When there is a geometry image D0 track and a geometry image D1 track that constitute PCC, and there is coding dependency between the geometry image D0 and D1 layers included in the two tracks (e.g., D0 is intra-coded, and D1 is coded as a differential image with respect to D0), dependency between the two tracks may be expressed through TrackReferenceBox. To this end, new ‘pgdp’ (PCC geometry image dependency) referemce_type may be defined. For example, the D1 track may include TrackReferenceTypeBox of ‘pgdp’ reference type and include the track_ID value of the D0 track in Track_IDs[ ]. In the same way, reference type such as the existing ‘sbas’ may be used instead of ‘pgdp’. PCC geometry track referencing according to embodiments may be delivered through multiple PCC tracks.

```
  aligned(8) class TrackReferenceBox extends Box(′tref′) {
  TrackReferenceTypeBox [];
}
  aligned(8) class TrackReferenceTypeBox (unsigned int(32)
reference_type) extends Box(reference_type) {
  unsigned int(32) track_IDs[];
}
```

The SchemeType related track/file for the PCC tracks according to the embodiments includes the following information. When the PCC frame is decoded, the decoded PCC frame may include data such as a geometry image, a texture image, an occupancy map, and auxiliary patch information of one or two layers. All of these data may be included in one PCC video track, and the point cloud may be reconstructed by performing post-processing based on the data. As such, the track including all the PCC data may be identified through, for example, the ‘pccs’ value of scheme type present in SchemeTypeBox. (Another scheme type may be defined so as to be distinguished from ‘pccv’ described above, in which PCC data are divided into multiple tracks.) SchemeType for a PCC track according to embodiments is delivered by a single PCC track.

```
  aligned(8) class SchemeTypeBox extends FullBox(′schm′, 0, flags) {
  unsigned int(32) scheme_type;
  unsigned int(32) scheme_version;
  if (flags & 0x000001) {
    unsigned int(8) scheme_uri[];
  }
}
```

The PCC Video Box according to the embodiments includes the following information.

A PCC track containing PCC data may have PccVideoBox. When SchemeType is ‘pccv’, PccVideoBox may be positioned under SchemeInformationBox. Alternatively, it may be positioned under VisualSampleEntry regardless of SchemeType. PccVideoBox may directly contain PCC GOF header data. The PCC Video Box according to the embodiments may be delivered by a single PCC track.

Box Type: ‘pccs′

| | |
|---|---|
| Container: | SchemeInformationBox or VisualSampleEntry |
| Mandatory: | Yes (when the SchemeType is ‘pccs′) |
| Quantity: | One |

```
  aligned(8) class PccVideoBox extends FullBox(‘pccs′, version = 0,0) {
  PccHeaderBox pcc_header_box;   // optional
  Box[] any box; // optional
}
```

A method for distinguishing PCC data in a single track using sub-samples according to embodiments may be implemented based on the following information. When PCC data are present in one track, media samples of the track may be divided into multiple sub-samples. Each sub-sample may correspond to PCC data such as a geometry image (D0/D1), a texture image, an occupancy map, or auxiliary patch information. To describe the mapping relationship between the sub-samples and the PCC data, codec_specific_parameters of SubSampleInformationBox may be defined as follows.

```
  aligned(8) class Sub SampleInformationBox extends FullBox(′subs′,
version, flags) {
  unsigned int(32) entry_count;
  for (i=0; i < entry_count; i++) {
    unsigned int(32) sample_delta;
    unsigned int(16) subsample_count;
    if (subsample_count > 0) {
      for (j=0; j < subsample_count; j++) {
        if(version == 1)  {
          unsigned int(32) subsample_size;
        }
        else  {
          unsigned int(16) subsample_size;
        }
        unsigned int(8) subsample_priority;
        unsigned int(8) discardable;
        unsigned int(32) codec_specific_parameters;
      }
    }
  }
}
  unsigned int(3) pcc_data_type;
  bit(29) reserved = 0;
```

pcc_data_type according to the embodiments indicates the type of PCC data included in a sub-sample. For example, pcc_data_type set to 0 indicates that geometry image D0 is included in the sub-sample. pcc_data_type set to 1 indicates that geometry image D1 is included in the sub-sample. pcc_data_type set to 2 indicates that the texture image is included in the sub-sample. pcc_data_type set to 3 indicates that the occupancy map is included in the sub-sample. pcc_data_type set to 4 indicates that the auxiliary patch information is included in the sub-sample.

The single PCC track according to embodiments may include a sample including each of geometry, texture, occupancy, and an auxiliary map, and one sample may include a plurality of samples. The samples may be distinguished using sub-samples according to embodiments. The sub-samples according to the embodiments may include geometry and texture.

The sample, sample grouping and/or sub-sample schemes according to the embodiments may be applied to geometry, texture video, occupancy maps, auxiliary patch information, and the like.

A method for distinguishing the PCC data using sample grouping according to embodiments may be implemented based on the following information. When PCC data are present in one track, media samples of the track may include one of PCC data such as a geometry image D0/D1, a texture image, an occupancy map, and auxiliary patch information. To identify that a sample is one of multiple PCC data, the following sample group boxes may be used. Each box may be linked to specific samples and used in identifying the PCC data corresponding to the samples. Sample grouping according to the embodiments may be transmitted by a single PCC track.

class PccGeometryDOImageGroupEntry extends VisualSampleGroupEntry(‘pd0g’) { }

class PccGeometryDlImageGroupEntry extends VisualSampleGroupEntry(‘pd1g’) { }

class PccTexturelmageGroupEntry extends Visual SampleGroupEntry(‘pteg’) { }

class PccOccupancyMapGroupEntry extends Visual SampleGroupEntry(‘pomg’) { }

class PccAuxiliaryPatchInfoGroupEntry extends VisualSampleGroupEntry(‘papg’) { }

VisualSampleGroupEntry according to the embodiments may be extended to an entry indicating type information about each of PccGeometryDO, PccGeometryDl, PccTexture, PccOccupancyMap, and PccAuxiliaryPatchInfo. Thus, the decoder according to embodiments may be informed of the data transmitted by a sample.

Hereinafter, a method of classifying metadata according to embodiments in detail will be described.

The occupancy map, auxiliary patch information, geometry image, and texture image may be provided using sample auxiliary information according to embodiments, based on the following information. Sample auxiliary information according to the embodiments may be delivered by a single PCC track. When PCC data are present in one track, media samples of the track may include one of PCC data such as a geometry image D0/D1, a texture image, an occupancy map, and auxiliary patch information. Alternatively, one or more different types of PCC data may be included in the media sample using the sub-sample proposed above. PCC data not included in the media sample may be set as sample auxiliary information and linked with the sample. The sample auxiliary information may be stored in the same file as the sample. To describe the size and offset of the data, SampleAuxiliaryInformationSizesBox and SampleAuxiliaryInformationOffsetsBox may be used. To identify the PCC data included in the sample auxiliary information, aux_info_type and aux_info_type_parameter may be defined as follows.

aux_info type according to the embodiments: may indicate that PCC data is included in the sample auxiliary information when it is ‘pccd’.

aux_info_type_parameter according to the embodiments: When aux_info_type is ‘pccd’, this field may be defined as follows: unsigned int(3) pcc_data_type; bit(29) reserved=0.

pcc_data_type according to the embodiments indicates the type of PCC data included in the sample auxiliary information. For example, pcc_data_type set to 0 may indicate that an occupancy map is included in the sample auxiliary information. pcc_data_type set to 1 indicates that auxiliary patch information is included in the sample auxiliary information. pcc_data_type set to 2 indicates that geometry image D1 is included in the sample auxiliary information. pcc_data_type set to 3 indicates that geometry image D0 is included in the sample auxiliary information. pcc_data_type set to 4 indicates that a texture image is included in the sample auxiliary information.

```
  aligned(8) class SampleAuxiliaryInformationSizesBox extends
FullBox(′saiz′, version = 0, flags)
{
  if (flags & 1) {
    unsigned int(32) aux_info_type;
    unsigned int(32) aux info type_parameter;
  }
  unsigned int(8) default_sample_info_size;
  unsigned int(32) sample_count;
  if (default_sample_info_size == 0) {
    unsigned int(8) sample_info_size[ sample_count ];
  }
}
  aligned(8) class SampleAuxiliaryInformationOffsetsBox extends
FullBox(′saio′, version, flags) {
  if (flags & 1) {
    unsigned int(32) aux_info_type;
    unsigned int(32) aux_info_type_parameter;
  }
  unsigned int(32) entry_count;
  if( version == 0) {
    unsigned int(32) offset[ entry_count];
  }
  else {
    unsigned int(64) offset[ entry_count];
  }
}
```

The signaling information according to the embodiments is not limited by the name and may be interpreted based on the function/effect of the signaling information.

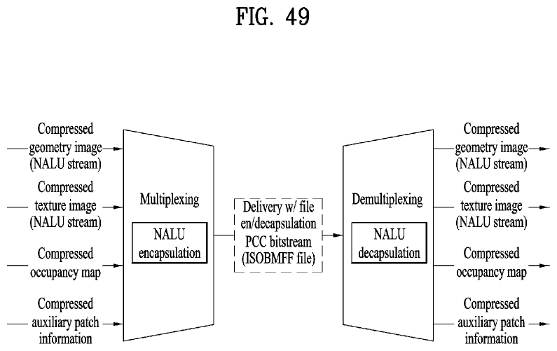

FIG. 49 illustrates NALU stream based multiplexing/demultiplexing according to embodiments.

In multiplexing according to the embodiments, a geometry image (NALU stream), a texture image (NALU stream), an occupancy map and/or auxiliary patch information are multiplexed. The multiplexing according to the embodiments may include NALU based encapsulation.

In delivery according to the embodiments, multiplexed data is transmitted. In the delivery according to the embodiments, a PCC bitstream including the geometry image (NALU stream), texture image (NALU stream), occupancy map and/or auxiliary patch information are delivered based on the ISOBMFF file.

In demultiplexing according to the embodiments, the geometry image (NALU stream), texture image (NALU stream), occupancy map and/or auxiliary patch information are demultiplexed. The demultiplexing according to the embodiments may include NALU based decapsulation.

Details of the NALU stream based multiplexing/demultiplexing according to the embodiments are described below.

The geometry/texture image according to the embodiments may distinguish between D0, D1, texture, and the like using Nuh_layer_id. Embodiments of PCC signaling for each layer are proposed (e.g., new SEI message, adding information to the VPS)

Regarding the occupancy map/auxiliary patch information according to the embodiments, an SEI message according to embodiments is proposed.

In connection with the PCC GOF header according to the embodiments, an SEI message according to the embodiments is proposed.

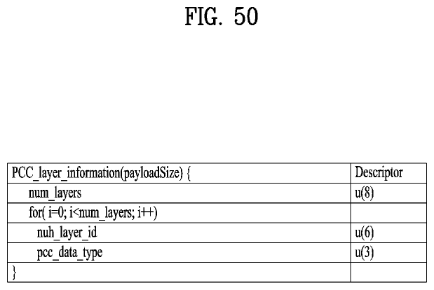

FIG. 50 illustrates PCC layer information according to embodiments.

Regarding the PCC layer information SEI message according to the embodiments, the PCC layer information SEI may be configured as follows. The NAL unit stream may be composed of various layers distinguished by nuh_layer_id of nal_unit_header( ). In order to configure PCC data in one NAL unit stream, each of several types of PCC data may be configured in one layer. The PCC layer information SEI serves to identify PCC data mapping information for each layer.

num_layers according to the embodiments: may specifiy the number of layers included in a NAL unit stream.

nuh_layer_id according to the embodiments: a unique identifier assigned to each layer. It has the same meaning as nuh_layer_id of nal_unit_header( ).

pcc_data_type according to the embodiments: indicates a type of PCC data included in a corresponding layer. For example, pcc_data_type set to 0 may indicate that an occupancy map is included in the sample auxiliary information. pcc_data_type set to 1 may indicate that auxiliary patch information is included in the sample auxiliary information. pcc_data_type set to 2 may indicate that geometry image D1 is included in the sample auxiliary information. pcc_data_type set to 3 may indicate that geometry image D0 is included in the sample auxiliary information. pcc_data_type set to 4 may indicate that a texture image is included in the sample auxiliary information.

Metadata according to the embodiments described below may indicate pcc_data_type for each nuh_layer_id according to the embodiments.

With the metadata according to nuh_layer_id and nuh layer_id, PCC data may be represented, and the geometry and texture may be efficiently distinguished from each other.

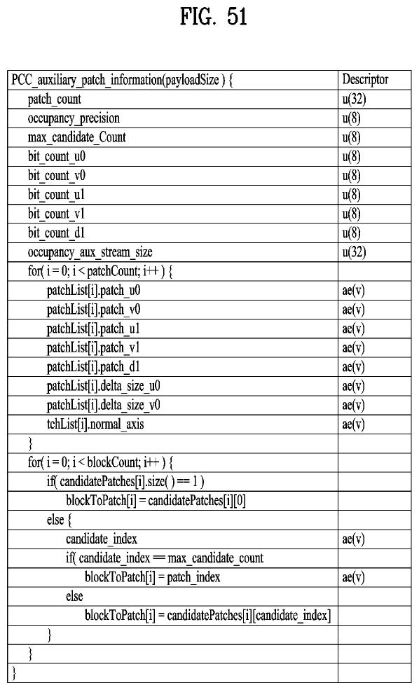

FIG. 51 illustrates PCC auxiliary patch information according to embodiments.

Regarding the PCC auxiliary patch information SEI message according to the embodiments, the PCC auxiliary patch information SEI message may be configured as follows. The meaning of each field is similar to the meaning in the PCC auxiliary patch information timed metadata described above. The PCC auxiliary patch information SEI message may serve to provide auxiliary patch information metadata to a geometry image, a texture image, and the like transmitted through the VCL NAL unit and may change dynamically over time. The content of the current SEI message is valid only until the next SEI message of the same type is interpreted. Thereby, the metadata may be dynamically applied.

patch_count according to the embodiments is the number of patches in the geometry and texture videos. It shall be larger than 0.

occupancy_precision according to the embodiments is the horizontal and vertical resolution, in pixels, of the occupancy map precision. This corresponds to the sub-block size for which occupancy is signaled. To achieve lossless coding of occupancy map, this should be set to size 1.

max_candidate_count according to the embodiments specifies the maximum number of candidates in the patch candidate list.

byte_count_u0 according to the embodiments specifies the number of bytes for fixed-length coding of patch_u0.

byte_count_v0 according to the embodiments specifies the number of bytes for fixed-length coding of patch_v0.

byte_count_u1 according to the embodiments specifies the number of bytes for fixed-length coding of patch_u1.

byte_count_v1 according to the embodiments specifies the number of bytes for fixed-length coding of patch_v1.

byte_count_d1 according to the embodiments specifies the number of bytes for fixed-length coding of patch_d1.

byte_count_delta_size_u0 according to the embodiments specifies the number of bytes for fixed-length coding of delta_size_u0.

byte_count_delta_size_v0 according to the embodiments specifies the number of bytes for fixed-length coding of delta_size_v0.

patch-u0 according to the embodiments specifies the x-coordinate of the top-left corner subblock of size occupancy_resolution×occupancy_resolution of the patch bounding box. The value of patch_u0 shall be in the range of 0 to frame_width/occupancy_resolution−1, inclusive.

patch-v0 according to the embodiments specifies the y-coordinate of the top-left corner subblock of size occupancy_resolution×occupancy_resolution of the patch bounding box. The value of patch_v0 shall be in the range of 0 to frame_height/occupancy_resolution−1, inclusive.

patch_u1 according to the embodiments specifies the minimum x-coordinate of the 3D bounding box of patch points. The value of patch_u1 shall be in the range of 0 to frame width−1, inclusive.

patch_v1 according to the embodiments is the minimum y-coordinate of the 3D bounding box of patch points. The value of patch_v1 shall be in the range of 0 to frameHeight−1, inclusive.

patch_d1 according to the embodiments specifies the minimum depth of the patch.)

delta_size_u0 according to the embodiments is the difference of patch width between the current patch and the previous one.

delta_size_v0 according to the embodiments is the difference of patch height between the current patch and the previous one.

nrmal_axis according to the embodiments specifies the plane projection index. The value of normal_axis shall be in the range of 0 to 2, inclusive. normalAxis values of 0, 1, and 2 correspond to the X, Y, and Z projection axes, respectively.

candidate_index_flag according to the embodiments specifies whether candidate_index is present or not.

patch_index_flag according to the embodiments specifies whether patch_index is present or not.

byte_count_candidate_index according to the embodiments specifies the number of bytes for fixed-length coding of candidate_index.

byte_count_patch_index according to the embodiments specifies the number of bytes for fixed-length coding of patch_index.

candidate_index according to the embodiment is the index to the patch candidate list. The value of candidate_index shall be in the range of 0 to max_candidate_count, inclusive.

patch_index according to the embodiments is an index to a sorted patch list, in descending size order, associated with a frame.

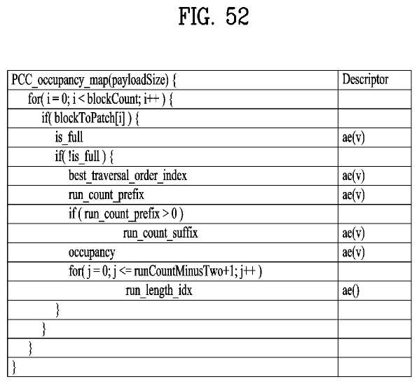

FIG. 52 shows a PCC occupancy map according to embodiments.

Regarding the PCC occupancy map SEI message according to the embodiments, the PCC occupancy map SEI message may be configured as follows. The meaning of each field is similar to the meaning in the PCC auxiliary patch information timed metadata described above. The PCC auxiliary patch information SEI message may serve to provide occupancy map data to a geometry image, a texture image, and the like transmitted through the VCL NAL unit and may change dynamically over time. The current SEI message content is valid only until the next SEI message of the same type is interpreted. Thereby, the metadata may be dynamically applied.

is_full according to the embodiments specifies whether the current occupancy block of size occupancy_resolution×occupancy_resolution block is full. is_full equal to 1 specifies that the current block is full. is_full equal to 0 specifies that the current occupancy block is not full.

best_traversal_order_index according to the embodiments specifies the scan order for sub-blocks of size occupancy_precision×occupancy_precision in the current occupancy_resolution×occupancy_resolution block. The value of best_traversal_order_index shall be in the range of 0 to 4, inclusive.

run_count_prefix according to the embodiments is used in the derivation of variable runCountMinusTwo.

run_count_suffix according to the embodiments is used in the derivation of variable runCountMinusTwo. When not present, the value of run_count_suffix is inferred to be equal to 0.

When the value of blockToPatch for a particular block is not equal to zero and the block is not full, runCountMinusTwo plus 2 represents the number of signaled runs for a block. The value of runCountMinusTwo shall be in the range of 0 to (occupancy_resolution*occupancy_resolution)−1, inclusive.

runCountMinusTwo according to the embodiments may be expressed as follows:

runCountMinusTwo=(1<<run_count_prefix)−1+run_count_suffix

occupancy specifies the occupancy value for the first sub-block (of occupancyPrecision×occupancyPrecision pixels). occupancy equal to 0 specifies that the first sub-block is empty. occupancy equal to 1 specifies that the first sub-block is occupied.

run_length_idx according to the embodiments is indication of the run length. The value of runLengthIdx shall be in the range of 0 to 14, inclusive.

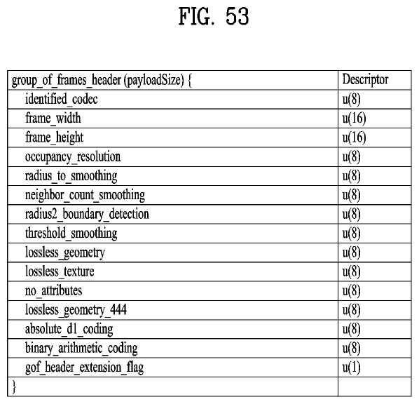

FIG. 53 shows a PCC group of frames header according to embodiments.

Regarding the PCC group of frames header SEI message according to the embodiments, the PCC group of frames header SEI message may be configured as follows. The meaning of each field is similar to the meaning in GofHeaderBox. The PCC group of frames header SEI message may serve to provide header data to a geometry image and a texture image transmitted through the VCL NAL unit, and an occupancy map and patch auxiliary information transmitted through the SEI message, and may change dynamically over time. The content of the current SEI message is valid only until the next SEI message of the same type is interpreted. Thereby, the metadata may be dynamically applied.

identified_codec according to the embodiments indicates a codec used for PCC data.

frame_width according to the embodiments indicates the frame width, in pixels, of the geometry and texture videos. It shall be multiple of occupancyResolution.

frame_height according to the embodiments indicates the frame height, in pixels, of the geometry and texture videos. It shall be multiple of occupancyResolution.

occupancy_resolution according to the embodiments indicates the horizontal and vertical resolution, in pixels, at which patches are packed in the geometry and texture videos. It shall be an even value multiple of occupancyPrecision.

radius_to_smoothing according to the embodiments indicates the radius to detect neighbours for smoothing. The value of radius_to_smoothing shall be in the range of 0 to 255, inclusive.

neighbor_count_smoothing according to the embodiments indicates the maximum number of neighours used for smoothing. The value of neighbor_count_smoothing shall be in the range of 0 to 255, inclusive.

radius2_boundary_detection according to the embodiments indicates the radius for boundary point detection. The value of radius2_boundary_detection shall be in the range of 0 to 255, inclusive.

threshold_smoothing according to the embodiments indicates the smoothing threshold. The value of threshold_smoothing shall be in the range of 0 to 255, inclusive.

lossless_geometry according to the embodiments indicates lossless geometry coding. The value of lossless_geometry equal to 1 indicates that point cloud geometry information is coded losslessly. The value of lossless_geometry equal to 0 indicates that point cloud geometry information is coded in a lossy manner.

lossless_texture according to the embodiments indicates lossless texture encoding. The value of lossless_texture equal to 1 indicates that point cloud texture information is coded losslessly. The value of lossless_texture equal to 0 indicates that point cloud texture information is coded in a lossy manner.

no_attributes according to the embodiments indicates whether attributes are coded along with geometry data. The value of no_attributes equal to 1 indicates that the coded point cloud bitstream does not contain any attributes information. The value of no_attributes equal to 0 indicates that the coded point cloud bitstream contains attributes information.

lossless_geometry_444 according to embodiments indicates whether to use 4:2:0 or 4:4:4 video format for geometry frames. The value of lossless_geometry_444 equal to 1 indicates that the geometry video is coded in 4:4:4 format. The value of lossless_geometry_444 equal to 0 indicates that the geometry video is coded in 4:2:0 format.

absolute_d1_coding according to the embodiments indicates how the geometry layers other than the layer nearest to the projection plane are coded. absolute_d1 coding equal to 1 indicates that the actual geometry values are coded for the geometry layers other than the layer nearest to the projection plane. absolute d1 coding equal to 0 indicates that the geometry layers other than the layer nearest to the projection plane are coded differentially.

bin_arithmetic_coding according to the embodiments indicates whether binary arithmetic coding is used. The value of bin_arithmetic_coding equal to 1 indicates that binary arithmetic coding is used for all the syntax elements. The value of bin_arithmetic_coding equal to 0 indicates that non-binary arithmetic coding is used for some syntax elements.

gof header_extension_flag according to the embodiments indicates whether there is a GOF header extension.

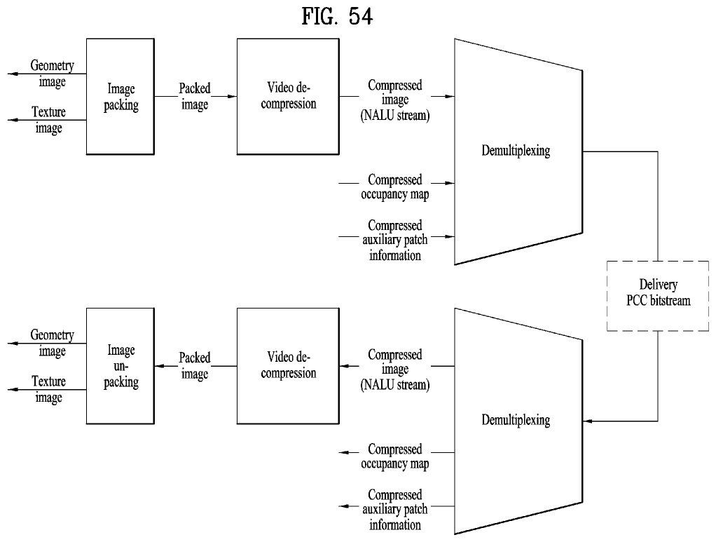

FIG. 54 illustrates geometry/texture image packing according to embodiments.

In image packing according to the embodiments, geometry and texture images may be packed into a packed image.

The image packing according to the embodiments may be similar to stereo frame packing. For example, it may be applied when only D0 and texture are present. In addition, a packing type (e.g., side-by-side) technique may be applied. In addition, the image packing according to the embodiments may be similar to the region-wise packing. For example, a source (D0, D1, or texture) may be mapped onto a destination (packed image), and the mapping relationship may be described through metadata.

In video compression according to the embodiments, the packed image may be compressed based on the NALU stream.

In multiplexing according to the embodiments, the compressed image, the compressed occupancy map, and the compressed auxiliary patch information may be multiplexed.

In delivery according to the embodiments, a PCC bitstream may be transmitted.

In demultiplexing according to the embodiments, the PCC bitstream may be demultiplexed to generate a compressed image, a compressed occupancy map, and compressed auxiliary patch information.

In video decompression according to the embodiments, the compressed image may be decompressed to generate the packed image.

In image unpacking according to the embodiments, the geometry image and the texture image may be generated from the packed image.

Image unpacking according to the embodiments may be similar to stereo frame packing. For example, it may be applied when only D0 and texture are present. In the image unpacking according to embodiments, a packing type (e.g., side-by-side) technique may be applied. Also, the image unpacking according to the embodiments may be similar to region-wise packing. For example, a source (D0, D1 or texture) may be mapped onto a destination (packed image) and the mapping relationship may be described.

The image packing according to the embodiments may packing the geometry image and/or texture image into one image, thereby providing efficiency in terms of latency and decoding complexity.

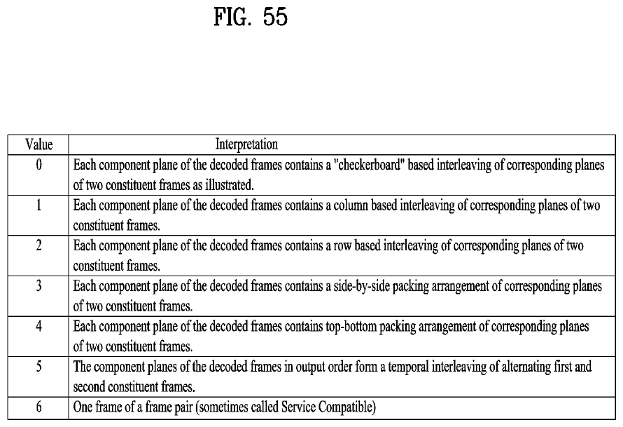

FIG. 55 illustrates a method of arranging geometry and image components according to embodiments.

Regarding the PCC frame packing according to the embodiments, the geometry image (e.g., D0 layer) and the texture image constituting the PCC may be disposed in one image frame sequence and decoded into one bitstream composed of one layer. In this case, PccFramePackingBox may indicate how to arrange the geometry and image components. The PCC frame packing according to embodiments may be applied to multiple PCC tracks.

aligned(8) class PccFramePackingBox extends FullBox(‘pccp’, version=0, 0) {

unsigned int(8) pcc frame_packing_type

}

pcc frame_packing_type according to the embodiments: may indicate a method of arranging geometry and image components by assigning a value as shown in the figure.

Regarding the PCC frame packing according to the embodiments, the geometry image (e.g., D0 layer) and the texture image constituting the PCC may be disposed in one image frame sequence and decoded into one bitstream composed of one layer. In this case, PccFramePackingBox given below may indicate how to arragne the geometry and image components.

```
  aligned(8) class PccFramePackingRegionBox extends FullBox(‘pccr′,
version = 0, 0) {
  unsigned int(16) packed_picture_width;
  unsigned int(16) packed_picture_height;
  unsigned int(8) num_sources;
  for(i = 0; i<num_sources; i++) {
    unsigned int(8) num_regions [i];
    unsigned int(2) source_picture_type[i]
    bit(6) reserved = 0;
    unsigned int(32) source_picture_width[i];
    unsigned int(32) source_picture_height[i];
    for (j = 0; j < num_regions; j++) {
      unsigned int(32) source_reg_width[i][j];
      unsigned int(32) source_reg_height[i][j];
      unsigned int(32) source_reg_top[i][j];
      unsigned int(32) source_reg_left[i][j];
      unsigned int(3) transform_type[i][j];
      bit(5) reserved = 0;
      unsigned int(16) packed_reg_width[i][j];
      unsigned int(16) packed_reg_height[i][j];
      unsigned int(16) packed_reg_top[i][j];
      unsigned int(16) packed_reg_left[i][j];
    }
}
}
```

packed_picture_width and packed_picture_height according to the embodiments specify the width and height, respectively, of the packed picture, in relative packed picture sample units. packed picture_width and packed_picture_height shall both be greater than 0.

num_sources according to the embodiments specifies the number of source pictures.

num_regions[i] according to the embodiments specifies the number of packed regions per each source picture.

num_sourece_picturetype[i] according to the embodiments specifies the type of source picture for PCC frames. The following values are specified: 0: geometry image D0,

1: geometry image D1, 2: texture image, 3: reserved.

source_picture_width[i] and source_picture_height[i] according to the embodiments specify the width and height, respectively, of the source picture, in relative source picture sample units. source picture_width[i] and sourcej_picture_height[i] shall both be greater than 0.

According to the embodiments, source_reg_width[i][j], source_reg_height[i][j], source_reg_top[i][j], and source_reg_left[i][j] specify the width, height, top offset, and left offset, respectively, of the j-th source region, either within the i-th source picture.

transform_type[i][j] according to the embodiments specifies the rotation and mirroring that is applied to the j-th packed region to remap it to the j-th projected region of the i-th source picture. When transform_type[i][j] specifies both rotation and mirroring, rotation is applied before mirroring for converting sample locations of a packed region to sample locations of a projected region. The following values are expressed: 0: no transform, 1: mirroring horizontally, 2: rotation by 180 degrees (counter-clockwise), 3: rotation by 180 degrees (counter-clockwise) before mirroring horizontally, 4: rotation by 90 degrees (counter-clockwise) before mirroring horizontally, 5: rotation by 90 degrees (counter-clockwise), 6: rotation by 270 degrees (counter-clockwise) before mirroring horizontally, 7: rotation by 270 degrees (counter-clockwise).

packed_reg width[i][j], packed_reg_height[i][j], packed_reg_top[i][j], and packed_reg_left[i][j] according to the embodiments specify the width, height, the offset, and the left offset, respectively, of the j-th packed region for the i-the source picture.

Hereinafter, further embodiments will be described in relation to NALU stream based multiplexing/demultiplexing of FIG. 49. Reference may be made to FIG. 49 and the following description.

A method for extending the metadata according to embodiments is proposed in the following description.

Regarding geometry/texture images according to embodiments, D0, D1, and texture may be distinguished using Nuh_layer_id. In addition, a method for PCC signaling for each layer (e.g., new SEI message, adding information to VPS) is proposed. According to embodiments, an SEI message may be provided and definition of a VPS extension syntax is proposed. In addition, embodiments may distinguish between D0, D1, and texture using PPS. Signaling (of D0, D1, or texture) using a PPS extension is proposed, and a method for providing a VPS link in each NAL unit (slice) to one stream based on a plurality of PPSs is proposed.

Regarding occupancy map/auxiliary patch information according to embodiments, a new SEI message is proposed. In addition, definition of a PPS extension syntax is proposed.

Regarding a PCC GOF header according to embodiments, a new SEI message is proposed. In addition, the embodiments propose definition of a VPS extension syntax and definition of an SPS extension syntax.

The PCC NAL unit according to embodiments defines a new NAL unit type. For example, there may be a NAL unit that contains only a parameter set. For example, the NAL unit may contain PCC_VPS NUT, PCC_SPS_NUT, and PCC_PPS NUT.

IRAP PCC AU according to embodiments may be a NAL unit including the starting AU of the PCC GOF.

An access unit delimiter according to embodiments may indicate the end of the PCC AU (when interleaving is performed on an AU-by-AU basis).

For NAL unit interleaving according to embodiments, different interleaving may be applied to each component. For example, interleaving on an AU-by-AU basis may be applied if the same GOP structure is used. Otherwise, interleaving on a GOF-by-GOF basis may be applied. Specifically, interleaving on the GOF-by-GOF basis and/or interleaving on the AU-by-AU basis may be performed. According to embodiments, interleaving on the AU-by-AU basis may be performed when the GOP structures of the components are the same and/or when the GOP structures of the components are different from each other. Here, when the GOP structures according to the embodiments are different, interleaving may be determined based on a difference value of decoding delay (DPB output delay).

The proposed embodiments will be described in more detail below.

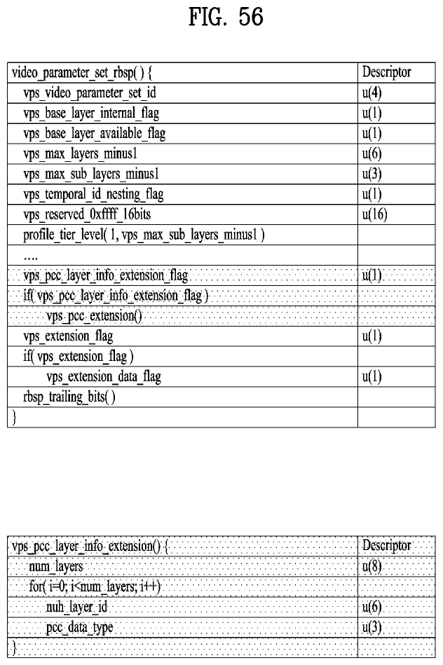

FIG. 56 illustrates VPS extension according to embodiments.

Regarding the VPS extension with the PCC layer information according to the embodiments, the above-described PCC layer information may not only be configured in an SEI message, may also be included in the VPS in the form of a VPS extension. For example, vps_pcc layer info_extension_flag may be added to the VPS to indicate presence or absence of vps_pcc_layer info_extension( ). The meanings of the fields in vps_pcc_extension( ) are the same as in the previous PCC layer information SEI message.

By including different pieces of vps_pcc_layer info_extension( ) information in multiple VPSs and activating different VPSs over time, PCC layer information that changes over time may be applied. An active parameter sets SEI message may be used to activate the VPSs.

video_parameter_set according to the embodiments may signal vps_pcc_extension( ) according to the embodiments based on vps_pcc layer_info_extension_flag.

vps_pcclayer info_extension( ) according to the embodiments may deliver num_layers, nuh_layer_id, and/or pcc_data_type. The definition of each field is as described above.

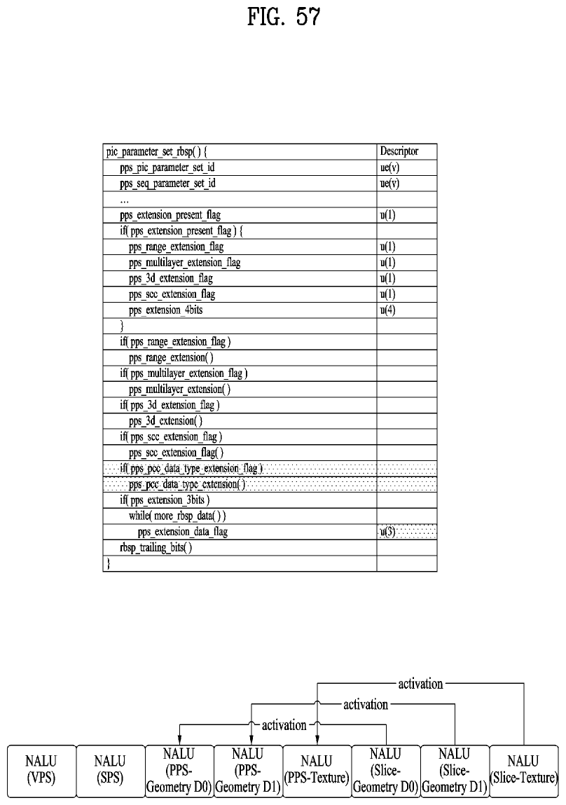

FIG. 57 illustrates pic_parameter_set according to embodiments.

Regarding the PPS extension with PCC data type according to the embodiments, a PPS extension syntax may be defined to distinguish between data types of PCC components included in the PCC bitstream. For example, pps_data type_extension_flag may be added to the PPS to indicate presence or absence of pps_data type_extension( ). pcc_data_type of pps_data_type_extension( ) indicates the data type of a PCC component included in the slice that references (activates) the current PCC using slice_pic_parameter_set id of the slice header. For example, pcc_data_type set to 0 may indicate an occupancy map, and pcc_data_type set to 1 may indicate auxiliary patch information. pcc_data_type set to 2 may indicate geometry image D1, and pcc_data_type set to 3 may indicate a geometry image D0. pcc_data_type set to 4 may indicate that a texture image is sample auxiliary information.

In this case, unlike the case where one layer is applied to one PCC data type, the PCC components of all data types may be included in one layer.

As shown in the figure, an NALU stream according to the embodiments includes a VLP and an SPS, includes a NALU unit having a PPS for the geometry texture, and includes a NALU unit having a slice for the geometry and the texture. Referencing between the PPS and the slice is performed based on signaling information (metadata) according to the embodiments.

pic_parameter_set according to the embodiments may signal pps_pcc_data_type_extension( ) based on pps_pcc_data_type_extension_flag. vps_pcc_data_type_extension( ) according to the embodiments signals pcc_data_type. As a result, the decoder may acquire the activation relationship between slices. pps_extension_data_flag according to the embodiments may signal presence or absence of pps extension data.

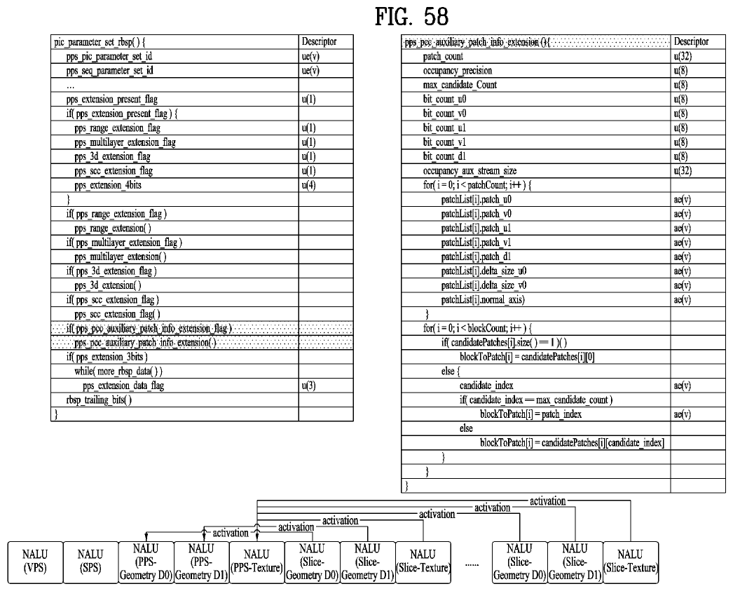

FIG. 58 illustrates pps_pcc_auxiliary_patch_info_extension ( ) according to embodiments.

Regarding the PPS extension with auxiliary patch information according to the embodiments, a PPS extension syntax may be defined to deliver PCC auxiliary patch information. For example, pps_pcc_auxiliary_patch_info_extension_flag may be added to the PPS to indicate presence or absence of pps_pcc_auxiliary_patch_info_extension( ). Internal fields of pps_pcc_auxiliary_patch_info_extension( ) indicate PCC auxiliary patch information to be applied to a slice referencing (activating) the current PCC using slice_pic_parameter_set id of a slice header. PCC auxiliary patch information that changes over time may be applied by delivering multiple PPSs with different pps_pcc_auxiliary_patch_info_extension( ) to the transmission side and activating different PPSs in the slice over time.

The same information as pps_pcc_auxiliary_patch_info_extension( ) [e.g., sps_pcc_auxiliary_patch_info_extension( )] may be included in the SPS. An active parameter set SEI message may be used to activate the SPS over time.

pic_parameter_set according to the embodiments may signal pps_pcc_auxiliary_patch_info_extension( ) based on pps_pcc_auxiliary_patch_info_extension_flag. pps_pcc_auxiliary_patch_info_extension( ) may be PCC auxiliary patch information to be applied to a slice referencing (activating) the PCC based on slice_pic_parameter_set_id of the slice header. For example, there may be one or more slices to activate a NALU unit including one PPS.

The PPS according to the embodiments provides an NALU unit link, and may signal a PCC data type based on the unit link by adding pps_pcc_data_type_extension( ) according to the embodiments.

pps_pcc_auxiliary_patch_info_extension( ) according to the embodiments may signal PCC data without defining a separate SEI message.

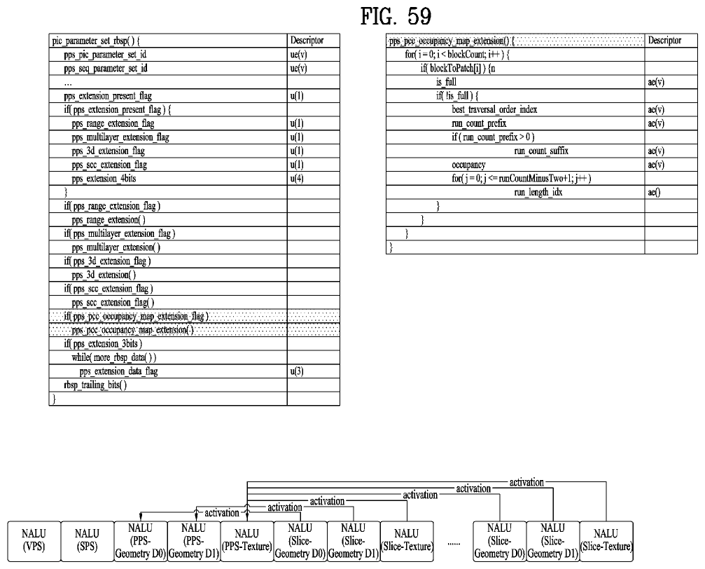

FIG. 59 illustrates pps_pcc_occupancy_map_extension( ) according to embodiments.

Regarding the PPS extension with occupancy map according to the embodiments, a PPS extension syntax may be defined to deliver a PCC occupancy map. For example, pps_pcc_occupancy_map_extension_flag may be added to the PPS to indicate presence or absence of pps_pcc_occupancy_map_extension( ). The internal fields of pps_pcc_occupancy_map_extension( ) indicate a PCC occupancy map to be applied to a slice referencing (activating) the current PCC using slice_pic_parameter_set id of a slice header. The PCC occupancy map, which changes over time, may be applied by delivering multiple PPSs with different pps_pcc_occupancymap_extension( ) to the transmission side and activating different PPS in the slice over time.

The same information as pps_pcc_occupancy_map_extension( ) [e.g., sps_pcc_occupancy_map_extension( )] may be included in the SPS. An active parameter set SEI message may be used to activate the SPS over time.

pic_parameter_set according to the embodiments may signal pps_pcc_occupancy_map_extension( ) based on pps_pcc_occupancy_map_extension_flag. pps_pcc_occupancy_map_extension( ) according to the embodiments delivers occupancy map-related information. In addition, there may be one or more slices to activate a NALU unit including one PPS.

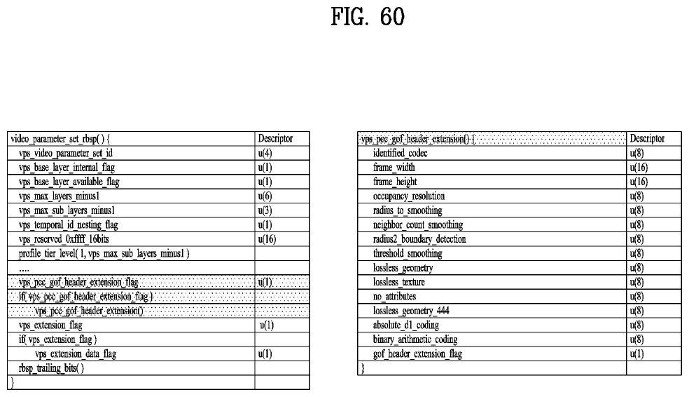

FIG. 60 illustrates vps_pcc_gof header_extension( ) according to embodiments.

Regarding the VPS extension with PCC GOF header according to the embodiments, the aforementioned PCC group of frames header may not only be configured in an SEI message, may also be included in the VPS in the form of a VPS extension. For example, vps_pcc_gof header_extension_flag may be added to the VPS to indicate presence or absence of vps_pcc_gof header_extension( ). The meanings of the fields in vps_pcc_gof header_extension( ) are the same as in the previous PCC group of frames header SEI message.

By including different pieces of vps_pcc_gof header_extension( ) information in multiple VPSs and activating different VPSs over time, the PCC GOF header, which changes over time, may be applied. An active parameter sets SEI message may be used to activate the VPSs.

The PCC GOF header delivery method using the VPS extension is applicable when one layer is mapped to a PCC component of one data type as described above.

Instead of VPS extension, SPS extension may be used to deliver the PCC GOF header [e.g., vps_pcc_gof header_extension( )]. This case is applicable when PCC components of all data types are delivered through one layer.

video_parameter_set according to the embodiments signals vps_pcc_gof header_extension( ) based on vps_pcc_gof header_extension_flag, and vps_pcc_gof header_extension( ) according to the embodiments delivers frame header PCC group information.

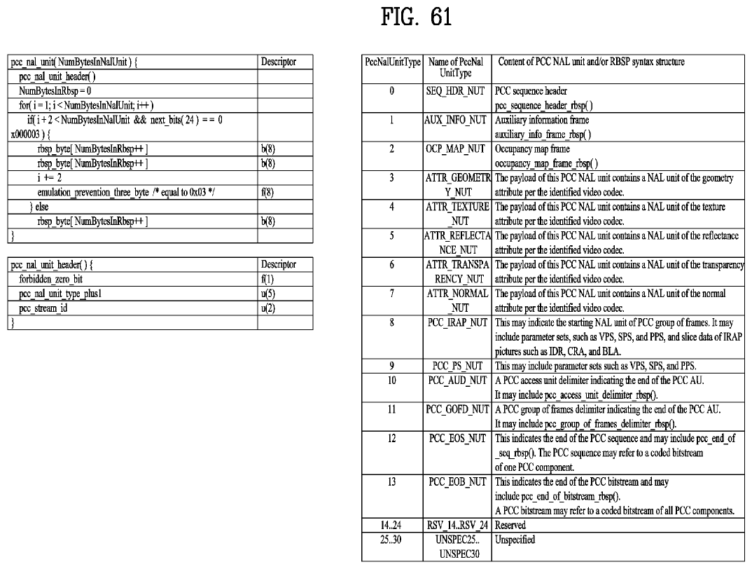

FIG. 61 illustrates pcc_nal_unit according to embodiments.

Regarding the PCC NAL unit according to the embodiments, a PCC NAL unit syntax may be defined for PCC component delivery as follows. The PCC NAL unit header may include pcc_nal unit type_plus1 for identifying the PCC component. The PCC NAL unit payload (rbsp byte) may include the existing HEVC NAL unit or AVC NAL unit.

forbidden_zero_bit according to the embodiments may be 0.

A type according to embodiments may indicate the starting NAL unit of the PCC group of frames. It may include a parameter set, such as VPS, SPS, or PPS, and slice data of an IRAP picture, such as IDR, CRA, or BLA.

A type according to embodiments may include a parameter set such as VPS, SPS, or PPS.

A type according to embodiments may indicate the end of the PCC AU through a PCC access unit delimiter and may include pcc_access_unit_delimiter_rbsp( ).

A type according to embodiments may indicate the end of the PCC AU through a PCC group of frames delimiter and may include pcc_group_of frames_delimiter_rbsp( ).

A type according to embodiments may indicate the end of a PCC sequence and may include pcc_end_of seq_rbsp( ). The PCC sequence may refer to a coded bitstream of one PCC component.

A type according to embodiments may indicate the end of a PCC bitstream and may include pcc_end_of_bitstream_rbsp( ). The PCC bitstream may refer to a coded bitstream of all PCC components.

pcc_nal unit type_plus1 according to the embodiments indicates that the value thereof minus 1 represents the value of variable PccNalUnitType. Variable PccNalUnitType according to the embodiments indicates the type of structure of RBSP data included in the PCC NAL unit.

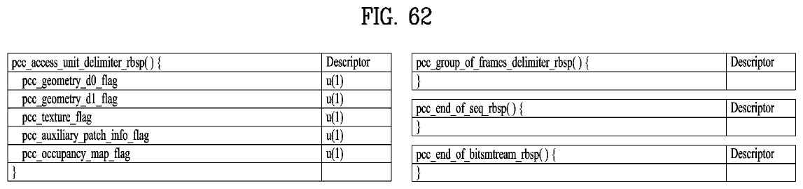

FIG. 62 shows an example of a PCC related syntax according to embodiments.

According to the embodiments, pcc_access_unit_delimiter_rbsp( ), pcc_group_of frames_delimiter_rbsp( ), pcc_end_of_seq_rbsp( ), and pcc_end_of_bitstream_rbsp(mentioned above may have the following syntaxes and meanings.

pcc_geometry_d0_flag according to the embodiments: pcc_geometry_d0_flag set to 1 may indicate that PCC geometry d0 image is included in the PCC access unit distinguished by the current PCC access unit delimiter. pcc_geometry_d0_flag set to 0 may indicate that the PCC geometry d0 image is not included.

pcc_geometry_d1_flag according to the embodiments: pcc_geometry_d1_flag set to 1 may indicate that a PCC geometry d1 image is included in the PCC access unit distinguished by the current PCC access unit delimiter. pcc_geometry_d1_flag set to 0 may indicate that PCC geometry d1 image is not included.

pcc_texture_flag according to the embodiments: pcc_texture_flag set to 1 according to embodiments may indicate that a PCC texture image is included in the PCC access unit distinguished by the current PCC access unit delimiter. pcc_texture_flag set to 0 may indicate that the PCC texture image is not included.

pcc_auxiliary_patch_info_flag according to the embodiments: pcc_auxiliary_patch_info_flag set to 1 may indicate that PCC access patch information is included in the PCC access unit distinguished by the current PCC access unit delimiter. pcc_auxiliary_patch_info_flag set to 0 may indicate that the PCC auxiliary patch information is not included.

pcc_occupancy_map_flag according to the embodiments: pcc_occupancy_map_flag set to 1 may indicate that a PCC occupancy map is included in the PCC access unit distinguished by the current PCC access unit delimiter. pcc_occupancy_map_flag set to 0 may indicate that the PCC occupancy map is not included.

These fields may allow the receiver to recognize whether PCC components are present in the current AU. If the PCC components are not present, the receiver may retrieve the components from the previous AUs and use the same to reconstruct a point cloud.

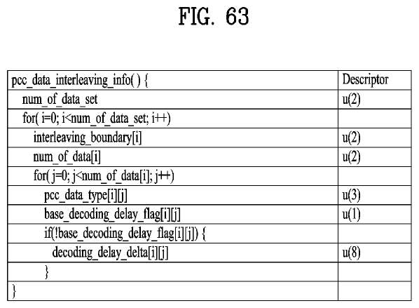

FIG. 63 shows PCC data interleaving information according to embodiments.

Regarding the PCC data interleaving method according to the embodiments, in order to describe the method of interleaving PCC data, a syntax such as pcc_data_interleaving_info( ) may be defined. Each field may have the following meaning.

num_of data_set according to the embodiments: may indicate the number of sets having the same interleaving boundary among the data of PCC components included in one PCC GOF (or bitstream). For example, when the interleaving boundaries of all data are the same, num_of data_set may be set to 1.

interleaving boundary[i] according to the embodiments: may indicate an interleaving boundary of the i-th data set. For example, interleaving_boundary[i] set to 0 may indicate that data are interleaved in the GOF. interleaving_boundary[i] set to 1 may indicate that data are interleaved in the AU.

num_of_data[i] according to the embodiments: may indicate the number of PCC data constituting the i-th data set.

pcc_data_type[i][j] according to the embodiments may indicate a data type of a PCC component corresponding to the j-th data of the i-th data set. For example, pcc_data_type[i][j] set to 0 may indicate an occupancy map. pcc_data_type[i][j] set to 1 may indicate auxiliary patch information. pcc_data_type[i][j] set to 2 may indicate a geometry image D1. pcc_data_type[i][j] set to 3 may indicate geometry image D0. pcc_data_type[i][j] set to 4 may indicate that a texture image is sample auxiliary information.

base_decoding_delay_flag[i][j] according to the embodiments: may indicate that the j-th data of the i-th data set is set as a reference value of the decoding delay.

According to embodiments, the decoding delay may refer to a time difference between an input and an output, which may be produced due to a reference structure in GOP coding, such as a hierarchical B picture. The decoding delay may be defined as hierarchy level −1 [frames]. For example, the decoding delay of the “IPPP . . . ” structure whose hierarchy level is 1 is 0. The decoding delay of the “IPBP . . . ” structure whose hierarchy level is 2 is 0 and 1 [frame].

decoding_delay_delta[i][j] according to the embodiments: may indicate a difference between the decoding delay of the j-th data of the i-th data set and the reference value of the decoding delay.

pcc_data_interleaving_info( ) according to the embodiments may be included in the PCC bitstream in various ways. For example, it may be included in a VPS or PCC extension or defined through a new SEI message. Alternatively, it may be delivered in the PCC GOF header described above.

The receiver may determine a buffering method for synchronizing the PCC data based on this information. For example, if all components are interleaved at the AU boundary and there is no difference in decoding delay, the components may be synchronized simply by buffering of data corresponding to at least one PCC AU.

According to embodiments, a unit (GOF or AU) in which four PCC data are interleaved in multiplexing of PCC data and a corresponding buffering method for the receiver are proposed. In particular, when the PCC data are interleaved on an AU-by-AU basis and the GOP reference structures of the video components are different from each other, display cannot be started at a time when only one AU is buffered (e.g., a time when decoding is completed). (For example, the first frame of the geometry may have been output from the decoder, but the first frame of the texture may not have been output from the decoder). In this case, embodiments may allow a difference in decoding delay to be identified by the number of frames through decoding_delay_delta such that display can be started when the PCC AU corresponding to the minimum decoding_delay_delta is buffered.

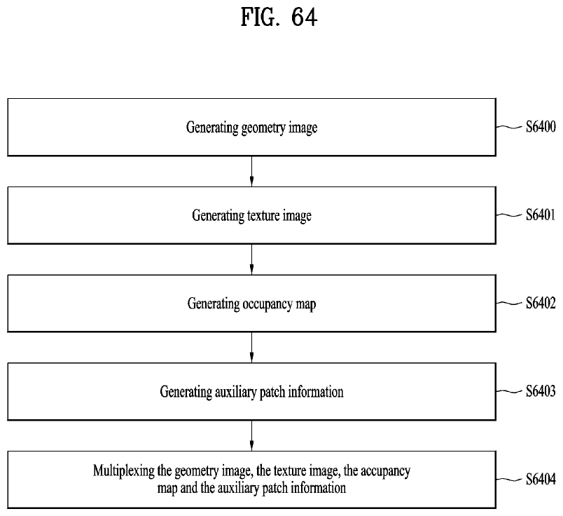

FIG. 64 illustrates a point cloud data transmission method according to embodiments.

The point cloud data transmission method according to the embodiments includes generating a geometry image for a location of the point cloud data (S6400), generating a texture image for attributes of a point cloud (S6401), generating an occupancy map for a patch of the point cloud (S6402), generating auxiliary patch information related to the patch of the point cloud (S6403), and/or multiplexing the geometry image, the texture image, the occupancy map, and the auxiliary patch information (S6404).

According to embodiments, the point cloud data transmission method may be carried out by each component of the point cloud data transmission apparatus and/or the point cloud transmission apparatus according to the embodiments described with reference to FIG. 45.

Operation S6400 is a process of generating a geometry image for point cloud data. As described with reference to FIG. 45, the geometry image is generated based on a point cloud frame, a patch, and related metadata.

Operation S6401 is a process of generating a texture image for the point cloud data. As described with reference to FIG. 45, the texture image is generated based on a point cloud frame, a patch, and related metadata.

Operation S6402 is a process of generating metadata needed for the decoder according to the embodiments to reconstruct the generated patch.

Operation S6403 is a process of generating metadata needed for the decoder according to the embodiments to reconstruct the generated patch. Not only the patch but also auxiliary patch information is needed to efficiently decode the point cloud data.

The definition and usage of the metadata according to the embodiments may improve transmission/reception, encoding and/or decoding performance of the point cloud.

Operation S6404 is a process of performing encapsulation and/or multiplexing to transmit the above-described data. The multiplexing method according to the embodiments may improve transmission/reception, encoding and/or decoding performance of the point cloud.

The point cloud data transmission method according to the embodiments may be combined with elements, operations and/or metadata of additional embodiments according to the above-described embodiments.

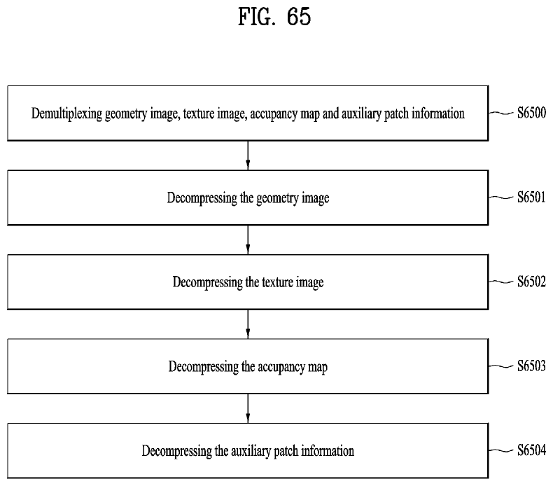

FIG. 65 illustrates a point cloud data reception method according to embodiments.

The point cloud data reception method according to the embodiments may include demultiplexing a geometry image for a location of point cloud data, a texture image for attributes of a point cloud, an occupancy map for a patch of the point cloud, and auxiliary patch information related to the patch of the point cloud (S6500), decompressing the geometry image (S6501), decompressing the texture image (S6502), decompressing the occupancy map (S6503), and/or decompressing the auxiliary patch information (S6504).

The point cloud data reception method according to the embodiments may be combined with elements, operations and/or metadata of additional embodiments according to the above-described embodiments.

Each part, module, or unit described above may be a software, processor, or hardware part that executes successive procedures stored in a memory (or storage unit). Each of the steps described in the above embodiments may be performed by a processor, software, or hardware parts. Each module/block/unit described in the above embodiments may operate as a processor, software, or hardware. In addition, the methods presented by the embodiments may be executed as code. This code may be written on a processor readable storage medium and thus read by a processor provided by an apparatus.

Although embodiments have been explained with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may fall within the scope of the appended claims and their equivalents.

The apparatuses and methods according to the embodiments may not be limited by the configurations and methods of the embodiments described above. The embodiments described above may be configured by being selectively combined with one another entirely or in part to enable various modifications.

In addition, the method proposed in the embodiments may be implemented with processor-readable code in a processor-readable recording medium provided to a network device. The processor-readable medium may include all kinds of recording devices capable of storing data readable by a processor. The processor-readable medium may include one of ROM, RAM, CD-ROM, magnetic tapes, floppy disks, optical data storage devices, and the like and also include carrier-wave type implementation such as a transmission via Internet. Furthermore, as the processor-readable recording medium is distributed to a computer system connected via a network, processor-readable code may be saved and executed in a distributed manner.

Although the disclosure has been described with reference to exemplary embodiments, those skilled in the art will appreciate that various modifications and variations can be made in the embodiments without departing from the spirit or scope of the invention described in the appended claims. Such modifications are not to be understood individually from the technical idea or perspective of the embodiments.

It will be appreciated by those skilled in the art that various modifications and variations can be made in the embodiments without departing from the scope of the inventions. Thus, it is intended that the present invention cover the modifications and variations of the embodiments provided they come within the scope of the appended claims and their equivalents.

Both apparatus and method inventions are described in this specification and descriptions of both the apparatus and method inventions are complementarily applicable.

In this document, the term “/“and”,” should be interpreted to indicate “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.”

Further, in the document, the term or should be interpreted to indicate and/or. For instance, the expression A or B may comprise 1) only A, 2) only B, and/or 3) both A and B. In other words, the term or in this document should be interpreted to indicate additionally or alternatively.

Various elements of the point cloud data transmission/reception apparatuses may be implemented by hardware, software, firmware or a combination thereof. Various elements in the embodiments may be implemented by a single chip, such as a hardware circuit. According to embodiments, various elements may optionally be implemented by individual chips. According to embodiments, elements may be implemented by one or more processors capable of executing one or more programs to perform operations according to the embodiments.

Regarding interpretation of the terminology according to the embodiments, the first, second, etc. may be used to describe various elements. These terms do not limit the interpretation of the elements of the embodiments. These terms may be used to distinguish between the elements.

The terminology used in connection with the description of the embodiments should be construed in all aspects as illustrative and not restrictive. Regarding singular and plural representations, the singular representation is intended to be interpreted as a plural representation, and “and/or” is also intended to include all possible combinations. Terms such as “includes” or “has” are intended to further include/combine various features, numbers, method steps, operations, and elements in addition to the elements included.

Conditional expressions such as “if” and “when” are not limited to an optional case and are intended to be interpreted, when a specific condition is satisfied, to perform the related operation or interpret the related definition according to the specific condition.

### MODE FOR INVENTION

As described above, related details have been described in the best mode for carrying out the embodiments.

### INDUSTRIAL APPLICABILITY

As described above, the embodiments are fully or partially applicable to a point cloud data transmission/reception apparatus and system.

Those skilled in the art may change or modify the embodiments in various ways within the scope of the embodiments.

Embodiments may include variations/modifications, which do not depart from the scope of the claims and their equivalents.

What is claimed is:

1. A method for transmitting point cloud data, the method comprising:
generating a geometry image for a location of point cloud data;
generating a texture image for attribute of the point cloud data;
generating an occupancy map for a patch of the point cloud data; and
multiplexing the geometry image, the texture image and the occupancy map.

2. The method of claim 1,
wherein the multiplexing multiplexes the geometry image, the texture image and the occupancy map based on a file.

3. The method of claim 2,
wherein the file includes multiple tracks.

4. The method of claim 3,
wherein the multiple tracks includes a first track including the geometry image, a second track including the texture image and the third track including the occupancy map.

5. The method of claim 4,
wherein the file includes a group box,
wherein the group box includes information for representing at least one of the first track, the second track or the third track.

6. An apparatus for transmitting point cloud data, the apparatus comprising:
a generator configured to generate a geometry image for a location of point cloud data;
a generator configured to generate a texture image for attribute of the point cloud data;
a generator configured to generate an occupancy map for a patch of the point cloud data; and
a multiplexer configured to multiplex the geometry image, the texture image and the occupancy map.

7. The apparatus of claim 6,
wherein the multiplexer multiplexes the geometry image, the texture image and the occupancy map based on a file.

8. The apparatus of claim 7,
wherein the file includes multiple tracks.

9. The apparatus of claim 8,
wherein the multiple tracks includes a first track including the geometry image, a second track including the texture image and the third track including the occupancy map.

10. The apparatus of claim 9,
wherein the file includes a group box,
wherein the group box includes information for representing at least one of the first track, the second track or the third track.

11. A method for receiving point cloud data, the method comprising:
demultiplexing multiplexing a geometry image for a location of point cloud data, a texture image for attribute of the point cloud data and an occupancy map for a patch of the point cloud data;
decompressing the geometry image;
decompressing the texture image; and
decompressing the occupancy map.

12. The method of claim 11,
wherein the demultiplexing demultiplexes the geometry image, the texture image and the occupancy map based on a file.

13. The method of claim 11,
wherein the file includes multiple tracks.

14. The method of claim 13,
wherein the multiple tracks includes a first track including the geometry image, a second track including the texture image and the third track including the occupancy map.

15. The method of claim 14,
wherein the file includes a group box,
wherein the group box includes information for representing at least one of the first track, the second track or the third track.

16. An apparatus for receiving point cloud data, the apparatus comprising:
a demultiplexer configured to demultiplex a geometry image for a location of point cloud data, a texture image for attribute of the point cloud data and an occupancy map for a patch of the point cloud data;
a decompressor configured to decompress the geometry image;
a decompressor configured to decompress the texture image; and
a decompressor configured to decompressing the occupancy map.

17. The apparatus of claim 16,
wherein the demultiplexer demultiplexes the geometry image, the texture image and the occupancy map based on a file.

18. The apparatus of claim 16,
wherein the file includes multiple tracks.

19. The apparatus of claim 18,
wherein the multiple tracks includes a first track including the geometry image, a second track including the texture image and the third track including the occupancy map.

20. The apparatus of claim 19,
wherein the file includes a group box,
wherein the group box includes information for representing at least one of the first track, the second track or the third track.
